(19) United States
(12) Patent Application Publication
(10) Pub. No.: US 2022/0396484 A1
(43) Pub. Date: Dec. 15, 2022

(54) ASYMMETRIC POROUS MATERIALS, METHODS OF MAKING SAME, AND USES THEREOF

(71) Applicant: CORNELL UNIVERSITY, lthaca, NY (US)

(72) Inventors: Ulrich B. Wiesner, Ithaca, NY (US); Sarah A. Hesse, Redwood City, CA (US); Kevin E. Fritz, Flemington, NJ (US); Peter A. Beaucage, Germantown, MD (US); Jin Suntivich, Ithaca, NY (US)

(21) Appl. No.: 17/772,542

(22) PCT Filed: Nov. 3, 2020
(86) PCT No.: PCT/US20/58755

§ 371 Date: Apr. 28, 2022

Related U.S. Application Data
(60) Provisional application No. 62/929,942, filed on Nov. 3, 2019.

(51) Int. Cl. C01B 32/05; H01M 4/583; B01D 71/02

(52) U.S. Cl. CPC C01B 32/05; H01M 4/583; B01D 71/021; C01P 2006/16

(57) ABSTRACT

Asymmetric porous films, methods of making, and devices. An asymmetric porous film may have a surface layer, which may be an isoporous surface layer, disposed on a substructure, which may be a graded porous substructure that may have mesopores throughout. An asymmetric porous film may be a hybrid asymmetric porous film comprising one or more precursor(s). An asymmetric porous film may include one or more carbon material(s), one or more metalloid oxide(s), one or more metal(s), one or more metal oxide(s), one or more metal nitride(s), one or more metal oxynitride(s), one or more metal carbide(s), one or more metal carbonitrides, or a combination thereof. A method of making an asymmetric porous film may comprise formation of an asymmetric porous film using CA a mixture comprising a multiblock copolymer that can self-assemble and one or more precursor(s).

### CROSS REFERENCE TO RELATED APPLICATIONS

This application claims priority to U.S. Provisional Application No. 62/929,942, filed on Nov. 3, 2019, the disclosure of which is hereby incorporated by reference.

### STATEMENT REGARDING FEDERALLY SPONSORED RESEARCH OR DEVELOPMENT

This invention was made with government support under grant numbers 1650441 and 1707836 awarded by the National Science Foundation and DE-SC0019445 awarded by the Department of Energy. The government has certain rights in the invention.

### BACKGROUND OF THE DISCLOSURE

Porous inorganic materials have gained attention in applications ranging from energy conversion and storage to catalysis to separations. Porous carbon materials, a class of inorganic materials, find use in a broad range of applications including batteries, fuel cells, and gas separation due to their favorable chemical and physical properties such as high chemical resistance, compatibility with polymers, easy processability, as well as electrical and thermal conductivity. Initial studies used silica templates as a mold to make ordered mesoporous carbon materials. These initial hard-templating routes involve multiple processing steps, however, including the oftentimes highly chemically-hazardous removal of the template. For this reason, various soft-templating approaches were developed to fabricate ordered mesoporous carbons. These studies often utilized the self-assembling properties of block copolymers (BCPs) as structure-directing agents for organic carbon precursors, such as phenol formaldehyde resols or resorcinol formaldehyde resols.

A number of these studies focused on the micro- and mesopore scale in order to maximize surface area. In order to increase accessibility/flux together with surface area, in 2015 Gu et al. developed a method for creating porous inorganic materials with graded porosity. These materials, instead of having only mesopores throughout the material, had pores from the meso- to the macroscale, arranged in an asymmetric and graded fashion along the film normal. The underlying process originally employed for the generation of ultrafiltration (UF) membranes is called self-assembly and non-solvent induced phase separation (SNIPS)—a non-equilibrium process pioneered in 2007 by Peinemann et al. for using a poly(styrene)-b-poly(2-vinylpyridine) diblock copolymer (SV) system. The SNIPS process combines the industrially well-utilized and scalable process of non-solvent induced phase separation (NIPS) with block copolymer self-assembly. To that end block copolymers (BCPs) are dissolved in a selective solvent mixture. The resulting micellar solution is then blade-cast/doctor bladed and allowed to evaporate for a short period of time, which introduces a polymer concentration gradient along the film normal. The films are then precipitated in a non-solvent bath, typically water, thereby forming a structural gradient frozen into a polymer glass. When the formation parameters are tuned correctly, the resulting membranes possess well-ordered top surfaces with narrow pore size distribution, which continuously evolve into structures with increasing pore size along the film normal from meso- to macropores. Gu et al. used such BCP membranes as templates to deposit metals like nickel or copper, or carbon precursors, generating the first asymmetric porous inorganic membrane materials with a structural hierarchy after additional thermal processing.

In order to decrease the number of processing steps in asymmetric porous organic-inorganic hybrid material formation, a process called CNIPS—co-assembly and non-solvent induced phase separation—was developed. This process is similar to the SNIPS process, however, instead of using just BCPs in the casting solutions, BCPs are employed as structure directing agents for inorganic precursor materials and are used together in the casting solutions thereby eliminating time consuming post-membrane formation processing steps.

In 2015, Hesse et al. used the CNIPS process to create asymmetric porous carbon materials with a hierarchy of structure. ISV triblock terpolymer and phenol formaldehyde resols carbon precursors were combined in a one-pot solution, subjected to the CNIPS process and subsequently heat-treated to both cross-link the phenol formaldehyde resols and remove the polymer. The expectation was to obtain carbon materials with an ordered top surface as is characteristic of materials made via the combination of BCP self-assembly and NIPS. However, while this proof-of-principle study yielded the characteristic asymmetric pore structure, no formation conditions were found to obtain membranes with periodically ordered pores in the top surface layer of the resulting carbon materials.

It is periodic pore order in the top-separation layer together with narrow pore size distributions, however, which sets SNIPS/CNIPS membranes apart from conventional UF membranes. This combination leads to maximum pore density, in turn providing high flux, which together with high resolution from narrow pore size distributions enables advanced membrane performance.

The ability to prepare mesoporous materials with small, interconnected pores has resulted in remarkable improvements in power and energy densities in energy storage devices. However, at fast charge/discharge rates, only a small fraction of pores are accessible, resulting in pore underutilization. While pore utilization can be improved by reducing the electrode thickness, there is a tradeoff between energy density and rate capability (i.e., power density). This goldilocks issue has restricted energy storage devices such as batteries and capacitors from achieving both high energy and power densities. Even for electrochemical double-layer capacitors (EDLCs), a device known for high power density, the energy density drops precipitously at high rate operation. For example, mesoporous carbon with the presence of microporosity to substantially increase the surface area has been used to make EDLCs with high energy density (>10 W-h kg⁻¹). However, these energy densities can only be realized at moderate power densities (≤10² kW kg⁻¹). To improve the rate capability, hierarchical carbon structures, consisting of a combination of macro-, meso-, and microporosity have been explored. While these structures allow improved power density, realizing simultaneously improved energy and power densities has not been straightforward even when these hierarchical structures have high specific surface areas comparable to energy-dense mesoporous structures. Other strategies such as making the pores ionophobic to enhance charge storage, modifying the pore shape to reduce internal resistance, and modeling ion transport during charging and discharging have also been studied, however, the issue of pore underutilization remains. This observation points to the critical need for a strategy to overcome pore underutilization in hierarchical structures to enable high energy densities at high rate operation.

Nature employs asymmetric structures to address this tradeoff between requirements for high internal surface area and high flux. For example, the respiratory system is highly asymmetric in structure and uses airflow through the trachea (diameter of ˜1.5-2.5 cm) and bronchi (diameter of ˜0.4 mm) to the alveoli (diameter of ˜50-250 μm) in order to allow high flux while simultaneously providing large surface area for O₂/CO₂ exchange. Creating engineered asymmetric porous inorganic structures with graded porosity requires non-equilibrium processes, however, which has remained challenging. One approach has employed non-solvent induced phase separation (NIPS) to prepare asymmetric carbon structures, a widely used and scalable industrial ultrafiltration polymer membrane formation process. These structures possess an asymmetric, hierarchical structural gradient consisting of macro- to micro-pores, the latter of which particularly aid in obtaining high surface areas. However, because these structures lack well-defined mesopores throughout the membrane, they face the same pore inaccessibility restriction—their high energy density (>10 W-h kg⁻¹) can only be realized at modest power density (<10 kW kg⁻¹).

To address these shortcomings and produce EDLCs with high energy density (>10 W-h kg⁻¹) at a high power density (>250 kW kg⁻¹), here structural asymmetry, including hierarchical porosity, is combined with well-defined mesoporosity throughout the material. This approach integrates three different processes: Inorganic materials formation, NIPS, and block copolymer (BCP) self-assembly (SA). This approach is different from the NIPS process, which has traditionally been exclusively used with homopolymers. While the NIPS process produces asymmetric structures with graded, i.e., hierarchical porosity, the resulting membranes lack well-defined mesopores throughout the material. Furthermore, while NIPS membranes from homopolymers like polyacrylonitrile (PAN) can be converted into asymmetric carbon structures through thermal processing, it is not straightforward to use this process to produce asymmetric membranes from other inorganic materials. The combination of BCP SA and NIPS (SA+NIPS=SNIPS) circumvents all these issues. It has already provided a paradigm shift in the ability to generate high flux and high resolution asymmetric organic polymer ultrafiltration (UF) membranes.

When designing electrodes for energy conversion and storage applications, high power density and high energy density are desirable. However, there exists an inherent tradeoff between the two as materials that have high energy density resulting from high surfaces tend to have low power density as the surfaces are not readily accessible due to the limited diffusion into and out of the electrodes. Conversely materials that are highly accessible such as flat surfaces have high power density, yet they tend to have low surface areas and thus have limited energy density.

Mesoporous materials have contributed to substantially reducing the inherent energy and power density tradeoff. Block copolymer (BCP) self-assembly (SA) provides one route to structure directing materials and results in mesoporous inorganic materials which have homogeneous pore sizes on the order of tens of nanometers throughout the materials. These structures which generally are derived from equilibrium mesophases can have high surface areas and thus high energy densities. Yet, as we have recently showed, their power density tends to be lower than desirable due to the limited diffusion into and out of the material. However, since BCPs still provide a desirable route to obtaining inorganic mesoporous materials as the processes are highly controllable and versatile and can encompass a wide range of materials, we recently developed a technique for combining BCP and additive co-assembly with an industrially well-utilized process for making asymmetric membranes to produce asymmetric porous inorganic materials with highly accessible surface areas and fast ion diffusion and thus power.

The SNIPS process combines BCP SA with an industrially well-established process called non-solvent induced phase separation (NIPS). From this process, membranes with structural asymmetry can be produced, where a mesoporous top surface layer transitions into a porous support structure with asymmetric porosity ranging from mesopores at the top to macropores at the bottom. The mesoporous top surface layer can be tuned to possess a highly ordered array of homogeneous pores, thus producing high density pores with narrow pore size distributions. The support layer is also tunable and contributes to the mechanical stability of the membranes. Since the mesoporous selective layer is extremely thin and the support layer is highly permeable, a high flux can be achieved. While initially restricted to polymers, the SNIPS process was recently expanded to produce both organic and inorganic functional materials. In the expanded CNIPS (co-assembly and non-solvent induced phase separation) process, BCPs were used to structure-direct either organic or inorganic materials into asymmetric structures.

By introducing a substantial amount of additive, the resulting organic/organic or organic/inorganic hybrids can be further heat-treated to obtain carbons or oxides and nitrides, respectively. Carbons are the material of choice, e.g., as anodes for lithium ion batteries, and titanium nitride is stable to higher voltages than carbon, thus making it a desirable support material in electrocatalysis or in fuel cells. While these materials classes can themselves already find a range of applications, particularly in energy conversion and storage, we showed previously that the asymmetric structure is key to increasing their performance. While the resulting materials have similar specific surface areas compared to their mesoporous counterparts, the surface area is more highly accessible, and thus allow, e.g., for rapid ion diffusion into and out of the material, resulting in state-of-the-art power density.

### SUMMARY OF THE DISCLOSURE

In an aspect, the present disclosure provides films. The films may be referred to as asymmetric porous films or asymmetrically porous films. The films have asymmetric pore structures along the film normal. A film has a surface layer, which may be referred to as a top surface layer, and support layer, which may be referred to as a bulk layer or a substructure. An asymmetric porous film may have hierarchical porosity (e.g., a hierarchical porous substructure) and/or a well-defined mesoporosity throughout the material. The asymmetric porous film (e.g., the bulk layer) may have a continuous pore size gradient along the film normal. The support layer may have a finger-like structure or a sponge-like structure. The support layer may have a macroporous substructure. An asymmetric porous film may comprise one or more multiblock copolymer(s), one or more thermal decomposition product(s) of the multiblock copolymer(s), or a combination thereof. An asymmetric porous film may comprise one or more self-assembled multiblock copolymer(s) and one or more precursor(s). These films may be referred to as hybrid asymmetric films, hybrid films, or precursor films. An asymmetric porous film may be a hybrid asymmetric porous film comprising homopolymer(s) and/or small molecule(s).

In an aspect, the present disclosure provides methods of making films. The methods comprise use of multiblock copolymers. Without intending to be bound by any particular theory, it is considered that the methods result in formation of non-equilibrium film structures. In various examples, a method for forming an asymmetrical porous film comprises: forming a film comprising one or more multiblock copolymer(s) comprising one or more hydrogen-bonding block(s) that can self-assemble using a mixture comprising a solvent system and one or more carbon precursor(s), one or more metalloid oxide precursor(s), or one or more metal oxide precursor(s), or a combination thereof, removing at least a portion of the solvent system from the film; and contacting the film having at least a portion of the solvent system removed with a phase separation solvent system, which may be referred to a non-solvent or precipitation system or a phase inversion system, such that the asymmetrical porous film is formed. A method may comprise one or more heating step(s), one or more nitriding steps(s), one or more post-asymmetric-film-formation treating step(s), or a combination thereof.

In an aspect, the present disclosure provides devices. In various examples, a device comprising one or more asymmetric porous film(s) of the present disclosure. A device may be an energy device (such as, for example, an energy conversion device, an energy storage device, or the like). In various examples, an energy device is chosen from batteries, capacitors, fuel cells, electrolyzers, and the like, and combinations thereof. A device may be a filtration device. A device may be an ultrafiltration device, a nanofiltration device, a microfiltration device, or the like.

### BRIEF DESCRIPTION OF THE FIGURES

For a fuller understanding of the nature and objects of the disclosure, reference should be made to the following detailed description taken in conjunction with the accompanying figures.

FIG. 1 shows a schematic representation of a SNIPS process and heat-treatment. The casting solutions, consisting of the ISV terpolymer mixed with either TiO₂ sol NPs or resols, was cast onto glass slides to form ˜200-400 μm thick films. After allowing the films to partially evaporate to induce an ISV+additive concentration gradient, they were plunged into a DI water bath, precipitating the polymer and converting the concentration gradient into an asymmetric composite structure. The resulting membranes were subsequently dried at RT and 130° C. The ISV+resols hybrids were heated to 900° C. in inert atmosphere (N₂) leading to ISV decomposition and resulting in graphitic carbon. The ISV+TiO₂ hybrids were heat-treated in air (400° C.). This led to polymer decomposition and formation of freestanding anatase titanium (IV) oxide. The oxide was then subjected to heat-treatment in ammonia (600° C.) to form TiN. A second heat-treatment in ammonia (865° C.) led to superconducting TiN. Photographs of the materials at each synthetic step are shown at the bottom.

FIG. 2 shows characterization of asymmetric TiN and carbon. SEM characterization of (a-g) asymmetric TiN: (a) and (b) two different types of asymmetric TiN cross-sections; (c) the top ˜150 nm mesoporous part of the cross-section; (d), (e) the mesoporous top surface; (f) the bottom surface showing macropores; (g) the mesoporous wall. SEM characterization of (h-n) asymmetric carbon: (h), (i) two different types of asymmetric carbon cross-sections; (j) the top ˜150 nm mesoporous part of the cross-section; (k), (1) the mesoporous top surface; (m) the bottom surface showing macropores; (n) the mesoporous wall. (o) XRD pattern of TiN. Tick marks indicate expected peak positions and relative intensities for cubic TiN (Fm3̅m, space group #230, ICSD #00-038-1420). (p) Nitrogen sorption isotherms of TiN and carbon materials. (h) BJH derived pore size distributions of the TiN and carbon materials.

FIG. 3 shows electrochemical characterization of asymmetric TiN and gyroidal mesoporous TiN. Cyclic voltammograms for asymmetric TiN and mesoporous TiN at (a) 50 mV s⁻¹ and (b) 5 V s⁻¹. (c) Chronoamperometry starting from the open circuit voltage to 0.01 V vs. RHE showing enhanced ion diffusion in asymmetric TiN. (d) Scan rate dependence of specific integral capacitance for asymmetric TiN and mesoporous TiN showing improved surface accessibility for asymmetric TiN. Error bars represent the standard deviation of three independent trials. All results were collected in Ar-saturated 0.1 mol L⁻¹ (also referred to as M) HClO₄.

FIG. 4 shows a capacitor performance benchmark and comparison of scan-rate dependent capacitance retention. (a) Ragonne plot comparing energy storage performance of gyroidal mesoporous TiN, asymmetric TiN, and asymmetric carbon. Previous literature examples include LaMnO_{2.91} ( [symbol] (Mefford et al., Nat. Mater. 13, 726-732 (2014))), MnO₂ ( [symbol] (Brousse et al., J. Electrochem. Soc. 151, A614-A622 (2004), [symbol] (Lei et al., J. Mater. Chem. 22, 153-160 (2012)), [symbol] (Sumboja et al., Adv. Mater. 25, 2809-2815 (2013)), [symbol] (Yu et al., Adv. Mater. 25, 3302-3306 (2013))), carbon nanotubes [symbol] (Hu et al., Proc. Natl. Acad. Sci. 106, 21490-21494 (2009)), [symbol] (Kaempgen et al., Nano Lett. 9, 1872-1876 (2009))), graphene ( [symbol] (Xu et al., ACS Nano 7, 4042-4049 (2013)), [symbol] (Yang et al., Science 341, 534-537 (2013))), N-doped carbon ( [symbol] (Lin et al., Science 350, 1508-1513 (2015))), and titanium carbide ( [symbol] (Lukatskaya et al., Science 341, 1502-1505 (2013))). (b) Scan rate dependence of capacitance retention for superconducting asymmetric TiN, asymmetric carbon, asymmetric TiN, and gyroidal mesoporous TiN. All results were collected in Ar-saturated 0.1 mol L⁻¹ HClO₄.

FIG. 5 shows characterization of asymmetric TiN superconductor. SEM characterization of: (a) 50 μm thick asymmetric cross-section; (b) the mesoporous top surface part of the cross-section; (c),(d) the mesoporous top surface; (e) bottom surface with macropores; (f) mesoporous wall. (g) XRD pattern: Tick marks indicate expected peak positions and relative intensities for cubic TiN (ICSD #00-038-1420). (h) Temperature dependent conductivity measurements. TiN is a nitride sample that was exposed to air for a longer period of time than the pristine TiN. The lower conductivity relative to the pristine TiN sample suggests growth of a thin surface oxide layer. (i) Temperature-dependent magnetization from 2.2 to 5 K for superconducting TiN membrane with an onset T_{c} of 3.8 K.

FIG. 6 shows characterization via SEM of the cross-section, top surface, and bottom surface of: (a) As-made ISV+TiO₂ hybrid, (b) as-made ISV+resols hybrid, (c) ISV+TiO₂ hybrid treated to 130° C., (d) ISV+resols hybrid treated to 130° C., and (e) XRD of the 130° C. ISV+TiO₂ hybrid.

FIG. 7 shows characterization of asymmetric TiO₂ following heat-treatment to 400° C. in air. (a) ˜60 μm cross-section SEM showing asymmetry. (b) Higher magnification SEM of the top mesoporous part of the cross-section. (c) SEM of the mesoporous top surface. (d) Higher magnification top surface SEM. (e) SEM of macroporous bottom surface. (f) Higher magnification SEM of the mesoporous wall. (g) XRD pattern of asymmetric TiO₂. Tick marks correspond to anatase TiO₂ (I4₁/amd, space group #141, ICSD #01-070-7348). (h) Nitrogen sorption isotherm. (i) BJH derived pore size distribution.

FIG. 8 shows full characterization of asymmetric TiN and carbon materials for which the cross-sections are shown in panels (2a) and (2 h) in FIG. 2. (a-f) SEM characterization of asymmetric TiN: (a) ˜60 μm asymmetric cross-section; (b) Higher magnification SEM of the top mesoporous part of the cross-section; (c) Mesoporous top surface; (d) Higher magnification top surface SEM; (e) Macroporous bottom surface; (f) Higher magnification SEM of the mesoporous wall. (g-1) SEM characterization of asymmetric carbon: (g) ˜8 μm asymmetric cross-section; (h) Higher magnification SEM of the top ˜150 nm mesoporous top part of the cross-section; (i) Mesoporous top surface; (j) Higher magnification top surface SEM; (k) Macroporous bottom surface; (1) Higher magnification SEM of the mesoporous wall. (m) XRD pattern of asymmetric TiN. One set of tick marks indicate expected peak positions and relative intensities for cubic TiN (Fm3̅m, space group #230, ICSD #00-038-1420), while the other set of tick marks (marked with *) indicate tetragonal anatase TiO₂ (I4₁/amd, space group #141, ICSD #01-070-7348). (n) Nitrogen sorption isotherm of the asymmetric carbon. (h) BJH derived pore size distribution of the asymmetric carbon.

FIG. 9 shows characterization of BCP SA directed alternating gyroidal mesoporous TiN treated to 600° C. in ammonia. (a) Low magnification SEM of the cross-section. (b) Higher magnification SEM of the top surface. (c) Higher magnification SEM of the cross-section. (d) Small-angle x-ray scattering pattern with tick marks indicating the expected peak positions for the alternating gyroid (I4₁32, space group #214) structure. (e) XRD pattern with tick marks indicating expected peak positions and relative intensities for cubic TiN (ICSD #00-038-1420). (f) Nitrogen sorption isotherms. (g) BJH derived pore size distribution.

FIG. 10 shows asymmetric TiN (a, c, e) and alternating gyroidal mesoporous TiN (b, d, f) cyclic voltammograms normalized by (a, b) electrode area, (c, d) electrode mass, and (e, f) surface area. All results were collected in Ar-saturated 0.1 mol L⁻¹ HClO₄ electrolyte. Scan rates shown: 1 V s⁻¹, 2 V s⁻¹, 3 V s⁻¹, 4 V s⁻¹, and 5 V s⁻¹.

FIG. 11 shows scan rate dependence of gravimetric integral capacitance for a asymmetric TiN and an alternating gyroidal mesoporous TiN. Error bars represent the standard deviation of three independent measurements. All results were collected in Ar-saturated 0.1 mol L⁻¹ HClO₄ electrolyte.

FIG. 12 shows electrochemical characterization of asymmetric TiN and alternating gyroidal mesoporous TiN without iR compensation. Cyclic voltammograms for asymmetric TiN and gyroidal mesoporous TiN at (a) 50 mV s⁻¹ and (b) 5 V s⁻¹. (c) Scan rate dependence of specific integral capacitance for asymmetric TiN and gyroidal mesoporous TiN showing improved surface accessibility for asymmetric TiN. (d) Scan rate dependence of gravimetric integral capacitance for asymmetric TiN and gyroidal mesoporous TiN. Error bars represent the standard deviation of three independent measurements. All results were collected in Ar-saturated 0.1 mol L⁻¹ HClO₄ electrolyte.

FIG. 13 shows (a) cyclic voltammograms for asymmetric carbon at 1 V s⁻¹, 2 V s⁻¹, 3 V s⁻¹, 4 V s⁻¹, and 5 V s⁻¹. (b) Scan rate dependent gravimetric and specific integral capacitance for asymmetric carbon. Error bars represent the standard deviation of three independent measurements. All results were collected in Ar-saturated 0.1 mol L⁻¹ HClO₄ electrolyte.

FIG. 14 shows XRD patterns at various steps in the processing on the way to asymmetric TiN with superconducting properties. From bottom to top: amorphous ISV/oxide hybrid heat-treated to 130° C. Freestanding asymmetric oxide heat-treated to 400° C. in air. One set of tick marks indicate the expected peak positions and relative intensities for tetragonal anatase (TiO₂) (ICSD 01-070-7348). Freestanding asymmetric superconducting TiN heat-treated to 865° C. in ammonia. The other set of tick marks indicate expected peak positions and relative intensities for cubic TiN (ICSD 00-038-1420).

FIG. 15 shows a photograph of a bonded asymmetric TiN prior to conductivity measurement.

FIG. 16 shows superconducting TiN cyclic voltammograms normalized by (a) electrode area, and (b) electrode mass. (c) Scan rate dependence of gravimetric integral capacitance for superconducting TiN. Error bars represent the standard deviation of three independent measurements. All results were collected in Ar-saturated 0.1 mol L⁻¹ HClO₄ electrolyte.

FIG. 17 shows a synthesis schematic of a CNIPS process and subsequent heat-treatments. ISV triblock terpolymer was dissolved in 7:3 (by weight) DOX:THF and TiO₂ sol NPs in THF were added. The homogeneous casting solution was pipetted onto a glass slide and a film of specified thickness was cast. The solvents were evaporated for a specified amount of time on the order of seconds to induce a concentration gradient. Upon immersion into a DI water bath, the polymer was precipitated, converting the ISV+TiO₂ concentration gradient into a structural gradient. The resulting membranes were dried at RT and up to 130° C. in a vacuum oven. They were then subjected to heat-treatment a flow furnace that was open to air (300, 400, and 500° C.). This led to the decomposition of the polymer and formation of a freestanding oxide. The oxide was then subjected to heat-treatment in ammonia (600° C.) to form titanium nitride. In one route, the 130° C. hybrid was directly heat-treated to the nitride without first treating the oxide in air. Photographs of the materials at each synthetic step are shown at the bottom.

FIG. 18 shows SEM micrographs of (a) as-made ISV+TiO₂ hybrid membranes and (b) TiO₂ materials heated to 500° C. with a dwell time of 3 h (h=hour(s)) before being allowed to cool to RT. From left to right, evaporation times range from 45 s, 60 s, 75, to 90 s. From top to bottom for both (a) and (b) top surface, asymmetric cross-section, and macroporous bottom surface.

FIG. 19 shows SEM micrographs of oxides and nitrides obtained from different heating protocols. High magnification top surface SEM of (a) 130° C. organic/inorganic hybrid, (b) 300° C. oxide, (c) 400° C. oxide, and (d) 500° C. oxide. SEM of (e) nitride obtained directly from the 130° C. hybrid, (f) 300° C. nitride, (g) 400° C. nitride, and (h) 500° C. nitride. Row two shows the top surface, row three the cross-section, and row four an image of the bottom surface. All oxides and nitrides were made from hybrids evaporated for 75 s.

FIG. 20 shows XRD patterns of the corresponding to the four pathways to obtaining TiN (blue) and their corresponding precursors (hybrids and oxides). One set of tick marks correspond to the expected peak positions and relative intensities of to a tetragonal crystal system of anatase TiO₂ (I41/amd, space group #141, ICSD #01-070-7348). The other set of tick marks correspond to the expected peak positions and relative intensities for cubic TiN (Fm3̅m, space group #225, ICSD #00-038-1420).

FIG. 21 shows electrochemical characterization of asymmetric, hierarchical TiN. Cyclic voltammograms for TiN monoliths derived from (a) 300° C. oxide, (b) 400° C. oxide, (c) 130° C. hybrid. Scan rates shown include: 50 mV s⁻¹, 200 mV s⁻¹, 500 mV s⁻¹, 1 V s⁻¹. (d) Scan rate dependence of specific integral capacitance for asymmetric TiN showing improved specific integral capacitance with more complete polymer removal. All results were collected in Ar-saturated 0.1 mol L⁻¹ HClO₄.

FIG. 22 shows characterization of anatase and rutile materials. SEM of (a) as-made TiO₂ and (b)-(e) TiO₂ membranes heated to (b) 500° C., (c) 700° C., (d) 825° C., and (e) 875° C. From top to bottom, images depict the top surface, the asymmetric cross-section, bottom surface, and a higher magnification micrograph of the bottom surface showing mesopores. (f) Powder XRD corresponding to the various heating temperatures from bottom to top of 500° C., 700° C., 825° C., and 875° C. One set tick marks correspond to the expected peak positions and relative intensities of a tetragonal crystal system of anatase TiO₂ (I4₁/amd, space group #141, ICSD #01-070-7348). Another set of tick marks correspond to the expected peak positions and relative intensities of a tetragonal crystal system of rutile TiO₂ (P4₂/mnm, space group #136, ICSD #00-021-1276).

FIG. 23 shows XRD corresponding to TiO₂ membranes in FIG. 18 with evaporation times of 45 s, 60 s, 75 s, and 90 s. One set of tick marks correspond to the expected peak positions and relative intensities of a tetragonal crystal system of anatase TiO₂ (I41/amd, space group #141, ICSD #01-070-7348).

FIG. 24 shows a representative SEM of the as-made organic/inorganic hybrid materials resulting from 75 s (s=second(s)) evaporation time. The top surface (a) is closed. The cross-section (b) is asymmetric. The bottom (c) has accessible macropores. A higher magnification of the wall of one of the macropores is shown in (d).

FIG. 25 shows a representative SEM micrograph of as-made organic/inorganic hybrid materials heated to 130° C. resulting from 75 s evaporation time. The top surface (a) is closed, yet the hexagonal packing is becoming more evident. The cross-section (b) is asymmetric. The bottom (c) has accessible macropores. A higher magnification of the wall of one of the macropores is shown in (d).

FIG. 26 shows SEM micrographs of the (a) 130° C. organic/inorganic hybrid (b) 300° C. oxide, (c) 400° C. oxide and (d) 500° C. oxide. From top to bottom: Cross-section, bottom surface, higher magnification of the wall of a macropore.

FIG. 27 shows thermogravimetric analysis (TGA) plots of the 130° C. organic/inorganic hybrid treated to 300° C., 400° C., and 500° C. each at a ramp rate of 1° C. min⁻¹ with a dwell time of 3 h in air.

FIG. 28 shows nitrogen sorption (left column) and pore size distribution graphs (right column) for the various oxides. (a, b) correspond to the 500° C. oxide, (c, d) correspond to the 400° C. oxide, and (e, f) correspond to the 300° C. oxide.

FIG. 29 shows nitrogen sorption (left column) and pore size distribution graphs (right column) for the various TiN. (a, b) correspond to the 400° C. nitride, (c, d) correspond to the 300° C. nitrides, and (e, f) correspond to the TiN derived from the 130° C. hybrid ISV+TiO₂.

FIG. 30 shows electrochemical characterization of asymmetric, hierarchical TiN. Cyclic voltammograms for TiN monoliths derived from 300° C. oxide, 400° C. oxide, 130° C. hybrid at 50 mV s⁻¹ (a) and 1 V s⁻¹ (b) showing increased specific capacitive current with more complete polymer removal. (c) Scan rate dependence of gravimetric integral capacitance for asymmetric TiN showing similar gravimetric integral capacitance for all samples, suggesting that the residual carbon does not have a significant effect on charge storage. (d) Percent capacitance retention for each material indicating reduced capacitance retention at fast scan rates for TiN derived from 300° C. oxide, possibly due to residual carbon inhibiting ion diffusion at high flux. All results were collected in Ar-saturated 0.1 mol L⁻¹ HClO₄.

FIG. 31 shows a schematic representation of chemical components and CNIPS process pathways. Typically a 2:1 weight ratio of ISV and resols in a 7:3 ratio (by weight) of DOX:THF were cast onto a glass slide. The starting solutions were prepared by either a “simultaneous” or a “consecutive method” as indicated. The solutions were evaporated for a specific amount of time to induce a concentration gradient, and plunged into a DI water bath whereby the polymer was precipitated, converting the concentration gradient into a structural gradient. The resulting asymmetric membranes were subjected to a series of heat-treatments to crosslink the resols (130° C.) and carbonize the system (900° C.). The BCP decomposes during carbonization leading to shrinkage and additional mesoporosity.

FIG. 32 shows small-angle x-ray scattering patterns of solutions of (a) parent ISV, (b) simultaneous method ISV+resols (2:1 ISV:resols by weight), (c) consecutive method ISV+resols (2:1 ISV:resols by weight), (d) selected pattern of consecutive method at 19 weight % (wt % or also referred to as % by mass or also mass fraction) ISV+resols (2:1 ISV:resols by weight). All solutions were 7:3 DOX:THF (by weight). Tick marks indicate expected peak positions for a body-centered cubic (BCC) lattice relative to the observed primary peak. The (a) ISV concentrations and (b, c, d) ISV+resols concentrations are reported with each trace.

FIG. 33 shows selected in situ GISAXS patterns of solutions of (a) 10 wt % ISV, (b) 10 wt % ISV+resols simultaneous method (2:1 ISV:resols by weight), (c) 10 wt % ISV+resols consecutive method (2:1 ISV:resols by weight) cast and evaporated for various times. The two images boxed (a) 40 s and (c) 22 s were indexed in (d) and (e), respectively. All solutions were 7:3 DOX:THF (by weight). Spot markings in (d) and (e) correspond to those expected for a SC (simple cubic) lattice with the (001) plane parallel to the surface and lattice parameters of 38 nm and 39.5 nm, respectively.

FIG. 34 shows SEM characterization of membranes prepared from (a) 9.9 wt % ISV, (b) 10 wt % ISV+resols (2:1 ISV:resols weight ratio) and via the simultaneous method, and (c) 10 wt % ISV+resols (2:1 ISV:resols weight ratio) and via the consecutive method. The solutions were in 7:3 DOX:THF (by weight), cast, and evaporated for (a) 45 s on a RT (˜20° C.) substrate, or (b+c) 40 s on a 30° C. substrate, respectively. All films were cast at low relative humidity (<30%) and plunged into a RT (˜20° C.) nonsolvent DI water bath. Micrographs from top to bottom respectively show top surface, cross-section, bottom surface, and a zoomed-in image from the macroporous region of the membrane. Scale bars are the same in all rows as indicated on the left.

FIG. 35 shows top surface (top rows) and cross-section (bottom rows) SEM characterization of (a) as-made and (c) corresponding carbonized membranes prepared via the simultaneous method from an 11 wt % ISV+resols (2:1 ISV:resols weight ratio) solution in 7:3 DOX:THF (by weight). SEM characterization of (b) as-made and (d) corresponding carbonized membranes prepared via the consecutive method from a 10 wt % ISV+resols (2:1 ISV:resols weight ratio) solution in 7:3 DOX:THF (by weight). The films were cast at the same height. However, with increased evaporation time from 20 to 40s (left to right), more solvent evaporates, producing denser and thus thinner thickness membranes. The films were cast at low relative humidity (<30%) onto a 30° C. heated substrate, and allowed to evaporate for various amounts of time (20-40 s, as indicated) before being plunged into a RT (˜20° C.) nonsolvent DI water bath. Scale is the same for all rows as indicated by scale bars on the left side.

FIG. 36 shows characterization of carbon materials carbonized from membranes which were obtained from 11 wt % ISV+resols (2:1 ISV:resols weight ratio) solutions in 7:3 DOX:THF (by weight) prepared via the simultaneous method, cast onto a 30° C. heated substrate, allowed to evaporate at low relative humidity conditions (<30%) for 40 s before being plunged into a RT (˜20° C.) nonsolvent DI water bath, dried, cross-linked at 130° C. for <24 h, and carbonized. The temperature profile for the carbonizing step was first heating at a rate of 1° C. min⁻¹ to 600° C. The temperature was held at 600° C. for 3 h before being further ramped at 5° C. min⁻¹ to 900° C., where it was held for 3 h before being allowed to cool back to room temperature. (a)-(g) Scanning electron micrographs: (a)-(c) Top surface images at different magnifications, (d) full asymmetric cross-section, (e) mesoporous middle part of cross-section, (f) higher magnification mesoporous middle part of cross-section, (g) macroporous bottom. (h) Nitrogen sorption isotherms of the carbonized material. (i) BJH derived pore size distribution of the final carbonized membrane material.

FIG. 37 shows characterization of carbon material carbonized from membranes which were obtained from 10 wt % ISV+resols (2:1 ISV:resols weight ratio) solutions in 7:3 DOX:THF (by weight) prepared via the consecutive method, cast onto a 30° C. heated substrate, allowed to evaporate at low relative humidity conditions (<30%) for 40 s before being plunged into a RT (˜20° C.) nonsolvent DI water bath, dried, cross-linked at 130° C. for <24 h, and carbonized. The temperature profile for the carbonizing step was first heating at a rate of 1° C. min⁻¹ to 600° C. The temperature was held at 600° C. for 3 h before being further ramped at 5° C. min⁻¹ to 900° C., where it was held for 3 h before being allowed to cool to room temperature. (a)-(g) Scanning electron micrographs: (a)-(c) Top surface at different magnifications, (d) full asymmetric cross-section, (e) mesoporous middle part of cross-section, (f) higher magnification mesoporous middle part of cross-section, (g) macroporous bottom. (h) Nitrogen sorption isotherms of the carbonized material. (i) BJH derived pore size distribution of the final carbonized material.

FIG. 38 shows small-angle x-ray scattering (SAXS) patterns of solutions of (a) parent ISV, (b) simultaneous method ISV+resols (2:1 ISV:resols by weight), and (c) consecutive method ISV+resols (2:1 ISV:resols by weight). All solutions were 7:3 DOX:THF (by weight). Tick marks indicate expected peak positions for a body-centered cubic (BCC) morphology relative to the observed primary peak. The (a) ISV concentrations and (b, c) ISV+resols concentrations are reported next to each trace, ranging from about 1 wt % to 20 wt %. (d) provides a table consistent in color coding to wt % dependent traces in a-c with the corresponding d spacings, where applicable. Light gray text marks spacings given for traces which were analyzed assuming a BCC lattice but do not show evidence of BCC ordering. These values are given merely as a reference to indicate expected lattice spacings based solely off of the primary peak.

FIG. 39 shows in-situ GISAXS patterns of (a) 7.9 wt % and (b) 10 wt % solutions of parent ISV terpolymer in 7:3 DOX:THF (by weight) solutions cast and evaporated for varying amounts of time as indicated. The two images boxed in (a) and (b) were indexed in (c) and (d), respectively. Patterns were indexed to a simple cubic (SC) lattice with the (001) plane parallel to the surface and lattice parameters of 39.5 nm and 38 nm for (c) and (d), respectively.

FIG. 40 shows in-situ GISAXS patterns of (a) 8.0 wt %, (b) 10 wt %, (c) 12 wt %, (d) 15 wt % ISV+resols (2:1 ISV:resols weight ratio) in 7:3 DOX:THF (by weight) solutions prepared via the simultaneous method, cast, and evaporated for varying times as indicated. Some disordered structure is evidenced by broad amorphous rings. No long-range order is evident from these diffractograms.

FIG. 41 shows in-situ GISAXS patterns of (a) 8.0 wt %, (b) 10 wt %, (c) 13 wt %, and (d) 15 wt % ISV+resols (2:1 ISV:resols weight ratio) in 7:3 DOX:THF (by weight) solutions prepared via the consecutive method, cast, and evaporated for varying amounts of time as indicated. The images boxed in (a), (b), (c), and (d) are indexed in FIG. 42 (a), (b), (c), and (d), respectively.

FIG. 42 shows selected in situ GISAXS patterns from FIG. 42 of (a) 8.0 wt %, (b) 10 wt %, (c) 13 wt %, and (d) 15 wt % ISV+resols (2:1 ISV:resols weight ratio) in 7:3 DOX:THF (by weight) solutions prepared via the consecutive method cast and evaporated for 31 s, 22 s, 13 s, 21 s, respectively. Patterns for (a), (b), and (c) were indexed to an SC lattice with the (001) plane parallel to the surface and lattice parameters of 40.5 nm, 39.5 nm, 39.5 nm, respectively. The pattern of the 15 wt % ISV+resols sample evaporated for 21 s was best indexed by a BCC lattice with the (110) plane parallel to the film surface and a lattice parameter of 58 nm.

FIG. 43 shows top surface (top row) and cross-section (bottom row) SEM characterization of 9.9 wt % ISV in 7:3 DOX:THF (by weight), evaporated on a RT (˜20° C.) substrate at low relative humidity (<30%) for 30 s (left column) and 45 s (right column), and subsequently plunged into a RT (˜20° C.) nonsolvent DI water bath.

FIG. 44 shows top surface (top rows) and cross-section (bottom rows) SEM characterization of (a) 10 wt % and (b) 15 wt % ISV+resols (2:1 ISV:resols weight ratio) in 7:3 DOX:THF (by weight) solutions cast via the consecutive method on a room temperature (˜20° C.) substrate under low (<30%) relative humidity, and allowed to evaporate for various amounts of times. The films were plunged into a RT (˜20° C.) nonsolvent DI water bath.

FIG. 45 shows top surface (top rows) and cross-section (bottom rows) SEM characterization of (a) 10 wt % and (b) 15 wt % ISV+resols (2:1 ISV:resols weight ratio) in 7:3 DOX:THF (by weight) solutions cast via the consecutive method on a substrate heated to 30° C. under low (<30%) relative humidity, and allowed to evaporate for various amounts of time. The films were plunged into a RT (˜20° C.) nonsolvent DI water bath.

FIG. 46 shows top surface (top rows) and cross-section (bottom rows) SEM characterization of a 10 wt % ISV+resols (2:1 ISV:resols weight ratio) in 7:3 DOX:THF (by weight) solution cast via the simultaneous method on (a) a RT (˜20° C.) and (b) a substrate heated to 30° C. under low (<30%) relative humidity, and allowed to evaporate for various amounts of time. The films were plunged into a RT (˜20° C.) nonsolvent DI water bath.

FIG. 47 shows top surface (top rows) and cross-section (bottom rows) SEM characterization of a 10 wt % ISV in 7:3 DOX:THF (by weight) solution cast under high relative humidity (˜70%) on (a) a RT (˜20° C.) and (b) a substrate heated to 30° C., and allowed to evaporate for various amounts of time. The films were plunged into a RT (˜20° C.) non-solvent DI water bath.

FIG. 48 shows top surface (top row) and cross-section (bottom row) SEM characterization of a 10 wt % ISV+resols (2:1 ISV:resols weight ratio) in 7:3 DOX:THF (by weight) solution prepared via the consecutive method and cast at low (<30%) relative humidity on a 30° C. substrate and dipped into a RT (˜20° C.) (left), a 40° C. (middle), and a 4° C. (right) DI water bath.

FIG. 49 shows FFT analysis of SEM images of the top surface of the membranes for (a) ISV membrane, (b) ISV+resols (2:1 ISV:resols weight ratio) derived membrane from simultaneous method as-made, or stirred in DI water overnight, (c) ISV+resols (2:1 ISV:resols weight ratio) derived membrane from consecutive method as-made, or stirred in DI water overnight. Cubic ordering is only evident for ISV and ISV+resols consecutive method derived membranes. Tick marks indicate expected peak positions for a 2D square lattice. q* positions yield pore-to-pore distances of 39 nm for the ISV membrane, as well as 32 nm and 40 nm for as-made membrane and a membrane stirred overnight in the DI water bath.

FIG. 50 shows SEM characterization of (a) as-made and (b) 130° C. heat-treated membranes obtained via the simultaneous method from an 11 wt % ISV+resols (2:1 ISV:resols weight ratio) solution. SEM characterization of (c) as-made and (d) 130° C. heat treated membranes obtained via the consecutive method from a 10 wt % ISV+resols (2:1 ISV:resols weight ratio) solution. The evaporation time for all membranes was 40 s. From top to bottom: Top surface, cross-section, enlarged cross-section of mesoporous top surface, enlarged mesopores in the walls of the macroporous pockets towards the bottom membrane region, and bottom surface. Membranes were cast onto a 30° C. substrate at low relative humidity (<30%), and dipped into a RT (˜20° C.) nonsolvent DI water bath.

FIG. 51 shows thermogravimetric analysis (TGA) of 130° C. heat-treated ISV and ISV+resols (2:1 ISV:resols weight ratio) hybrid membranes from both the simultaneous and consecutive methods.

FIG. 52 shows top surface (top rows) and cross-section (bottom rows) SEM characterization of (a) as-made and (b) carbonized membranes cast from 15 wt % ISV+resols (2:1 ISV:resols weight ratio) solution made via the consecutive method and allowed to evaporate for two different times, as indicated. Membranes were cast at low relative humidity (<30%), onto 30° C. substrates, and plunged into RT (˜20° C.) nonsolvent DI water bath.

FIG. 53 describes various examples of methods of the present disclosure. A hybrid film may be a polymer and carbon precursor film or a polymer and metal oxide precursor film.

### DETAILED DESCRIPTION OF THE DISCLOSURE

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value).

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent, trivalent, and the like, radicals). Illustrative examples of groups include:

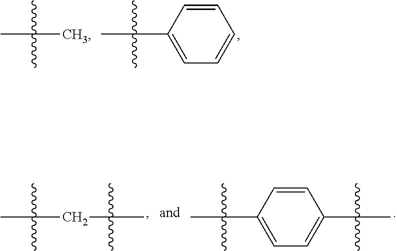

Molecular weight for any of the instances of molecular weight described herein, unless otherwise indicated, may be determined by a method disclosed herein. For example, the molecular weight is determined by gel permeation chromatography.

The present disclosure provides films and methods of making the films. The present disclosure also provides devices.

In the present disclosure, attributes such as, for example, asymmetric/hierarchical pore structures and well-defined mesopores, are combined and a scalable path to inorganic materials, such as, for example, porous titanium nitride (TiN) and carbon membranes that are conducting (TiN, carbon) or superconducting (TiN), demonstrated. In various examples, materials of the present disclosure exhibit a combination of asymmetric, hierarchical pore structures and well-defined mesoporosity throughout the material. In various examples, materials of the present disclosure exhibit desirable internal surface area and desirable flux. Fast transport through such TiN materials as an electrochemical double-layer capacitor provides a substantial improvement in capacity retention at high scan rates, resulting in state-of-the-art power density (28.2 kW kg⁻¹) at competitive energy density (7.3 W-h kg⁻¹). In the case of carbon membranes, a record-setting power density (287.9 kW kg⁻¹) at 14.5 W-h kg⁻¹ was demonstrated. Based on the results described herein, it is expected that such pore architectures will provide distinct advantages for energy storage and conversion applications and provide an advanced avenue for addressing the tradeoff between high-surface-area and high-flux requirements.

In an aspect, the present disclosure provides films. The films may be referred to as asymmetric porous films or asymmetrically porous films. The films have asymmetric pore structures along the film normal. A film has a surface layer, which may be referred to as a top surface layer, and support layer, which may be referred to as a bulk layer or a substructure. A film may have a surface layer, which may be an isoporous surface layer, disposed on a graded porous substructure. The graded porous substructure may exhibit a combination of asymmetric pore structure from mesopores at one side (e.g., the top) to macropores at a second side (e.g., the bottom) and the substructure also has mesopores throughout as a result of block copolymer self-assembly. In other words, the pore walls, e.g., of the macropores of the substructure themselves are mesoporous. Without intending to be bound by any particular theory, it is considered that this porosity combination results in materials exhibiting desirable properties (e.g., a combination of high surface area and high transport characteristics important, e.g., for energy storage and conversion applications). In various examples, a film of the present disclosure is made by a method of the present disclosure. Non-limiting examples of films are provided herein.

An asymmetric porous film may have hierarchical porosity (e.g., a hierarchical porous substructure) and/or a well-defined mesoporosity throughout the material. The asymmetric porous film (e.g., the bulk layer) may have a continuous pore size gradient along the film normal. The support layer may have a finger-like structure or a sponge-like structure. The support layer may have a macroporous substructure. The film along an axis from a first side of the film to a second side of the film opposite the first side, the film may have an overall continuous pore gradient and/or pore asymmetry, where the pores are mesopores at (or proximal to) a first side to macropores at (or proximal to) the second side (e.g., mesopores and macropores are terms defined by the IUPAC). The pores, individually, may comprise porous walls, e.g., creating a hierarchical porosity within the film. The substructure may have mesopores throughout. For example, at least a portion of or all of the macropore walls comprise mesopores.

An asymmetric porous film may be a film with a mesoporous top surface layer that merges into a substructure with graded porosity, which may have macropores at the bottom. The asymmetric film may have a continuous pore size gradient along the film normal. The walls of the macropores in the substructure may have mesopores, and potentially micropores (e.g., if made using a carbon precursor or comprising porous carbon), thus forming a hierarchically porous substructure (the asymmetric porous film thus has a graded porosity and, at the same time, is hierarchically structured, and has may have mesopores throughout the film). A film may comprise macropores with mesopores and/or micropores. In the case of carbon films, such films may comprise micropores (i.e., pores below 2 nm diameter).

An asymmetric porous film may comprise a top surface layer disposed on a substructure, which in turn shows the graded porosity, with mesopores right at the interface with the top surface layer as well as everywhere else throughout the substructure, and macropores at the side of the substructure opposite the top surface layer.

A surface layer may have a thickness of 20 nm to 500 nm, including all 0.1 nm values and ranges therebetween, and/or a plurality of pores. Each pore, independently, may have a size (e.g., of one or more dimension(s), which may be linear dimension(s)) of 5 nm to 100 nm, including all 0.1 nm values and ranges therebetween. A size of the pores in the surface layer may have a pore size distribution of less than 3, where the pore size distribution is the ratio of the maximum pore diameter (dₘₐₓ) to the minimum pore diameter (dₘᵢₙ).

An asymmetric porous film as a bulk layer. The bulk layer may have a thickness of 5 microns to 500 microns, including all 0.1 nm values and ranges therebetween, and/or a plurality of pores. Each pore, independently, may have a size (e.g., of one or more dimension(s), which may be linear dimension(s), of 10 nm to 100 microns, including all 0.1 nm values and ranges therebetween, 10 nm to 100 microns, and/or an asymmetric substructure).

An asymmetric film may be a continuous material. In an example, the asymmetric film is not composite material or composite membrane comprising two or more discrete, pre-formed layers.

An asymmetric film (e.g., a surface layer and/or a support layer) may have a three-dimensional structure. The three-dimensional structure may be a three-dimensional carbon structure, a three-dimensional metalloid structure, a three-dimensional metal structure, a three-dimensional metal oxide structure, a three-dimensional metal nitride structure, a three-dimensional metal oxynitride structure, a three-dimensional metal carbide structure, a three-dimensional metal carbonitride structure, or a combination thereof. A three-dimensional carbon structure may be a three-dimensional doped carbon (e.g., N-doped or the like) structure. A three-dimensional metalloid oxide structure may be a three-dimensional silica or the like, or a combination thereof, structure. A three-dimensional metal oxide structure may be a three-dimensional transition metal oxide or a p-block metal oxide structure, such as, for example, aluminum oxides and the like, or the like, or a combinations thereof structure.

At least a portion or all of the carbon, or metal, or metal oxide, or metal nitride, metal oxynitride, metal carbide, metal carbonitride, or a combination thereof is mesoporous (e.g., mesoporous according the IUPAC definition of mesoporous). At least a portion or all of the carbon, or metal, or metal oxide, or metal nitride, metal oxynitride, metal carbide, metal carbonitride, or a combination thereof may or may not (e.g., in the case of a carbon film) have one or more crystalline and/or polycrystalline domains, be polycrystalline, or be single crystalline (any of which may be detected by x-ray diffraction). A top surface layer may be an isoporous surface layer.

An asymmetric porous film may comprise one or more multiblock copolymer(s), one or more thermal decomposition product(s) of the multiblock copolymer(s), or a combination thereof. Non-limiting examples of multiblock copolymers are described herein. In various examples, an asymmetric porous film does not comprise a multiblock copolymer, a thermal decomposition product of the multiblock copolymer, or a combination thereof.

An asymmetric porous film may comprise one or more self-assembled multiblock copolymer(s) and one or more precursor(s). These films may be referred to as hybrid asymmetric films, hybrid films, or precursor films.

An asymmetric porous film may be a hybrid asymmetric porous film and may also comprise one or more homopolymer(s). The choice of homopolymer may depend on the blocks of the multiblock copolymer(s) used. Without intending to be bound by any particular theory, it is considered that inclusion of homopolymer(s) can result in swelling of the film. For example, if ISV is used, poly(isoprene), poly(styrene), poly(4-vinylpyridine), or a combination thereof may be used as additive/additives, which would selectively swell the respective domains of the block copolymer. Non-limiting examples of homopolymers are described herein. An asymmetric porous film may be a hybrid asymmetric porous film and may also comprise one or more small molecule(s). Without intending to be bound by any particular theory, it is considered that a small molecule/small molecules can selectively swell the micelle pores, resulting in an increase in pore diameters. It may be desirable to use a non-toxic small molecule. Non-limiting examples of small molecules are described herein. An asymmetric porous film may be a hybrid asymmetric porous film comprising homopolymer(s) and/or small molecule(s). The homopolymer and/or small molecule is blended in the multi-block copolymer. The homopolymer and/or small molecule may preferentially associate with one of the blocks of the multi-block copolymer and locate in the vicinity of that block. For example, poly(phenylene oxide) can mix with a poly(styrene) block of a multi-block copolymer. For example, poly(butadiene) can mix with a poly(isoprene) block of a multiblock copolymer.

A variety of homopolymers can be used. For example, any homopolymer that has the same chemical composition as or can hydrogen bond to at least one block (e.g., the hydrogen-bonding block) of the multi-block copolymer can be used. The homopolymer may have hydrogen bond donors or hydrogen bond acceptors. Examples of suitable homopolymers include, but are not limited to, poly(4-vinyl) pyridine), poly(acrylic acid)s, polystyrenes (e.g., substituted analogs thereof, such as, for example, poly(hydroxystyrene and the like), polyisoprene, and the like, and combinations thereof. In cases where the multi-block copolymer has a hydrogen-bonding block, it is desirable that the homopolymers or small molecules have a low or negative chi parameter with the hydrogen-bonding block (e.g., poly(4-vinyl)pyridine). A range of ratios of multi-block copolymer to homopolymer can be used. The homopolymer can have a range of molecular weight. For example, the homopolymer can have a molecular weight of 5×10² g/mol to 5×10⁴ g/mol, including all integer g/mol values and ranges therebetween.

A variety of small molecules can be used. For example, any small molecule that can hydrogen bond to at least one block of the multi-block copolymer can be used. The small molecule can have hydrogen bond donors or hydrogen bond acceptors. Examples of suitable small molecules include, but are not limited to, glycerol, pentadecylphenol, dodecylphenol, 2-4′-(hydroxy benzeneazo)benzoic acid (HABA), 1,8-naphthalene dimethanol, 3-hydroxy-2-naphthoicacid, and 6-hydroxy-2-naphthoicacid, and the like. A range of ratios of multi-block copolymer to small molecule can be used.

Various amounts of homopolymer(s) and small molecule(s) can be used. In various examples, the molar ratio of multiblock copolymer(s) to homopolymer(s) is 1:0.05 to 1:10 (e.g., 1:0.05 to 1:1), including all 0.01 ratio values and ranges therebetween, and/or the molar ratio of multiblock copolymer(s) to small molecule(s) is 1:1 to 1:1000, including all 0.01 ratio values and ranges therebetween.

An asymmetric porous film can have various thicknesses. In various examples, a film has a thickness of 5 microns to 500 microns, including all 0.1 micron values and ranges therebetween.

An asymmetric porous film may have a surface area of 10 to 3000 m²/g, including all 0.1 m²/g values and ranges therebetween. The surface area of a film may be determined by BET analysis.

An asymmetric porous film can have various structures. An asymmetric porous film may be a continuous structure and/or a free-standing structure. An asymmetric porous film may have a sponge-like substructure or may have a finger-like substructure.

With regard to nitrogen sorption of asymmetric porous nitride film, the film may exhibit a type IV curve and/or H₁-type hysteresis and/or sharp capillary condensation (e.g., above relative pressures of 0.99). An asymmetric porous metal nitride film may be superconducting at certain temperatures.

In an aspect, the present disclosure provides methods of making films. The methods comprise use of multiblock copolymers. Without intending to be bound by any particular theory, it is considered that the methods result in formation of non-equilibrium film structures. Non-limiting examples of methods of making films are provided herein.

In various examples, a method for forming an asymmetrical porous film comprises: forming a film comprising one or more multiblock copolymer(s) comprising one or more hydrogen-bonding block(s) that can self-assemble using a mixture comprising a solvent system and one or more carbon precursor(s), one or more metalloid oxide precursor(s), or one or more metal oxide precursor(s), or a combination thereof, removing at least a portion of the solvent system from the film; and contacting the film having at least a portion of the solvent system removed with a phase separation solvent system, which may be referred to a non-solvent or precipitation system or a phase inversion system, such that the asymmetrical porous film is formed. A method may comprise one or more heating step(s), one or more nitriding steps(s), one or more post-asymmetric-film-formation treating step(s), or a combination thereof.

A mixture, which may be referred to as a deposition solution, comprises one or more multiblock copolymer(s), a solvent system, and, optionally, one or more additive(s), which are used in combination to form the film or self-assemble the film on a substrate. A mixture may be referred to as a casting solution or dope. A mixture may be a solution. In an example, the film forming mixture does not comprise pre-formed nanoparticles.

Nanoparticles may be metal nanoparticles, metal oxide nanoparticles, or the like or a combination thereof.

A solvent system may comprise (or is) 1,4-dioxane (DOX) and, optionally, tetrahydrofuran (THF). In various examples, a solvent system comprise (or is) DOX:THF at a ratio of 7:3 by weight, based on the total amount of DOX and THF.

At least a portion of the solvent system may be removed. For example, at least a portion of the solvent system is removed by allowing at least a portion of the solvent to evaporate (e.g., by allowing the film to stand for a selected period of time).

Various phase separation solvent systems may be used. In various examples, a phase separation solvent system is an aqueous solution, such as, for example, water. A phase separation solvent system may be an anti or (non-)solvent for the multiblock copolymer(s) and/or precursor(s).

Asymmetric films having various asymmetric porosity profiles can be formed by altering process conditions, such as, for example, evaporation, concentration, and the like, and combinations thereof). In various examples, an asymmetric porous film for which the process (e.g., evaporation time and/or concentration) can be altered to change the asymmetric porosity profile, for example from a more sponge-like to a more finger-like asymmetric structure.

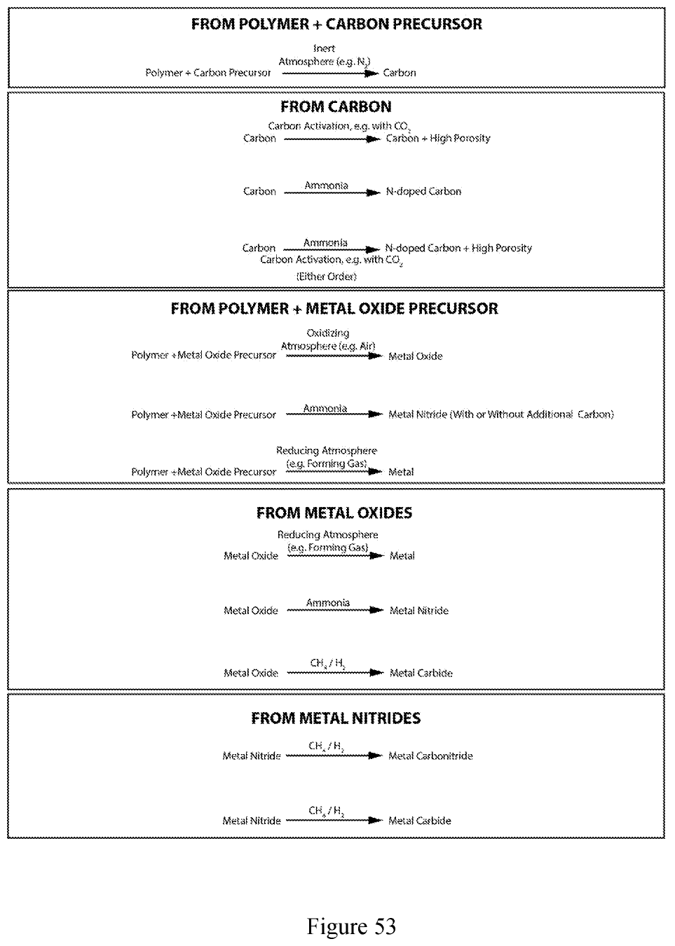

A method may comprise heating (e.g., as described herein) the asymmetrical porous film comprising the multiblock copolymer and the one or more precursor(s) (which may be referred to as a hybrid asymmetrical porous film) to form the asymmetrical porous film comprising one or more carbon (e.g., N-doped carbon), one or more metalloid oxide(s) (e.g., silica, and the like, and combinations thereof), one or more metal(s), one or more metal oxide(s) (e.g., transition metal oxide, p-block metal oxide (e.g., aluminum oxide and the like), and the like, and combinations thereof), one or more metal nitride(s), one or more metal oxynitride(s), one or more metal carbide(s), one or more metal carbonitride(s), or a combination thereof. The heating described herein (e.g., in FIG. 53) may be applied to a hybrid film, carbon film, metal oxide film, and/or metal nitride film of the present disclosure.

The heating may be carried out in a single step (with constant or varying temperature) or in multiple steps (each with the same or varying time and/or temperature). The heating (which for desired times and/or temperatures may be carried out in a selected atmosphere, such as, for example, a gaseous atmosphere (e.g., an inert atmosphere, such as, for example, argon, nitrogen, and the like, and combinations thereof, a reactive atmospheres, such as, for example, oxidizing atmospheres (e.g., air and the like), reducing atmospheres (e.g., forming gas and the like), ammonia, CO₂, H₂ (which may be reducing), CH₄, and the like, and combinations thereof)) may be carried out to remove all or substantially all of the multiblock copolymer and/or at least partially crosslink the carbon precursor(s), if present, and/or form the carbon, metal, metal oxide, metal nitride, metal oxynitride, metal carbide, metal carbonitride, or a combination thereof.

In the case of multiblock copolymer(s) and carbon precursor(s), the precursor film may be heated, for example, in an inert atmosphere at temperatures from 300° C. to 1600° C. (e.g., 850° C. to 1150° C.), including all 0.1° C. values and ranges therebetween. Desirable results were obtained using multiblock copolymer(s) and carbon precursor(s) and treating in inert atmosphere to 900° C.

Desirable results were obtained using multiblock copolymer(s) and metal oxide precursor(s) and treating the films in oxidizing conditions at 300° C. and 500° C., including all ° C. values and ranges therebetween (e.g., 400° C.), and following this with nitriding conditions (e.g., heating to 600° C. to form metal nitride, and to about 865° C. to form metal nitride with superconducting properties). As-made films derived from multiblock copolymer(s) and metal oxide precursor(s) may be treated (e.g., heated) directly to 600° C. under ammonia to result in metal nitride formation, i.e., without an intermediate step resulting in oxide film formation using oxidizing conditions.

A method may comprise treating (e.g., heating) (e.g., as described herein) the asymmetrical porous film (which may have a top surface layer (e.g., an isoporous surface layer) disposed on a graded porous substructure) comprising metal oxide under reducing conditions to form the asymmetrical porous film (which may have a top surface layer (e.g., an isoporous surface layer) disposed on a graded porous substructure) comprising metal.

In various examples, an as-made asymmetric film (e.g., precursor films) is heat treated (e.g., up to 130° C.) in air. In the case of resol precursor(s), this further cross-links the resol precursor(s). In the case of carbon film formation, those cross-linked films may be further heat treated (e.g., up to 900° C. or up to 1600° C.) under inert gas conditions (e.g., nitrogen or argon). In the case of nitride formation, after the first (e.g., 130° C.) heat treatment, there may be additional heat treatments (e.g., a second heat treatment (e.g., to 400° C.) in air, to convert the as-made hybrid film into an oxide; then a third heat treatment under ammonia (to 600° C.) in order to convert the oxide into a nitride; and an optional additional heat treatment (e.g., at 865° C.) under ammonia in order to improve the nitride quality and obtain a superconducting nitride. A metal (e.g., transition metal) oxides may be reduced to metal using a reducing atmosphere. This may be carried out under forming gas, which is 5% hydrogen in nitrogen.

A method may comprise nitriding (e.g., as described herein) the asymmetrical porous film comprising multiblock copolymer(s) and one or more metal oxide precursor(s). A method may comprise nitriding (e.g., as described herein) the metal oxide material. A method may comprise nitriding the carbon material, which may have been obtained from multiblock copolymer and carbon precursor having been previously treated in reducing conditions. These will lead to asymmetrical porous films comprising metal nitride and/or N-doped carbon.

In the case of nitridation of the asymmetric porous film of the multiblock copolymer and the one or more metal oxide precursor(s) (e.g., the hybrid asymmetric porous film), formation of the metal nitride, for example, is carried out at 550 to 900° C. (e.g., 550 to 650 or 800 to 900° C.), including all integer ° C. values and ranges therebetween. In the case of nitridation of the asymmetric porous film comprising metal oxide, and, optionally, carbon, formation of the metal nitride, for example, is carried out at 550 to 900° C. (e.g., 550 to 650 or 800 to 900° C.), including all integer ° C. values and ranges therebetween. In the case of nitridation of the asymmetric porous film comprising carbon, formation of the N-doped carbon, for example, is carried out at 550 to 900° C. (e.g., 550 to 650 or 800 to 900° C.), including all integer ° C. values and ranges therebetween.

A method may comprise treating (e.g., heating) (e.g., as described herein) the asymmetrical porous film comprising multiblock copolymer and the one or more carbon precursor in inert atmosphere to form the asymmetrical porous film comprising carbon.

Treating (e.g., heating) may be carried out in a gaseous atmosphere (e.g., an inert atmosphere, such as, for example, argon, nitrogen, and the like, and combinations thereof; a reactive atmospheres, such as, for example, oxidizing atmospheres (e.g., air and the like), reducing atmospheres (e.g., forming gas and the like), ammonia, CO₂, H₂ (which may be reducing), CH₄, and the like, and combinations thereof)).

A method may comprise treating (e.g., heating) (e.g., as described herein) the carbon asymmetrical porous film (which may have a top surface layer (e.g., an isoporous surface layer) disposed on a graded porous substructure) in oxidizing conditions, such as, for example, under carbon dioxide or the like, (e.g., to increase the surface area of the film).

A film may be formed using a “simultaneous method” or a “continuous method.” Non-limiting examples of each method are provided herein. In a “consecutive method” the multiblock copolymer is dissolved first (using solvent(s)) and the precursor(s) are added thereafter to the mixture. In a “simultaneous method” the precursor(s) is/are added to the solid multiblock copolymer and the solvent(s) is/are added thereafter to the mixture.

A variety of multiblock copolymers can be used. A multiblock copolymer that self-assembles may be used. Multiblock copolymers include, but are not limited to, terpolymers and the like. Without intending to be bound by any particular theory, it is considered that self-assembled multiblock copolymers may act as structure-directing materials. For example, the multiblock copolymer can be a diblock copolymer, triblock copolymer, tetrablock copolymer, pentablock copolymers, or higher order multiblock copolymer. In various examples, the multiblock copolymer is a triblock terpolymer having a structure of the form A-B-C, or A-C-B, or other variable arrangements or containing blocks of different chemical composition. In other examples, additional structures are higher order multi-block copolymer systems of the form A-B-C-B, or A-B-C-D, or A-B-C-B-A, or A-B-C-D-E, or other variable arrangements of these higher order systems. Multiblock copolymers can be synthesized by methods known in the art. For example, the copolymers can be synthesized using anionic polymerization, atom transfer radical polymerization (ATRP), or other suitable living polymerization techniques. Multiblock copolymers can also be obtained commercially.

A multiblock copolymer may be a diblock copolymer or a triblock copolymer. Non-limiting examples of diblock copolymers include poly(styrene)-b-poly(4-vinylpyridine); poly(styrene)-b-poly(2-vinylpyridine); poly(styrene)-b-poly(ethylene oxide); poly(styrene)-b-poly(methyl methacrylate); poly(styrene)-b-poly(acrylic acid); poly(styrene)-b-poly(dimethyl amino ethyl methacrylate); poly(styrene)-b-poly(hydroxystyrene); poly(α-methyl styrene)-b-poly(4-vinylpyridine); poly(α-methyl styrene)-b-poly(2-vinylpyridine); poly(α-methyl styrene)-b-poly(ethylene oxide); poly(α-methyl styrene)-b-poly(methyl methacrylate); poly(α-methyl styrene)-b-poly(acrylic acid); poly(α-methyl styrene)-b-poly(dimethyl amino ethyl methacrylate); poly(α-methyl styrene)-b-poly(hydroxystyrene); poly(isoprene)-b-poly(4-vinylpyridine); poly(isoprene)-b-poly(2-vinylpyridine); poly(isoprene)-b-poly(ethylene oxide); poly(isoprene)-b-poly(methyl methacrylate); poly(isoprene)-b-poly(acrylic acid); poly(isoprene)-b-poly(dimethyl amino ethyl methacrylate); poly(isoprene)-b-poly(hydroxystyrene); poly(butadiene)-b-poly(4-vinylpyridine); poly(butadiene)-b-poly(2-vinylpyridine); poly(butadiene)-b-poly(ethylene oxide); poly(butadiene)-b-poly(methyl methacrylate); poly(butadiene)-b-poly(acrylic acid); poly(butadiene)-b-poly(dimethyl amino ethyl methacrylate); and poly(butadiene)-b-poly(hydroxystyrene). Non-limiting examples of triblock copolymers include poly(isoprene)-b-poly(styrene)-b-poly(4-vinylpyridine); poly(isoprene)-b-poly(styrene)-b-poly(2-vinylpyridine); poly(isoprene)-b-poly(styrene)-b-poly(ethylene oxide); poly(isoprene)-b-poly(styrene)-b-poly(methyl methacrylate); poly(isoprene)-b-poly(styrene)-b-poly(acrylic acid); poly(isoprene)-b-poly(styrene)-b-poly(dimethyl amino ethyl methacrylate); poly(isoprene)-b-poly(styrene)-b-poly(hydroxystyrene); poly(isoprene)-b-poly(α-methyl styrene)-b-poly(4-vinylpyridine); poly(isoprene)-b-poly(α-methyl styrene)-b-poly(2-vinylpyridine); poly(isoprene)-b-poly(α-methyl styrene)-b-poly(ethylene oxide); poly(isoprene)-b-poly(α-methyl styrene)-b-poly(methyl methacrylate); poly(isoprene)-b-poly(α-methyl styrene)-b-poly(acrylic acid); poly(isoprene)-b-poly(α-methyl styrene)-b-poly(dimethyl amino ethyl methacrylate); poly(isoprene)-b-poly(α-methyl styrene)-b-poly(hydroxystyrene); poly(butadiene)-b-poly(styrene)-b-poly(4-vinylpyridine); poly(butadiene)-b-poly(styrene)-b-poly(2-vinylpyridine); poly(butadiene)-b-poly(styrene)-b-poly(ethylene oxide); poly(butadiene)-b-poly(styrene)-b-poly(methyl methacrylate); poly(butadiene)-b-poly(styrene)-b-poly(acrylic acid); poly(butadiene)-b-poly(styrene)-b-poly(dimethyl amino ethyl methacrylate); poly(butadiene)-b-poly(styrene)-b-poly(hydroxystyrene); poly(butadiene)-b-poly(α-methyl styrene)-b-poly(4-vinylpyridine); poly(butadiene)-b-poly(α-methyl styrene)-b-poly(2-vinylpyridine); poly(butadiene)-b-poly (α-methyl styrene)-b-poly(ethylene oxide); poly(butadiene)-b-poly(α-methyl styrene)-b-poly(methyl methacrylate); poly(butadiene)-b-poly (α-methyl styrene)-b-poly(acrylic acid); poly(butadiene)-b-poly(α-methyl styrene)-b-poly(dimethyl amino ethyl methacrylate); and poly(butadiene)-b-poly(α-methyl styrene)-b-poly(hydroxystyrene). In various examples, the multiblock copolymer is ISV (e.g., having the individual block volume fractions described herein).

The individual polymer blocks of a multiblock copolymer can have a broad molecular weight range. For example, blocks having a number averaged molecular weight (Mₙ) of from 1×10³ to 1×10⁷ g/mol including all 1 g/mol values and ranges therebetween.

A multiblock copolymer can have various hydrogen-bonding blocks. In various examples, the one or more hydrogen-bonding block(s) are chosen from poly(4-vinyl-pyridine), poly(2-vinyl-pyridine), poly(ethylene oxide), poly(methacrylic acid), poly(dimethyl amino ethyl methacrylate), poly(acrylic acid), poly(hydroxystyrene), and the like, and combinations thereof.

A multiblock copolymer may also comprise one or more hydrophobic block(s). In various examples, the multiblock copolymer further comprises one or more poly(styrene), such as, for example, poly(styrene) and poly(alpha-methyl styrene), blocks, one or more poly(ethylene) block(s), one or more poly(propylene) block(s), one or more poly(vinyl chloride) block(s), and one or more poly(tetrafluoroethylene) block(s), or the like, or a combinations thereof. The hydrophobic blocks(s) may be low T_{g} blocks chosen from poly(isoprene), poly(butadiene), poly(butylene), poly(isobutylene), and the like, and combinations thereof. The low T_{g} polymer block may have a Mₙ of from 1×10³ to 1×10⁶ g/mol. The multiblock copolymer may have a low T_{g} polymer block, a styrene block having a Mₙ of from 1×10³ to 1×10⁶ g/mol, and a 4-vinyl pyridine block having a Mₙ of from 1×10³ to 1×10⁶ g/mol.

Various precursors can be used. Combinations of precursors may be used. In various examples, one or more precursor(s), such as, for example, carbon precursor(s), metalloid oxide precursor(s), metal oxide precursor(s), and the like, and combinations thereof, are used. A precursor may be a nanoparticle. In various examples, a precursor is a nanoparticle having a longest linear dimension (e.g., a diameter) of 1 to 20 nm, including all 0.1 nm values and ranges therebetween. Non-limiting examples of carbon precursors, metalloid oxide precursors, and metal oxide precursors are provided herein.

A carbon precursor may be an organic molecule or compound that is hydrophilic and may associate with at least a portion of or all of the hydrophilic part of the multiblock copolymer. A carbon precursor may be cross-linkable (e.g., thermally cross-linkable). A carbon precursor may be an oligomer. The molecular weight (M_{w} and/or Mₙ) of the carbon precursor(s) may be 5,000 g/mol or less (e.g., about 500 g/mol). Various carbon precursor(s) may be used. Non-limiting examples of carbon precursors are provided herein.

In the case of carbon films, the carbon precursor(s) may be chemically crosslinked. In various examples, at least a portion of or all of the carbon precursor(s) are crosslinked via a condensation reaction. Non-limiting examples of carbon precursors include, but are not limited to, phenol and formaldehyde derived resols, resorcinol, formaldehyde derived resols, and the like. For example, after resols nanoparticle synthesis under basic conditions (e.g., using sodium hydroxide as a base), and asymmetric film formation using SNIPS, the resols of the resulting composite films can be further crosslinked by heat treatment in air to 130° C.

A metal oxide precursor(s) may be an inorganic compound. An inorganic compound may be a transition metal compound, such as, for example, a transition metal halide, transition metal alkoxide, organometallic compound, or a coordination compound, or the like, a metal compound, such an aluminum compound (e.g., aluminium alkoxides and the like), a sol-gel precursor, such as, for example, a transition metal sol-gel precursor, alumina sol-gel precursor, or the like, or the like, or a combinations thereof. An inorganic compound may be a transition metal alkoxide (e.g., a C₁, C₂, C₃, C₄, C₅, or C₆ transition metal alkoxide, or the like, or a combination thereof. Non-limiting examples of metal oxide precursors are provided herein.

A metalloid oxide precursor(s) may be a metalloid compound. A metalloid oxide precursor may a p-block metal compound. A metalloid compound may be a silicon compound, a silica sol-gel precursor, or the like, or a combination thereof. Aluminum compounds are also examples of p-block metal compounds. The metal oxide precursor(s), which may be sol-gel precursor(s), may be at least partially hydrolyzed or at least partially hydrolyze during the film formation (e.g., such that nanoparticles, which may have a size (e.g., a longest dimension, which may be a diameter) of 20 nm or less, 10 nm or less, 20 nm or less, or 10 nm or less) are formed) and/or may form sol-nanoparticles prior to mixing with multiblock copolymer and/or prior to film formation. Non-limiting examples of metalloid oxide precursors are provided herein.

The asymmetric porous films (e.g., asymmetric porous film comprising the multiblock copolymer and the one or more carbon precursor or the transition metal oxide precursor(s) or the metalloid precursor(s), or a combination thereof) may be subjected to one or more post-film formation processes (e.g., as described herein, such as, for example, in the Examples), which may comprise heating (e.g., under inert, oxidizing, or reducing conditions, and optionally in the presence of a reactive gas), to form an asymmetrical porous film, which may have a top surface layer (e.g., an isoporous surface layer) disposed on a graded porous substructure, which may have mesopores throughout the substructure, the film comprising carbon (e.g., N-doped carbon), one or more metalloid oxide(s) (e.g., silica, and the like, and combinations thereof), one or more metal(s), one or more metal oxide(s) (e.g., transition metal oxide, aluminum oxide, and the like, and combinations thereof), one or more metal nitride(s), a metal oxynitride, a metal carbide, metal carbonitride, or a combination thereof.

A film may be a continuous structure. In an example, a film is not disposed on a support. Supports may be porous polymer supports in order to improve the mechanical properties of the film. In various examples, a polymer support is a woven porous polymer support or a non-woven porous polymer supports. The supports may also be inorganic supports, such as, for example, aluminum oxides (e.g., anodized aluminum oxide and the like) and the like, which may have various and/or different pore sizes. A film may be deposited on various rigid substrates (e.g., by drying the hybrid film on a substrate followed by thermal processing). It may be desirable that a substrate be stable under an atmosphere comprising NH₃ at temperatures up to 600° C. (e.g., for asymmetric TiN and the like) or up to 865° C. (e.g., for superconducting asymmetric TiN and the like). Non-limiting examples of supports include silicon wafers, glass (e.g., non-conductive and/or transparent conducting oxides, and the like), and the like.

In an aspect, the present disclosure provides devices. In various examples, a device comprising one or more asymmetric porous film(s) of the present disclosure. Non-limiting examples of devices are provided herein.

A device may be an energy device. An energy device may be an energy conversion device, an energy storage device, or the like. In various examples, an energy device is chosen from batteries, capacitors, fuel cells, electrolyzers, and the like, and combinations thereof. In the case of a battery, one or more electrode(s) of the battery comprises the asymmetric porous film(s). In the case of a capacitor, one or more electrode(s) of the capacitor comprises the asymmetric porous film(s). A capacitor may be a capacitor that operates by intercalation, double-layer charge storage, pseudocapacitive charge storage, or the like, or a combination thereof. In the case of a fuel cell or an electrolyzer, one or more catalyst support(s) of the fuel cell or electrolyzer comprises the asymmetric porous film(s). Non-limiting examples of batteries include metal-ion batteries (e.g., lithium-ion batteries, lithium-sulfur batteries, and the like) and may include liquid electrolyte, solid-electrolyte based batteries, or the like, or a combination thereof. A catalyst support or battery electrode may be used at the anode and/or the cathode.

A device may be a filtration device. The film(s) may be (or function as) the separation medium/media of a device. A filtration device may be a solvent-resistant filtration device. A device may be an ultrafiltration device, a nanofiltration device, a microfiltration device, or the like.

The following Statements describe examples of the asymmetrically porous films of the present disclosure, methods of making asymmetrically porous films, and devices comprising one or more asymmetrically porous film(s):

Statement 1. A method for forming an asymmetrically porous film, which may have a top surface layer (e.g., an isoporous surface layer) disposed on a graded porous substructure (e.g., with the substructure having mesopores throughout), the film comprising carbon (e.g., N-doped carbon), one or more metalloid oxide(s) (e.g., silicas, and the like, and combinations thereof), one or more metal(s), one or more metal oxide(s) (e.g., transition metal oxides, p-block metal oxides (e.g., aluminum oxides and the like), and the like, and combinations thereof), one or more metal nitride(s), one or more metal oxynitride(s), one or more metal carbide(s), one or more metal carbonitride(s), or a combination thereof, comprising: forming a film comprising a multiblock copolymer comprising one or more hydrogen-bonding block(s) that can self-assemble (e.g., self-assemble in the mixture, which may be referred to as a casting solution or dope, used to form the self-assembly based film on a substrate) using a deposition solution comprising the multiblock copolymer and a solvent system (e.g., a solvent system comprising 1,4-dioxane (DOX) and, optionally, tetrahydrofuran (THF), such as, for example, DOX:THF at a ratio of 7:3 by weight, based on the total amount of DOX and THF) and one or more carbon precursor(s), or one or more metal oxide precursor(s), or one or more metalloid oxide precursor(s), or a combination thereof; removing at least a portion of the solvent system from the film (e.g., by evaporation); and contacting the film having at least a portion of the solvent system removed with a phase separation solvent system (e.g., aqueous solutions, such as, for example, water), such that an asymmetrically porous film (which may have a top surface layer (e.g., an isoporous surface layer) disposed on a graded porous substructure, which may have mesopores throughout) comprising the multiblock copolymer and the precursor(s) (e.g., a hybrid asymmetric film) is formed; optionally, heating (e.g., as described herein) the asymmetrically porous film (which may have a top surface layer (e.g., an isoporous surface layer) disposed on a graded porous substructure, which may have mesopores throughout) comprising the multiblock copolymer and the one or more precursor(s) to form the asymmetrically porous film (which may have a top surface layer (e.g., an isoporous surface layer) disposed on a graded porous substructure, which may have mesopores throughout) comprising one or more carbon (e.g., N-doped carbon), one or more metalloid oxide(s) (e.g., silica, and the like, and combinations thereof), one or more metal(s), one or more metal oxide(s) (e.g., transition metal oxide, p-block metal oxide (e.g., aluminum oxide and the like), and the like, and combinations thereof), one or more metal nitride(s), one or more metal oxynitride(s), one or more metal carbide(s), one or more metal carbonitride(s), or a combination thereof, optionally, treating (e.g., heating) (e.g., as described herein) the asymmetrically porous film (which may have a top surface layer (e.g., an isoporous surface layer) disposed on a graded porous substructure, which may have mesopores throughout) comprising metal oxide under reducing conditions to form the asymmetrically porous film (which may have a top surface layer (e.g., an isoporous surface layer) disposed on a graded porous substructure) comprising metal, or optionally, nitriding (e.g., as described herein) the asymmetrically porous film (which may have a top surface layer (e.g., an isoporous surface layer) disposed on a graded porous substructure, which may have mesopores throughout) comprising the multiblock copolymer and the one or more carbon precursor or the one or more metal oxide precursor(s), or a combination thereof (e.g., the hybrid isoporous graded film), or the asymmetrically porous film (which may have a top surface layer (e.g., an isoporous surface layer) disposed on a graded porous substructure, which may have mesopores throughout) comprising metal oxide, and, optionally, carbon, to form the asymmetrically porous film (which may have a top surface layer (e.g., an isoporous surface layer) disposed on a graded porous substructure) comprising metal nitride and/or N-doped carbon, or optionally, treating (e.g., heating) (e.g., as described herein) the asymmetrically porous film (which may have a top surface layer (e.g., an isoporous surface layer) disposed on a graded porous substructure, which may have mesopores throughout) comprising multiblock copolymer and the one or more carbon precursor in inert atmosphere to form the asymmetrically porous film (which may have a top surface layer (e.g., an isoporous surface layer) disposed on a graded porous substructure, which may have mesopores throughout) comprising carbon, or optionally, treating (e.g., heating) (e.g., as described herein), which may be referred to as activation or carbonactivation, the carbon asymmetrically porous film (which may have a top surface layer (e.g., an isoporous surface layer) disposed on a graded porous substructure) under oxidizing conditions, such as, for example, under carbon dioxide, which may be carried out at elevated temperatures as described herein (e.g., to increase the surface area of the film).
Statement 2. The method of Statement 1, where the one or more hydrogen-bonding block(s) are be chosen from poly(4-vinylpyridine), poly(2-vinylpyridine), poly(ethylene oxide), poly(methacrylic acid), poly(dimethyl amino ethyl methacrylate), poly(acrylic acid), poly(hydroxystyrene), and the like, and combinations thereof.
Statement 3. The method of Statement 1 or Statement 2, where the multiblock copolymer further comprises of one or more hydrophobic block(s). Non-limiting examples of such hydrophobic block(s) include poly(styrene)s, such as, for example, poly(styrene) and poly(alpha-methyl styrene), poly(isoprene), poly(butadiene), poly(ethylene), poly(propylene), poly(methyl-methacrylate), poly(vinyl chloride), and poly(tetrafluoroethylene), and the like, and combinations thereof. The hydrophobic blocks(s) may be low T_{g} blocks.
Statement 4. The method of any one of the preceding Statements, where the one or more carbon precursor(s) are chosen from resins, oligomeric resins, aromatic alcohols, unsaturated alcohols, phenol-based resols, phenol-formaldehyde resols, resorcinol-formaldehyde resols, furfuryl alcohol, and the like, and combinations thereof.
Statement 5. The method of any one of the preceding Statements, where the concentration of the multiblock copolymer and precursor(s) is 3 to 50 wt. % (e.g., 5 to 50 wt. % or 6 to 20 wt. %) (based on the total weight of the mixture used to form the film), including all 0.1 wt % values and ranges therebetween.
Statement 6. The method of any one of the preceding Statements, where the ratio of the multiblock copolymer to precursor(s) in the mixture used to form the film is 0.1:1 to 10:1 (based on wt %, which is based on the total weight of the mixture used to form the film), including all 0.01 values and ranges therebetween, or the ratio of the multiblock copolymer to precursor(s) in the mixture used to form the film is greater than or equal to 200:1 and/or less than or equal to 3000:1 (based on molecular weight of the multiblock copolymer and precursor(s), which may be a weight averaged molecular weight of the precursors), including all 0.1 values and ranges therebetween.
Statement 7. The method of any one of the preceding Statements, where the one or more metal oxide precursor(s) is/are chosen from inorganic compounds (e.g., transition metal compounds, such as, for example, transition metal halides, transition metal alkoxides, organometallic compounds, and coordination compounds, and the like, metal compounds, such as aluminum compounds (e.g., aluminium alkoxides and the like), sol-gel precursors, such as, for example, transition metal sol-gel precursors, alumina sol-gel precursors, and the like), and the like, and combinations thereof, and/or the metalloid oxide precursor(s) is/are chosen from metalloid compounds (e.g., silicon compounds, silica sol-gel precursors, and the like), and the like, and combinations thereof.
Statement 8. The method of any one of the preceding Statements, where the metal oxide precursor(s) is/are chosen from transition metal alkoxides (e.g., C₁-C₆ transition metal alkoxides), and the like, and combinations thereof.
Statement 9. The method of any one of the preceding Statements, where the deposition solution further comprises a homopolymer and/or a small molecule (which may be referred to as an additive/additives) and the film (e.g., the as-made asymmetric porous film or hybrid film) further comprises the homopolymer or the small molecule.
Statement 10. The method of any one of the preceding Statements, where the solvent system comprises or further comprises a solvent chosen from 1,4-dioxane, tetrahydrofuran, morpholine, formylpiperidine, toluene, chloroform, dimethylformamide, acetone, dimethylsulfoxide, dimethylacetamide, N-methylpyrrolidone, sulfolane, acetonitrile, 2-methyltetrahydrofuran, and the like, and combinations thereof.
Statement 11. The method of any one of the preceding Statements, where the heating, which comprises drying the asymmetric porous film and/or in the case where the asymmetric porous film was formed using one or more carbon precursor(s), carbonization of the film (which may be carried out in an inert atmosphere), for example, is carried out at 350 to 1600° C. (e.g., 400 to 1150° C. or 850° C. to 1150° C.), including all integer ° C. values and ranges therebetween. In the case where the asymmetric porous film was formed using one or more carbon precursor(s), formation of an N-doped carbon film. In the case where the asymmetric porous film was formed using metal oxide precursor(s) (e.g., sol-gel precursor(s)), formation of the metal oxide, for example, is carried out at 280 to 900° C. (e.g., 300 to 500° C.), including all integer ° C. values and ranges therebetween; in the case where the asymmetric porous film was formed using either multiblock copolymer and precursor or metal oxide asymmetric porous film, formation of the metal nitride, for example, is carried out at 550 to 900° C. (e.g., 550 to 650 or 800 to 900° C.), including all integer ° C. values and ranges therebetween. In the case where the asymmetric porous film was formed using metal oxide precursor(s) (e.g., sol-gel precursor(s)), formation of the metal (which may be carried out in a reducing atmosphere, e.g., ammonia, nitrogen, or the like), for example, is carried out at 350 to 1600° C., including all integer ° C. values and ranges therebetween.
Statement 12. The method of any one of the preceding Statements, where the nitriding comprises heating the asymmetric porous film of the multiblock copolymer and the one or more metal oxide precursor(s) or transition metal oxide precursor(s) (e.g., transition metal oxide precursor(s), sol-gel precursor(s), and the like) (e.g., a hybrid isoporous graded film), (e.g., first under air) to generate an asymmetric porous film comprising metal oxide or transition metal oxide, and subsequently in an atmosphere that is a nitrogen source (e.g., ammonia gas, and the like) (e.g., to convert the oxide into the respective nitride, whereby the latter step converting the oxide into the nitride itself can comprise multiple separate heating steps under different atmosphere and different temperatures (e.g., first under ammonia at 700° C., and subsequently under gases including ammonia (NH₃), argon (Ar), forming gas (H₂ in N₂) or carburizing gas (mixture, e.g., of 16% CH₄, 4% H₂, and 80% N₂) at temperature ranging from 800° C. to 1000° C.
Statement 13. An asymmetrically porous film, which may have a top surface layer (e.g., an isoporous surface layer) disposed on a graded porous substructure, which may have mesopores throughout, comprising: a porous three-dimensional carbon, metal, metal oxide, metal nitride, metal oxynitride, metal carbide, metal carbonitride, or a combination thereof structure, where at least a portion or all of the carbon, or metal, or metal oxide, or metal nitride, metal oxynitride, metal carbide, metal carbonitride, or a combination thereof is mesoporous (e.g., mesoporous according the IUPAC definition of mesoporous), where the film has a surface layer (e.g., having a thickness, for example, of 20 nm to 500 nm, including all 0.1 nm values and ranges therebetween, and/or a plurality of pores, for example, each pore, independently, having a size (e.g., of one or more dimension(s)) of 5 nm to 100 nm, including all 0.1 nm values and ranges therebetween), and the film has a bulk layer (which may be a substructure layer) (e.g., having a thickness, for example, of 5 microns to 500 microns, including all 0.1 nm values and ranges therebetween, and/or a plurality of pores, for example, each pore, independently, having a size (e.g., of one or more dimension(s)) of 10 nm to 100 microns, including all 0.1 nm values and ranges therebetween, 10 nm to 100 microns, and/or an asymmetric substructure). The asymmetric porous film may be a continuous structure and/or free-standing structure.
Statement 14. The asymmetric porous graded film of Statement 13, where the size of the pores in the surface layer have a pore size distribution of less than 3, where the pore size distribution is the ratio of the maximum pore diameter (dₘₐₓ) to the minimum pore diameter (dₘᵢₙ).
Statement 15. The asymmetric porous film of Statement 13 or Statement 14, where the film has a thickness of 5 microns to 500 microns, including all 0.1 micron values and ranges therebetween.
Statement 16. An asymmetric porous film, where the asymmetric film is a hybrid film and, optionally, the film further comprises a homopolymer and/or a small molecule.
Statement 17. The asymmetric porous film of Statement 16, where the molar ratio of multiblock copolymer to homopolymer is 1:0.05 to 1:10 (e.g., 1:0.05 to 1:1) and/or the molar ratio of multiblock copolymer to small molecule is 1:1 to 1:1000.
Statement 18. A device comprising one or more asymmetric porous film(s) of any one of Statements 13-15 and/or an asymmetric porous film(s) made by a method of any one of Statements 1-12.
Statement 19. The device of Statement 18, where the device is an energy device (e.g., an energy storage device or an energy conversion device).
Statement 20. The device of Statement 19, where the energy device is chosen from batteries (e.g., one or more electrode(s) comprise the film(s)), capacitors (e.g., one or more electrode(s) comprise the film(s)), fuel cells (e.g., one or more catalyst support(s) comprise the film(s)), and the like, and combinations thereof.
Statement 21. The device of Statement 18, where the device is a filtration device (e.g., the film(s) are the separation medium/media. The filtration device may be a solvent-resistant filtration device or an ultrafiltration device, nanofiltration device, or a microfiltration device.

The steps of the method described in the various examples disclosed herein are sufficient to carry out the methods of the present disclosure. Thus, in an example, the method consists essentially of a combination of the steps of the methods disclosed herein. In another example, the method consists of such steps.

The following examples are presented to illustrate the present disclosure. The examples are not intended to be limiting in any matter.

### Example 1

This example provides a description of asymmetrical porous films of the present disclosure. Also provided are methods of making and uses of the asymmetrical porous films.

Porous materials design often faces a tradeoff between the requirements of high internal surface area and high reagent flux. Inorganic materials with asymmetric/hierarchical pore structures or well-defined mesopores have been tested to overcome this tradeoff, but success has remained limited when the strategies are employed individually. Here, the attributes of both strategies are combined and a scalable path to porous titanium nitride (TiN) and carbon materials that are conducting (TiN, carbon) or superconducting (TiN) is demonstrated. These materials exhibit a combination of asymmetric, hierarchical pore structures and well-defined mesoporosity throughout the material. Fast transport through such TiN materials as an electrochemical double-layer capacitor provides a substantial improvement in capacity retention at high scan rates, resulting in state-of-the-art power density (28.2 kW kg⁻¹) at competitive energy density (7.3 W h kg⁻¹). In the case of carbon membranes, a record-setting power density (287.9 kW kg⁻¹) at 14.5 W h kg⁻¹ is obtained. Results distinct advantages of such pore architectures for energy storage and conversion applications and provide an advanced avenue for addressing the tradeoff between high-surface-area and high-flux requirements.

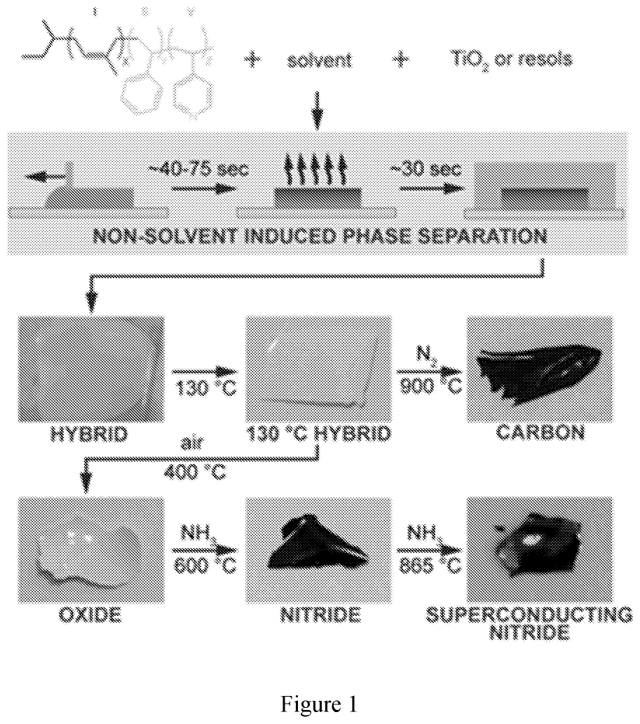

Direct formation of asymmetric porous nitride and carbon structures was used (FIG. 1b) and it was demonstrated that they can enhance mass transport of ions in EDLCs and allow for high rate capability without compromising on available surface area, outperforming previous materials with pore architectures including purely asymmetric, mesoporous, or hierarchical structures. These improvements are attributed to the combination of structural asymmetry, which allows rapid ion transport, with well-defined mesoporosity throughout, consequently aiding pore accessibility. Efforts started with titanium nitride (TiN), a promising alternative material for aqueous EDLCs, owing to its high conductivity, corrosion resistance and wide voltage window. In order to gain fundamental insights into the effects of the asymmetric structure on transport, asymmetric TiN with well-defined mesopores was compared to a periodically ordered, mesoporous TiN monolith derived from BCP SA and mimicking conventional mesoporous materials used in EDLC applications. Asymmetric graphitic carbon was also synthesized and its capacitive performance was measured to demonstrate that the combination of structural asymmetry and well-defined mesopores can be extended to enhance micropore accessibility.

FIG. 1 shows the overall synthesis flow. Briefly, an amphiphilic triblock terpolymer poly(isoprene)-block-poly(styrene)-block-poly(4-vinylpyridine) (ISV) was used to structure-direct either sol-gel derived inorganic titanium dioxide (TiO₂) nanoparticles (NPs) or organic phenol formaldehyde resols (resols). The inorganic/organic additive preferentially swells the hydrophilic V block of ISV. ISV was synthesized via sequential anionic polymerization. For the nitrides, an ISV of molar mass 113 kg mol⁻¹ (also referred to as kg/mol) with volume fractions of 29% poly(isoprene) (PI), 59% poly(styrene) (PS), 12% poly(4-vinylpyridine) (P4VP) and dispersity (Ð) of 1.3 was used, while for the graphitic carbons, a different ISV of molar mass 95 kg mol⁻¹ and volume fractions of 29% PI, 57% PS, 14% P4VP, and Ð=1.2 was used. The TiO₂ NPs were prepared from a modified hydrolytic sol-gel synthesis, while resols were synthesized via condensation of phenol and formaldehyde under basic conditions.

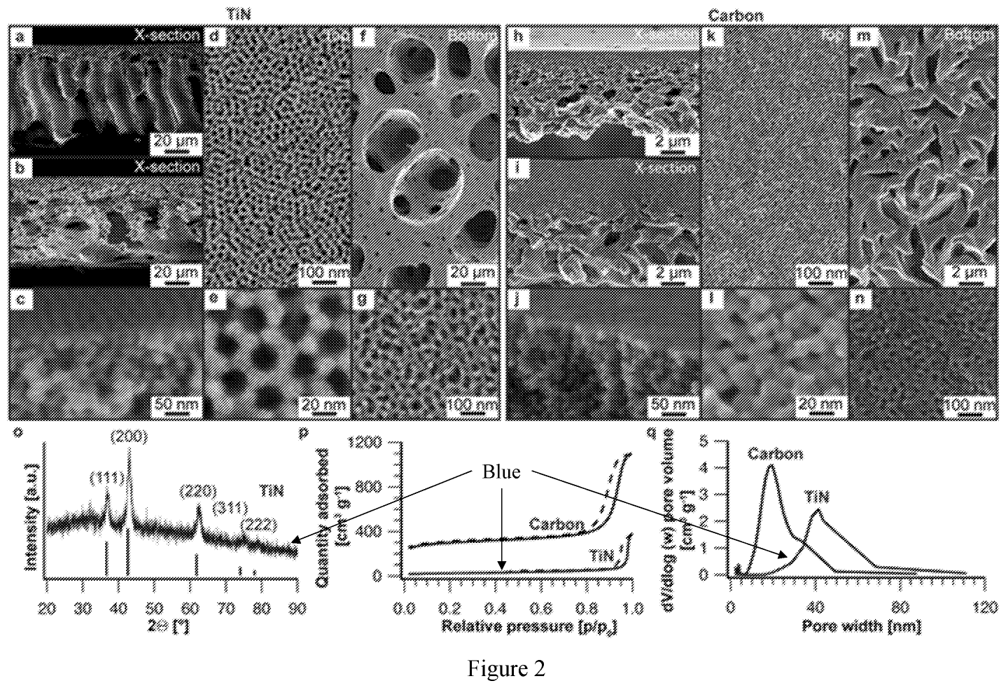

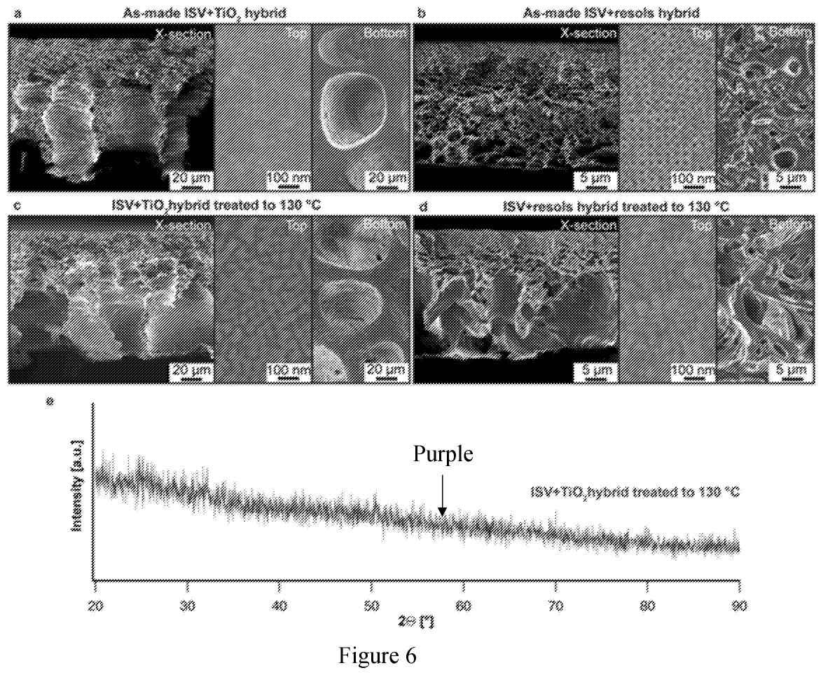

Solutions consisting of homogeneous mixtures of ISV and either TiO₂NPs or resols dissolved in 1,4-dioxane (DOX) and tetrahydrofuran (TIF) (mass ratio of 7:3 DOX:THF) were cast onto glass slides using a doctor blade with a predetermined gate height on the order of a few hundred microns. Films were allowed to evaporate for a set amount of time via the film surface, which introduced an ISV+additive concentration gradient along the film normal. Evaporation was halted by plunging the films into deionized (DI) water (a nonsolvent for the polymer) to precipitate ISV, thus freezing in the asymmetric structure and resulting in an as-made ISV+TiO₂ hybrid or ISV+resols hybrid (FIGS. 6a and b, respectively). Subsequent drying and heat treatments, first at 130° C. (FIGS. 6c and d, as well as FIG. 6e, which is a representative XRD of the ISV+TiO₂ hybrid treated to 130° C.) and then higher temperatures as shown in FIG. 2, converted the as-made composite materials into the final asymmetric inorganic porous structures.

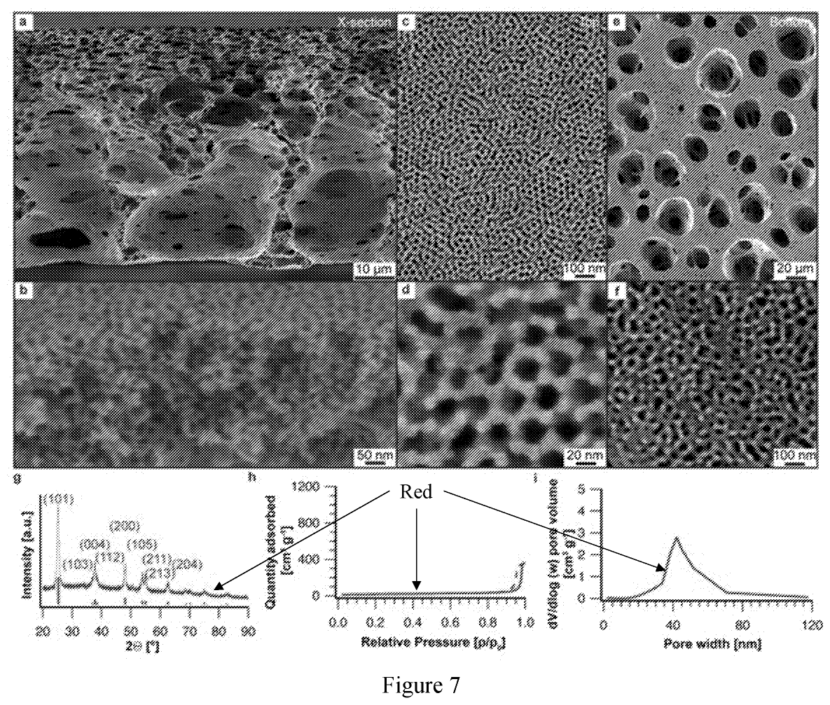

Following heat treatment at 130° C., ISV+TiO₂ hybrids were heated to 400° C. in air for 3 h to remove organic material to produce porous freestanding asymmetric TiO₂ without loss of the asymmetric structure. Scanning electron microscopy (SEM), X-ray diffraction (XRD), and nitrogen sorption data for a representative material are provided in FIG. 7. XRD peaks (FIG. 7g) were consistent with anatase phase TiO₂ (ICSD #01-070-7348, space group #141 I4₁/amd) with lattice parameters of a=b=3.79 Å and c=9.52 Å, and a coherent scattering domain size of 12.1 nm. These lattice parameters are comparable to those reported for bulk anatase TiO₂ (a=b=3.785 Å, c=9.514 Å), while the domain size is on the order of the top surface strut thickness. Results of the nitrogen sorption and XRD characterization for all materials in this study are summarized in Table 1 and 2, respectively. The oxide was converted into free-standing TiN by heat treatment to 600° C. in flowing ammonia for 6 h before allowing the sample to cool to room temperature. For asymmetric carbon, heat treatment at 130° C. of casted ISV+resols membranes induced cross-linking of the oligomeric resols. ISV+resols hybrids were subsequently heated to 900° C. in flowing nitrogen, decomposing the polymer and producing free-standing asymmetric carbon membranes.

Characterization of the final TiN and carbon structures via SEM, XRD, and nitrogen sorption is shown in FIG. 2. By varying dope solution parameters, e.g., film thickness and/or evaporation time, the cross-sections and thereby surface area accessibility of the materials could be tuned. For TiN, gate heights of 305 to 381 μm and evaporation times of 60 s resulted in asymmetric cross-sections with finger-like profiles (FIG. 2a). Increased evaporation time of 75 s resulted in denser cross-sections with larger diameter macropores (FIG. 2b), as increased solvent evaporation leaves behind a higher concentration film for precipitation. The final asymmetric TiN was considerably thinner (˜60 μm) than the original hybrid (˜100 μm, FIG. 6), due to the mass loss during the decomposition of the organics. Asymmetric carbon products had thinner cross-sections (˜8 μm) due to smaller casting gate heights of 203 to 229 μm. By varying the solution preparation (simultaneous vs. consecutive), cross-sections could be varied from a more asymmetric structure with a continuous gradient along the film normal (FIG. 2h) to one with a denser top layer atop a macroporous substructure (FIG. 2i).

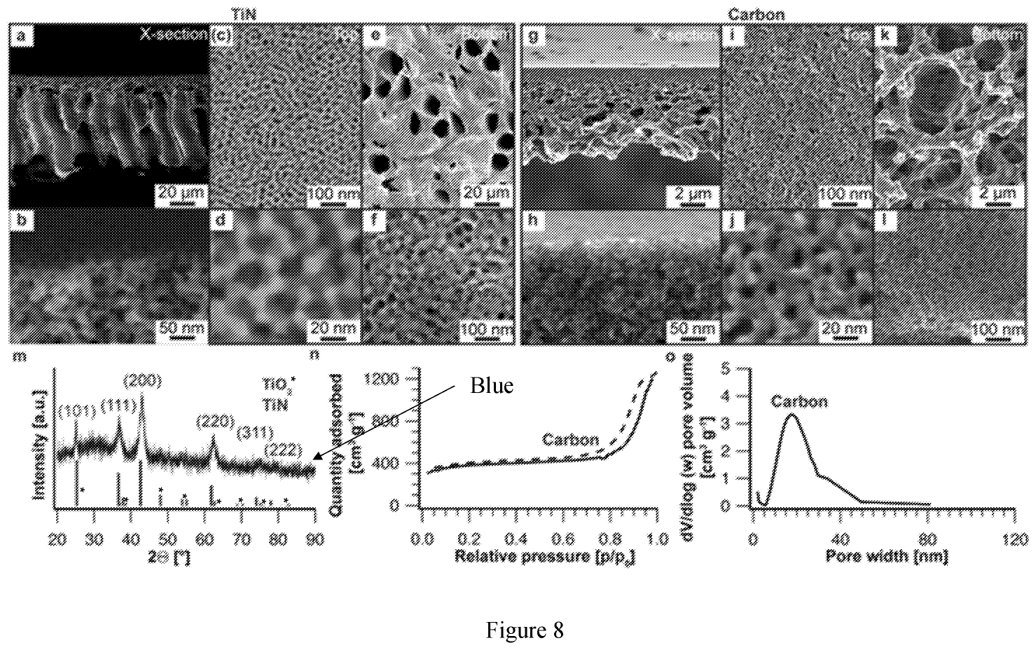

Characterization details of the TiN sample in FIG. 2b are provided in FIGS. 2c-g and 2o-q, while those of the sample depicted in FIG. 2a are provided in FIGS. 8a-f and 8m. Similarly, details of the carbon sample whose cross-section is shown in FIG. 2i is provided in FIGS. 2j-n and 2p,q, while those of the sample shown in FIG. 2h are provided in FIGS. 8g-l and 8n,o. The top ˜150 nm of the cross-sections for both TiN and carbon asymmetric structures (FIGS. 2c and 2j) showed evidence of well-defined nanoscopic mesopores and nanoscale periodic ordering. For TiN, surface pores were arranged in a hexagonal structure (FIGS. 2d and e), consistent with the ISV+TiO₂ hybrid (FIG. 6). For asymmetric carbon, the top surface showed a square pore arrangement (FIG. 2k, l), reflecting the cubically packed pores of the hybrid material (FIG. 6). For both TiN (FIG. 2f) and carbon (FIG. 2m), bottom surfaces exhibited micron-sized macropores. Furthermore, for both materials the walls of the macropores were mesoporous (FIG. 2g, 2n), which contributed to the specific surface area (vide infra). In summary, imaging results on these materials reveal an asymmetric pore structure, with well-defined mesopores at the top and macropores at the bottom, constituting a pore hierarchy. In addition to this asymmetry, throughout the material the macropore walls show well-defined mesopores, likely the result of the BCP SA process, which sequesters the inorganic precursors into nanoscopic domains everywhere along the film normal.

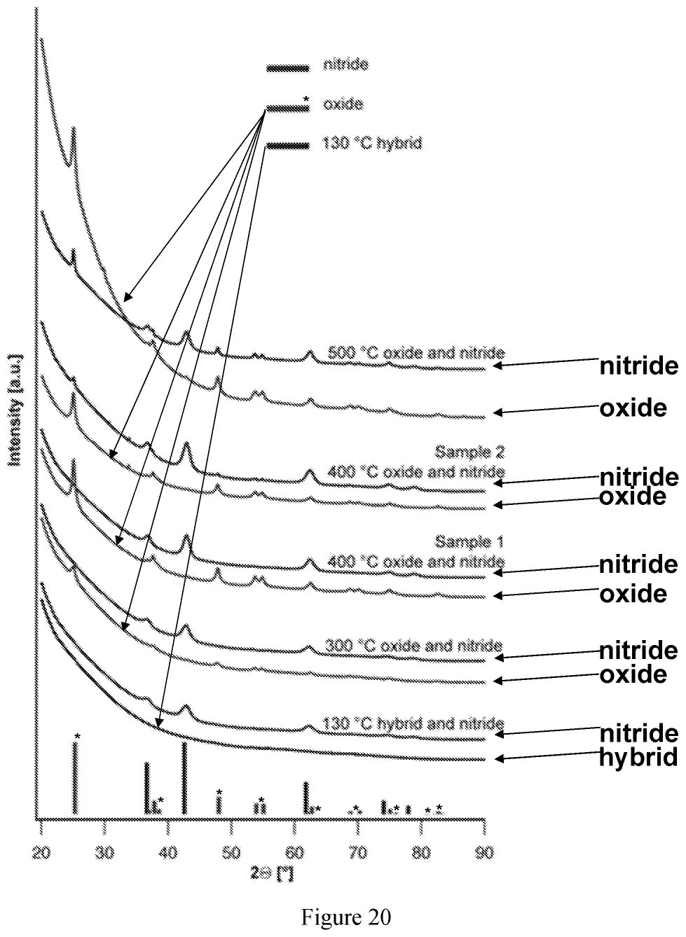

XRD characterization of the TiN (FIG. 20) was consistent with cubic rocksalt TiN (ICSD #00-038-1420), which crystallized in space group Fm3̅m (#225) with a lattice parameter of 4.20 Å and a coherent scattering domain size of 6.9 nm. The lattice parameter is below the reported literature values, which lie between 4.235 Å and 4.242 Å, but comparable to previously reported BCP-derived mesoporous TiN. This difference is associated with residual oxygen content and vacancies as described in previous studies.

The porosity of asymmetric TiN and carbon samples was characterized via nitrogen sorption isotherms analyzed using the Brunauer-Emmett-Teller (BET) method (FIG. 2p). In both cases, type-IV curves with H₁-type hysteresis and sharp capillary condensation above relative pressures of 0.99 were observed. For TiN, a BET surface area of 90±3.0 m² g⁻¹, a micropore area of 15 m² g⁻¹, volumetric surface area of 14.2 m² cm⁻³ and a specific pore volume of 0.59 cm³ g⁻¹ at p/p₀=0.99 were obtained. This surface area is similar to previously reported surface areas for mesoporous TiN, consistent with the mesoporous walls of the asymmetric material (vide supra). Barrett-Joyner-Halenda (BJH) analysis (FIG. 2q) revealed a well-defined pore size distribution that peaked at 41 nm with a full-width at half-max (FWHM) of 17±7 nm, similar to the oxide precursor (FIG. 7i). In comparison, asymmetric carbon had a much higher surface area due to increased microporosity and lower density. A BET surface area of 1024±142 m² g⁻¹, micropore area of 655 m² g⁻¹, volumetric surface area of 36.0 m² cm⁻³, and specific pore volume of 1.69 cm³ g⁻¹ at p/p₀=0.99 were obtained. BJH analysis (FIG. 2q) showed a well-defined pore size distribution that peaked at 20 nm with a FWHM of 12±5 nm.

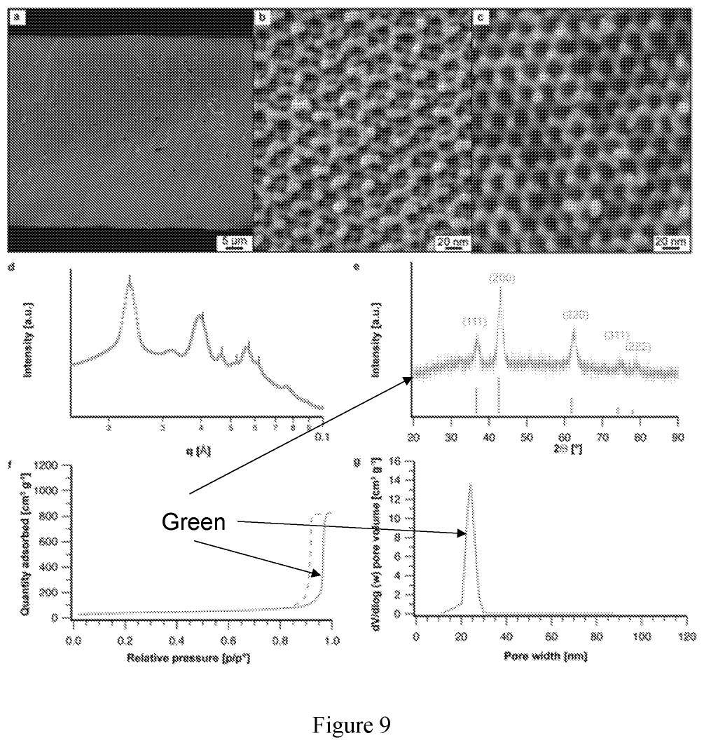

To evaluate ionic diffusion inside the asymmetric morphology, the electrochemical performance of asymmetric TiN was compared to homogeneous mesoporous TiN with the most accessible mesopores, i.e., the three-dimensional alternating gyroid structure with interconnected pores. Gyroidal mesoporous TiN was synthesized using evaporation induced BCP-directed self-assembly (EISA) to closely match features of the asymmetric TiN in terms of thickness, pore size distribution, and specific surface area (see below). The ordered mesostructure was confirmed using small angle x-ray scattering (SAXS) and SEM (FIG. 9). The SAXS pattern could be indexed to an alternating gyroid (I4₁32, space group #214) structure with unit cell size of 38 nm. The porosity was characterized using nitrogen sorption (FIG. 9). Type-IV curves with H₁-type hysteresis and sharp capillary condensation above relative pressures of 0.99 were observed. A BET surface area of 139 m² g⁻¹ with a weighing error of 2.1 m² g⁻¹, micropore area of 34 m² g⁻¹, volumetric surface area of 108 m² cm⁻³, and specific pore volume of 1.29 cm³ g⁻¹ at p/p₀=0.99 were observed with a peak in the pore size distribution around 24 nm with a FWHM of 4.2 nm, consistent with SEM results (FIG. 9b-c). From pore size distribution analysis, pores of the gyroidal mesoporous TiN were on average slightly smaller than those of the asymmetric TiN. Further, the BET surface area of the mesoporous TiN was higher (139 vs. 90 m² g⁻¹). XRD suggested mesoporous TiN crystallized with a rocksalt structure (ICSD #00-038-1420) and a lattice parameter of 4.20 Å with a coherent scattering domain size of 5.5 nm, similar to the asymmetric TiN.

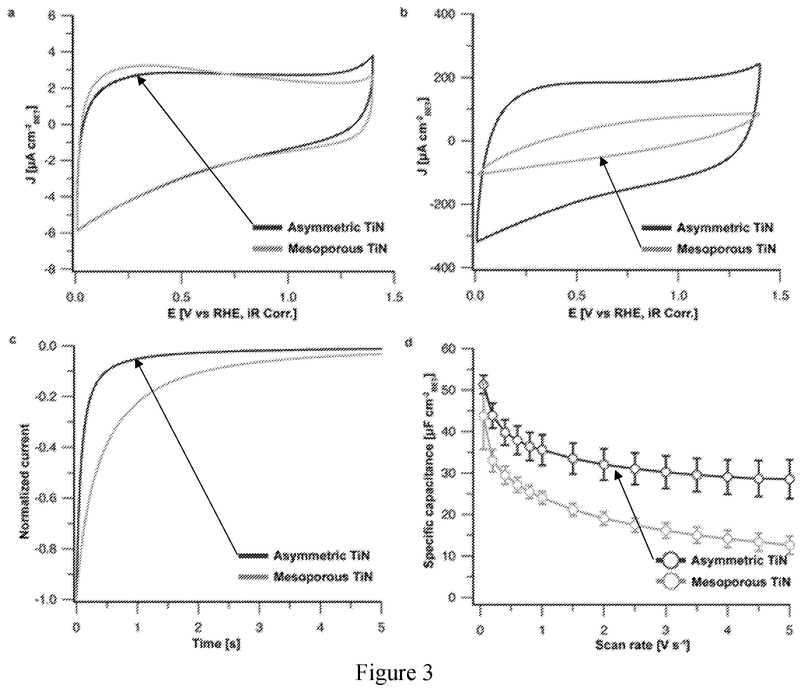

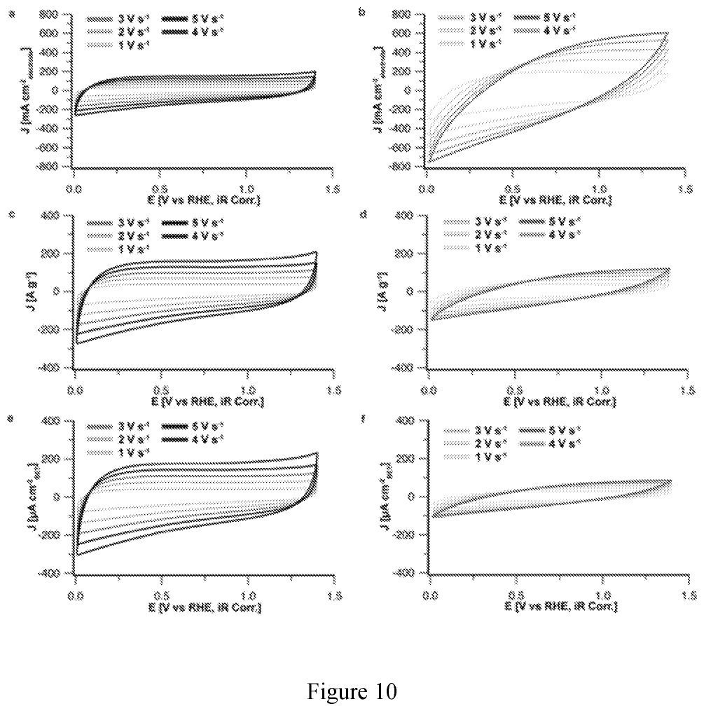

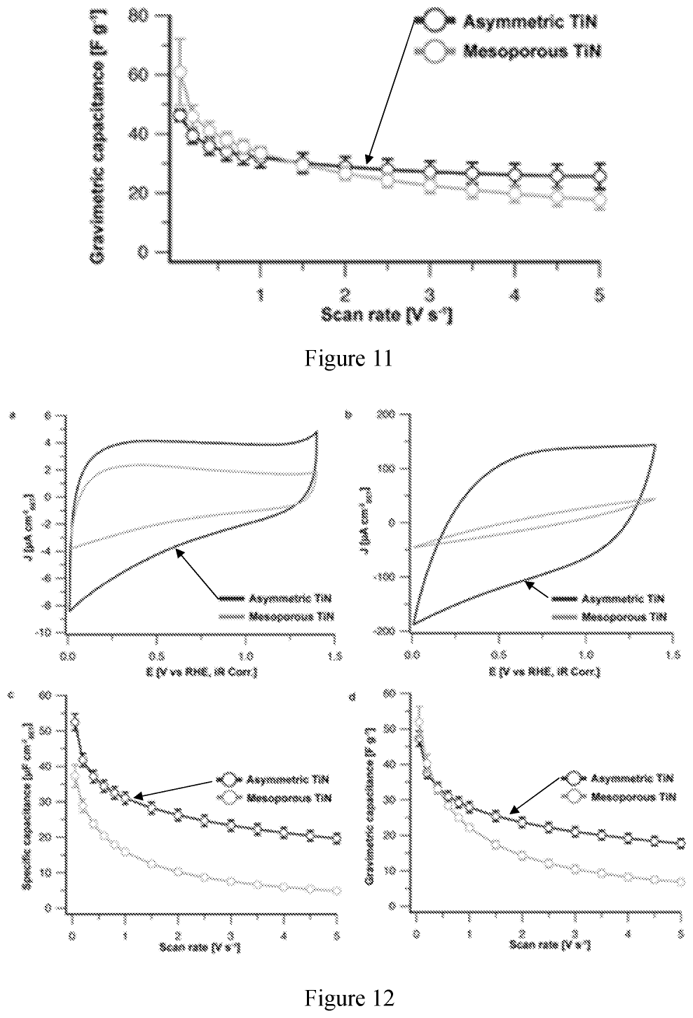

Cyclic voltammetry (CV) was conducted in aqueous 0.1 mol L⁻¹ HClO₄ to compare ion diffusion in the asymmetric TiN monolith with gyroidal mesoporous TiN. Measured currents were normalized to the respective BET surface areas to obtain the capacitive response of the asymmetric and mesoporous TiN per their internal surface areas. At slow scan rates (50 mV s⁻¹), CVs of both morphologies showed similar capacitive current and specific integral capacitance, indicating that the internal pores were accessible at slow scan rates. In this limit, the internal ion diffusion is sufficiently fast with respect to the charge/discharge rate (FIG. 3a). At high scan rates (5 V s⁻¹) corresponding to charge/discharge in <0.3 s, however, the capacitive performance of the two morphologies diverged substantially (FIG. 3b). While the CV for asymmetric TiN showed a similar shape to the one at slower scan rate, mesoporous TiN showed substantial integral capacitance loss (˜60 (e.g., 56) % vs. ˜30% initial value retention, see FIG. 3d, 4b). It is noted that because mesoporous TiN had a higher BET area than the asymmetric TiN, the gravimetric (mass-normalized) integral capacitance was higher at slow scan rate; however, the trend was reversed at higher scan rate because the asymmetric TiN has a better rate capability (2× at 5 V s⁻¹, see FIGS. 10, 11). It is emphasized that in order to allow a fair comparison of surface area accessibility in asymmetric and mesoporous TiN, the solution resistance was corrected using the high frequency intercept from impedance measurements and compensated (since the absolute surface areas of the two morphologies were not the same). The trend of improved integral capacitance retention in the asymmetric structure persisted even if we did not apply this correction (FIG. 12).

To understand the origin of the capacitance retention in asymmetric TiN, chronoamperometry (CA) was used (FIG. 3c). In this experiment, the voltage was held at the open-circuit voltage (˜0.65-0.75 V vs reversible hydrogen electrode (RHE)) for five minutes, then the potential was immediately dropped to 0.01 V vs RHE while the decay current was measured. After normalizing the maximum current to unity, effective time constants of 92.8 ms (asymmetric TiN) and 372 ms (mesoporous TiN) were calculated, indicating that double-layer charging is approximately four times faster in the asymmetric structure, which we attribute to more facile ion diffusion in asymmetric TiN. This result is consistent with the improved capacitance retention for asymmetric TiN at higher scan rate. It is noted that the open-circuit voltage varied by <0.1 V between the asymmetric and mesoporous morphologies, consistent with the idea that the two structures had similar surface chemistries.

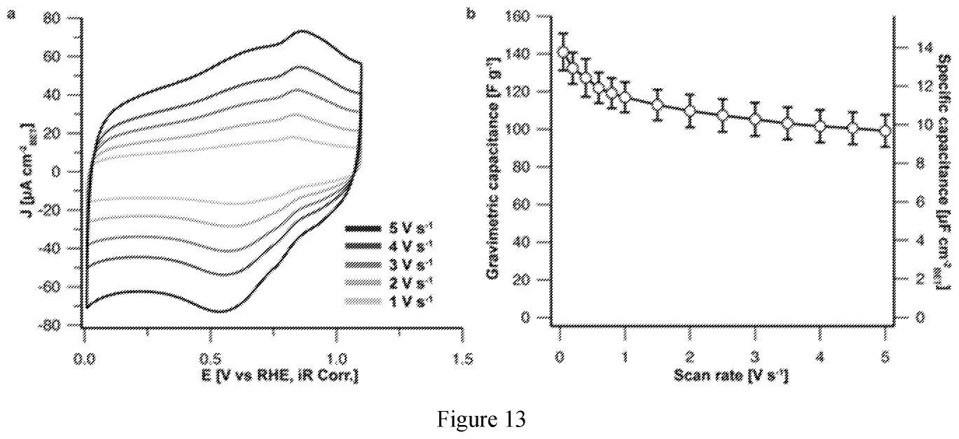

To demonstrate that the strategy of using SNIPS-derived asymmetric structures can also enhance mass transport through membranes with substantial microporosity, in addition to mesoporosity, the rate-dependent integral capacitance of the asymmetric graphitic carbon was also measured. Due to the microporosity in asymmetric carbon, the specific surface area is an order-of-magnitude higher than asymmetric TiN, potentially allowing higher power and energy densities. However, the ability to access a high fraction of the fine <2 nm micropores at fast rates is critical. To remove organic impurities and increase the capacitance, the asymmetric carbon was first activated by cycling to 1.4 V vs RHE at 5 V s⁻¹ which introduced redox functional groups, e.g., oxygen on the carbon surface. Like asymmetric TiN, the CV retained most of the low scan rate features even at relatively fast 5 V s⁻¹ scan rate (FIG. 13a). The CVs shown in FIG. 13a were measured using the same protocol as for TiN after the activation step had reached a steady-state CV shape and capacitive current. The specific integral capacitance of asymmetric carbon was found to be 13.8 μF cm⁻²BET at 50 mV s⁻¹, normalized using the BET-derived surface area, with 70% capacity retention at 5 V s⁻¹, suggesting that in addition to the mesopores, a high fraction of the micropores remain accessible at fast rates.

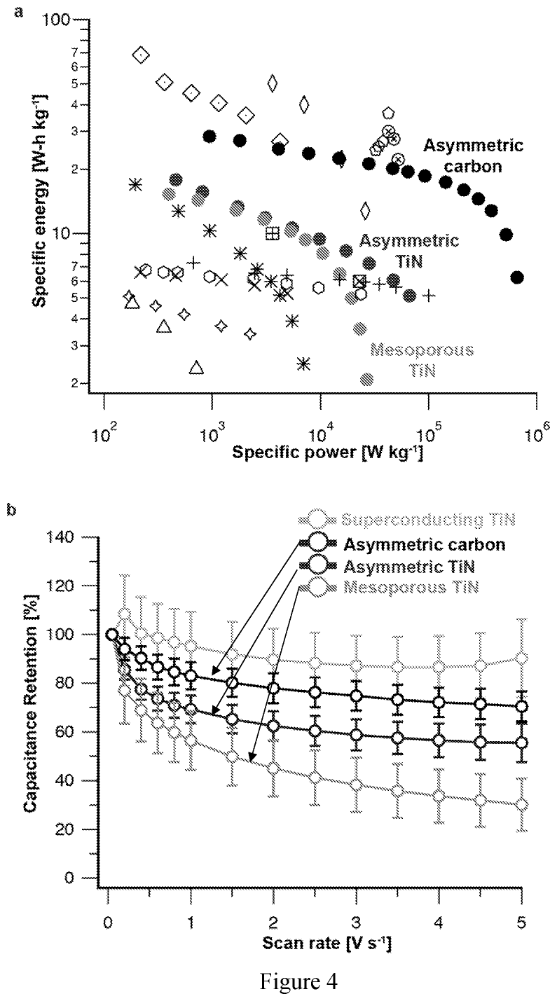

The high capacitance retention performance of the asymmetric structure is attributed to the improved pore accessibility at high rates (FIG. 4b). To illustrate the benefit of the asymmetric architecture, the energy density and power density of asymmetric and gyroidal mesoporous TiN and asymmetric graphitic carbon were calculated and compared to state-of-the-art literature values (FIG. 4a, Table 3). Gravimetric energy and power densities of a single electrode using a three-electrode half-cell configuration are reported. In order to provide a fair comparison the calculation details are compared below to those described in the prior literature (Table 3) and leading to each of the reference points shown in FIG. 4a. Since most literature reports do not include resistance compensation, energy and power density values are reported herein without resistance compensation. Full calculation details are included below. Electrode thicknesses are reported in Table 4. Due to the facile ion diffusion through the asymmetric structure, which leads to capacitance retention at high scan rates, the peak average power density for both asymmetric structures of TiN (28.2 kW kg⁻¹) and graphitic carbon (287.9 kW kg⁻¹) are significantly higher than the state-of-the-art. The energy density at the peak power density for TiN is 7.3 W-h kg⁻¹ and for graphitic carbon is 14.5 W-h kg⁻¹. The higher energy density in carbon is attributed to the higher micropore surface area compared to TiN. At the measured power density, as well as all power densities >100 kW kg⁻¹, these energy density values are amongst the highest energy values reported to date, including reports utilizing purely asymmetric/hierarchical, or mesoporous structures, suggesting that the combination of structural asymmetry with well-defined mesopores and micropores throughout the material is an important structural aspect resulting in improved performance. These values represent a non-optimized result. It is expected that further improvements can be made by adding additional functional groups such as amines or by activating the carbon with CO₂ to further increase microporosity and surface area, or by incorporating more conductive materials (vide infra). Furthermore, the SNIPS process could be further optimized to improve capacitance retention, power density, and energy density.

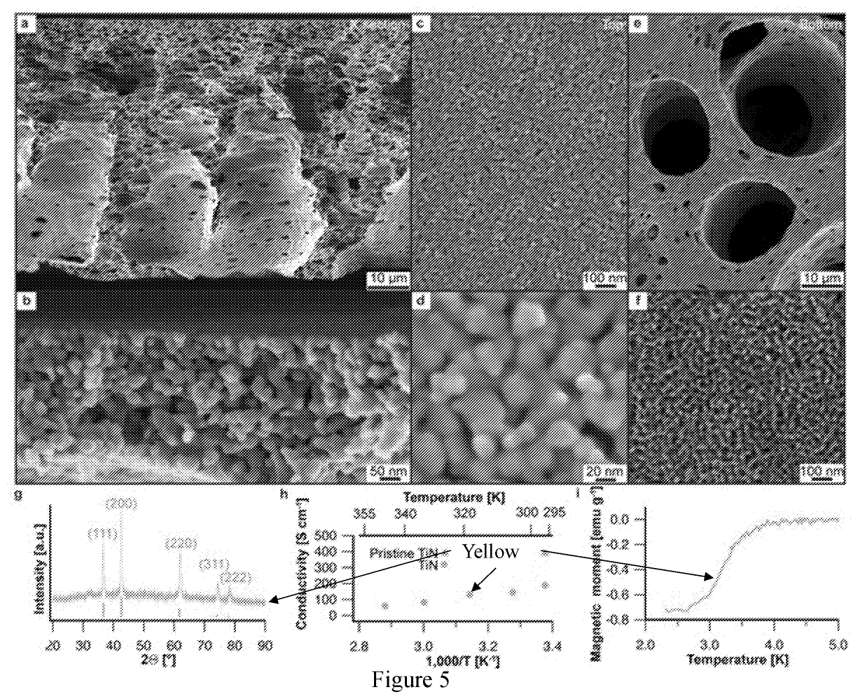

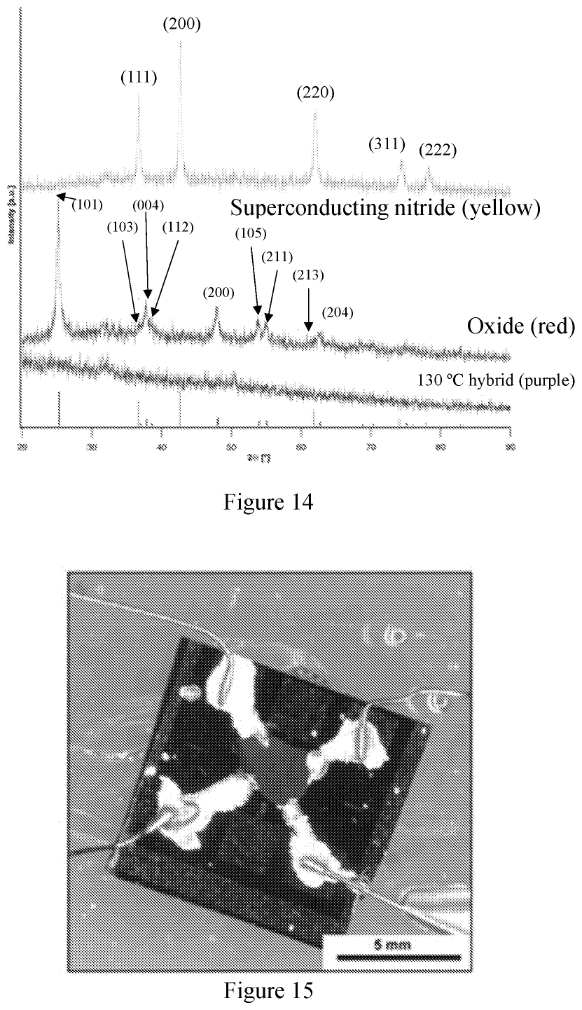

Given the record-setting power performance of the studied asymmetric structures, it was evaluated whether the observed result represents the fundamental limit of transport inside the porous structures. One of the possible limitations of the porous structures is the reduced electrical conductivity in TiN. To test the influence of electrical conductivity, the rate capability of the asymmetric TiN with less residual oxygen was examined, which has improved electrical conductivity. To this end, a second heat treatment step under flowing NH₃ was used to remove residual lattice oxygen and vacancies. After initial annealing at 600° C. for 6 h, asymmetric TiN monoliths were subsequently annealed under flowing NH₃ at 865° C. for 3 h. After annealing, the structure retained its asymmetric morphology (FIG. 5a-b), with open and accessible macroporous bottom and mesoporous walls (FIG. 5e, f). The ordered top surface densified, however, likely a result of crystallite overgrowth (FIG. 5c, d). Importantly, while the XRD peaks and relative intensities (FIG. 5g) remained consistent with cubic rocksalt TiN (ICSD #00-038-1420), the lattice parameter from XRD increased from 4.20 Å to 4.24 Å, similar to bulk TiN and suggesting removal of additional residual oxygen/vacancies. Furthermore, the grain sizes increased from 6.9 nm to 19 nm, consistent with the size of domains observed on the top surface in SEM (e.g., FIG. 5d). The progression of the transformation through various processing steps is shown in FIG. 14.

The annealed membrane had a conductivity of 188 S cm⁻¹ with a temperature dependent behavior consistent with metallic conductivity (FIG. 5h) measured using a four-point probe geometry (FIG. 15), comparable to that of glassy carbon and BCP-derived porous TiN thin films. While this electrical conductivity is sufficient for electrochemical testing, the value is lower than that for bulk TiN (>10⁴ S cm⁻¹) likely due to the remaining residual oxygen and vacancies resulting from the low ammonolysis temperature needed to maintain the porous structure as well as a thin surface oxide layer that forms upon longer exposure of the material to air (see FIG. 5h). In addition, the nanoscale grain sizes can also increase electron scattering, lowering conductivity.

One signature of significantly reduced oxygen defects in TiN is the presence and temperature of a superconducting transition. A superconducting membrane could be applied for, e.g., magnetic gas separations. To probe the superconducting transition in these materials, the temperature-dependent magnetization of the high temperature annealed asymmetric TiN was measured under an applied field of 796 Å m⁻¹ during warming after zero-field cooling to 2.5 K (FIG. 5i). A superconducting transition was observed between 2.5 K and about 4 K, with a flux expulsion from the material indicated by negative values of the magnetic moment. The observed T_{c} (3.8 K) is slightly below the value reported in the literature for TiN (5.6 K), possibly due to residual oxygen and vacancies in the lattice.

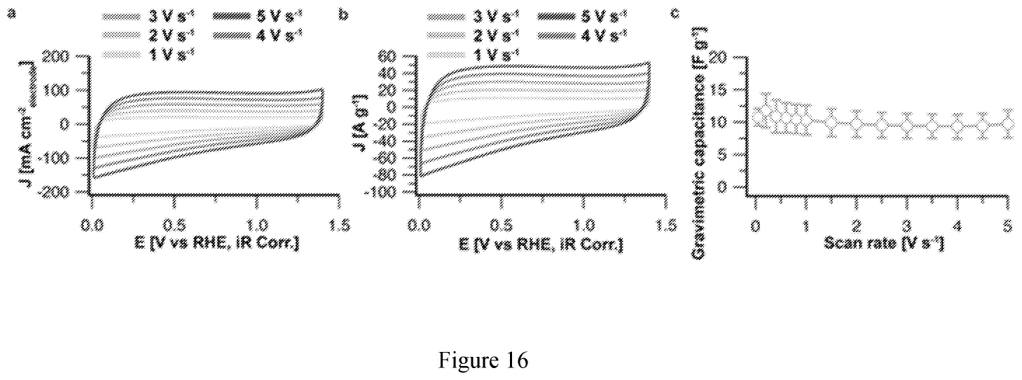

To study the effect of residual oxygen content on the electrochemical properties of asymmetric TiN, the capacitance retention of the reannealed TiN was investigated using CV. Like the previous TiN monolith, a double-layer capacitance response dominated the CV result when scanned between 50 mV s⁻¹ and 5 V s⁻¹. The measured capacitive current was lower than the previous TiN monolith (FIG. 16a, 16b). This observation is attributed to the loss of the residual oxygen, which could be redox-active and thus can contribute an additional capacitive response. More importantly, the capacitance retention (FIG. 4b) at 5 V s⁻¹ was 90% with respect to the slow scan rate integral capacitance, substantially higher than the 56% retention measured for the asymmetric TiN treated at only 600° C. (FIG. 16c). At slow scan rates, the possibility that kinetically slow pseudocapacitance derived from the redox sites in asymmetric TiN contributes to the reduced capacitance retention vs. superconducting TiN cannot be ruled out. However, the capacitance retention trend for faster scan rates (500 mV s⁻¹ to 5 V s⁻¹) is similar, suggesting that improved electrical conductivity is the dominant factor. Based on this result, it was concluded that this experiment does not yet test the limit of diffusion inside the asymmetric TiN structure. Instead, the limitation of this measurement is likely the electrical conductivity of the synthesized material. These results demonstrate the desirable diffusional performance of asymmetric morphologies and suggest that an asymmetric architecture can improve transport through, and pore utilization of, mesoporous materials, with particular interest for energy and sustainability applications.

TABLE 1
Surface area and pore volume of asymmetric materials via nitrogen sorption.

| | | | BET | | Peak | | Single point |
|---|---|---|---|---|---|---|---|
| | | | surface | Micropore | pore | | adsorption pore |
| | Corresponding | Trace | area | area | size | FWHM | volume |
| Material | Figure | Color | [m² g⁻¹] | [m² g⁻¹] | [nm] | [nm] | [cm³ g⁻¹] |
| Asymmetric | 2p, q | Black | 1024 ± 142 | 655 | 20 | 12 ± 5.1 | 1.69 |
| Carbon (FIG. 2i) | | | | | | | |
| Asymmetric | 8n, o | Black | 1322 ± 357 | 837 | 18 | 14 ± 6.4 | 1.96 |
| Carbon (FIG. 2h) | | | | | | | |
| Asymmetric TiO₂ | 7h, i | Red | 60 ± 1.1 | 11 | 42 | 16 ± 6.8 | 0.57 |
| Asymmetric TiN | 2p, q | Blue | 90 ± 3.0 | 15 | 41 | 17 ± 7.1 | 0.59 |
| Mesoporous TiN | 9f, g | Green | 139 ± 2.1 | 35 | 24 | 4.2 ± 1.8 | 1.29 |

TABLE 2
Lattice parameters and coherent scattering domain sizes of asymmetric materials via XRD.

| | Corresponding | | Anatase TiO₂ | | | TiN | |
|---|---|---|---|---|---|---|---|
| Material | Figure | Trace Color | LC a [Å] | LC c [Å] | CSDS [nm] | LC a [Å] | CSDS [mn] |
| Asymmetric 130° C. Hybrid | 6e | Purple | — | — | — | — | — |
| Asymmetric TiO₂ | 7g | Red | 3.79 | 9.52 | 12 | — | — |
| Asymmetric TiN | 2o | Blue | — | — | — | 4.20 | 6.9 |
| (75 s evaporation time) | | | | | | | |
| Asymmetric TiN | 8m | Blue | * | * | * | 4.21 | 6.5 |
| (60 s evaporation time) | | | | | | | |
| Mesoporous TiN | 9e | Green | — | — | — | 4.20 | 5.6 |
| Asymmetric TiN | 5g, 14 | Yellow | — | — | — | 4.24 | 19 |
| Superconductor | | | | | | | |
| Asymmetric TiO₂ | 14 | Red | 3.80 | 9.54 | 12 | — | — |
| (for superconductor) | | | | | | | |
| Asymmetric 130° C. Hybrid | 14 | Red | — | — | — | — | — |
| (for superconductor) | | | | | | | |

*residual TiO₂ (antase)

TABLE 3
Performance Benchmark Summary

| | | | Power | | Energy | | | | |
|---|---|---|---|---|---|---|---|---|---|
| | Testing | Power Density | Density | Energy Density | Density | | Loading | | |
| Material | Configuration | Formula | [kW kg⁻¹] | Formula | [W-h kg⁻¹] | Electrolyte | [per cm⁻²] | | Reference |
| LaMnO_{2.91} | Two Electrode Symmetric Cell | Not Reported | 0.2 4.2 | $\frac{1}{2} {C}_{cell} {V}^{2}$ | 68.4 26.9 | 0.1 mol L⁻¹ KOH | 1 | mg | Mefford, J.T., et al. Nature Materials 13.7 (2014): 726-732. |
| MnO₂ and Activated Carbon | Two Electrode Asymmetric Cell | $I \frac{V}{2}$ | 3.6 | (Power Density) (Ti [symbol] | 10.0 | 0.65 mol L⁻¹ K₂SO₄ | 6.2 mg (MnO₂); 4.5 mg (Carbon) | | Brousse, T., et al. J Electrochem. Soc. 151.4 (2004): A614-A622. |
| MnO₂ and Graphitic Carbon | Two Electrode Asymmetric Cell | Not Reported | 0.2 7.0 | Not Reported | 16.9 2.5 | 1 mol L⁻¹ Na₂SO₄ | 5.1 mg (MnO₂); 10.1 mg (Carbon) | | Lei, Z., et al. J. Mater. Chem. 22.1 (2012): 153-160. |
| MnO₂ and Reduced Graphene Oxide | Two Electrode Asymmetric Cell | $I \frac{V}{2}$ | 0.2 | (Power Density) (Ti [symbol] | 4.7 | 1 mol L⁻¹ Na₂SO₄ | 5 | mg | Sumboja, A., et al. Advanced Materials 25.20 (2013): 2809-2815. |
| MnO₂ | Three Electrode Cell | $\frac{Energy Density}{Time}$ | 3.6 26.0 | $\frac{1}{2} {C}_{electrode} {V}^{2}$ | 50.3 12.7 | 1 mol L⁻¹ Na₂SO₄ | 10.2 | μg | Yu, Z., et al. Advanced Materials 25.24 (2013): 3302-3306. |
| Carbon Nanotubes | Two Electrode Symmetric Cell | $\frac{{V}^{2}}{4 R}$ | 52.3 | $\frac{1}{2} {C}_{cell} {V}^{2}$ | 22.1 | 1 mol L⁻¹ H₂SO₄ | 1.7 | mg | Hu, L., et al. PNAS 106.51 (2009): 21490-21494. |
| Carbon Nanotubes | Two Electrode Symmetric Cell | $\frac{{V}^{2}}{4 R}$ | 23.0 | $\frac{1}{2} {C}_{cell} {V}^{2}$ | 6.0 | H₃PO₄/ PVA | 33 | μg | Kaempgen, M., et al. Nano Letters 9.5 (2009): 1872-1876 |
| 3D Graphene Hydrogel | Two Electrode Symmetric Cell | $\frac{Energy Density}{Time}$ | 0.2 5.0 | $\frac{1}{8} {C}_{electrode} {V}^{2} *$ | 6.6 5.3 | 1 mol L⁻¹ H₂SO₄ | 2 | mg | Xu, Y., et al. ACS Nano 7.5 (2013): 4042-4049. |
| Graphene | Two Electrode Symmetric Cell | $I \frac{V}{2}$ | 0.7 99.9 | $\frac{1}{8} {C}_{electrode} {V}^{2} *$ | 7.3 5.1 | 1 mol L⁻¹ H₂SO₄ | 1 | mg | Yang, X., et al. Science 341.6145 (2013): 534-537. |
| N-Doped Mesoporous Carbon | Two Electrode Symmetric Cell | $\frac{{V}^{2}}{4 R}$ | 34.5 42.5 | $\frac{\vert I \vert \int \vert Vdt \vert}{2}$ | 25.5 36.5 | 0.5 mol L⁻¹ H₂SO₄ | 0.5 | mg | Lin, T. et al. Science 350.6267 (2015): 1508-1513. |
| Hierarchical Porous Carbon | Two Electrode Symmetric Cell | $I \frac{V}{2}$ | 0.2 23.7 | $\frac{1}{2} {C}_{cell} {V}^{2}$ | 6.7 5.2 | 6 mol L⁻¹ KOH | 5 | mg | Wang, D., et al. Angew. Chem. Int. Ed. 47.2 (2008): 373-376. |
| Ti₃C₂ MXene | Three Electrode Cell | (Energy Density [symbol] | 0.2 2.2 | $\frac{1}{2} {C}_{electrode} {V}^{2}$ | 5.1 3.4 | 1 mol L⁻¹ KOH | 2-3 mg | | Lukatskaya, M.R., et al. Science 341.6153 (2013): 1502- [symbol] |
| Asymmetric Carbon | Three Electrode Cell | $\frac{Energy Density}{Time}$ | 0.9 287.9 | $\frac{1}{2} {C}_{electrode} {V}^{2}$ | 28.5 14.5 | 0.1 mol L⁻¹ HClO₄ | 0.32 | mg | This Work |
| Asymmetric TiN | Three Electrode Cell | $\frac{Energy Density}{Time}$ | 0.8 28.2 | $\frac{1}{2} {C}_{electrode} {V}^{2}$ | 15.7 7.3 | 0.1 mol L⁻¹ HClO₄ | 0.95 | mg | This Work |

[symbol]

indicates data missing or illegible when filed

TABLE 4
Electrode Thicknesses

| | Electrode |
|---|---|
| Material | Thickness [μm] |
| Asymmetric Carbon | 8 |
| Asymmetric TiN | 60 |
| Superconducting TiN | 63 |
| Mesoporous TiN | 65 |

Methods. Materials synthesis/preparation. Materials used. Materials were used as received unless otherwise stated. Anhydrous (99.9%) grades of tetrahydrofuran (THF) and 1,4-dioxane (DOX) were obtained from Sigma-Aldrich. The following chemicals were used for the sol-gel synthesis: Tetrahydrofuran (THF) (Sigma-Aldrich, anhydrous, ≥99.9%, inhibitor-free), titanium tetraisopropoxide (TTIP) (Sigma Aldrich, 99.999% trace metals basis or Alfa Aesar, 99.995% metals basis), and hydrochloric acid (HCl) (VWR/BDH, ACS Grade, 36.5-38%).

The materials used in the synthesis of the phenol formaldehyde resols additive were phenol (Sigma-Aldrich, purified by redistillation, ≥99%), formalin solution (Sigma-Aldrich, ACS reagent, 37% by mass in water, 10% to 15% methanol as stabilizer), sodium hydroxide (Sigma-Aldrich, reagent grade, ≥98% pellets anhydrous), para-toluene sulfonic acid monohydrate (Sigma-Aldrich, ACS reagent, ≥98.5%), and deionized (DI) water with a resistivity of 18.2 MΩcm, which was also used as the nonsolvent precipitation bath.

The following gases were used for thermal processing: argon (Airgas, high purity) and nitrogen (Airgas, ultra-high purity or built in purifier), and either electronic grade ammonia (Praxair, 99.999%) or anhydrous ammonia (Airgas, 99.9%, premium grade,) purified over an SAES MicroTorr MC400-702F purifier to remove residual oxygen and moisture.

The following chemicals were used in the electrochemical measurements: perchloric acid (GFS Chemicals, Veritas double-distilled), Pelco Colloidal Gold Paste (Ted Pella), Omegabond 101 epoxy (Omega Engineering), argon (Airgas, ultra-high purity), and deionized (DI) water with a resistivity of 18.2 MΩcm.

Materials used in the resistivity measurement were silver wire (99.95%, 0.2 mm, VWR) and Epo-TEK H20E silver-filled epoxy (Electron Microscopy Sciences).

Polymer Synthesis and Characterization. ISV for preparation of asymmetric oxides, nitrides and carbons. The poly(isoprene-b-styrene-b-4-vinylpyridine) (PI-b-PS-b-P4VP, or simply ISV) triblock terpolymers used to prepare the asymmetric materials herein were synthesized via a previously reported sequential living anionic polymerization route. The ISV used for the asymmetric TiN syntheses had a molar mass of 113 kg mol⁻¹ with volume fractions of 29% PI, 59% PS, 12% P4VP, and a dispersity of 1.3. The ISV used for the asymmetric carbon syntheses had a molar mass of 95 kg mol⁻¹ with volume fractions of 29% PI, 57% PS, 14% P4VP, and a dispersity of 1.2.

A Varian INOVA 400 MHz ¹H solution nuclear magnetic resonance (H NMR) spectrometer was used to determine the block fractions of each block using chloroform-d₆ as the solvent (D, 99.8%, Cambridge Isotope Laboratories). A Waters ambient temperature gel permeation chromatograph (GPC) equipped with a Waters 410 differential refractive index (RI) detector (flow rate: 1 mL min⁻¹) was used to analyze the ISV dispersity using polystyrene standards for dispersity determination. Tetrahydrofuran (THF) was used as the solvent. Overall ISV molar mass was obtained using the molar mass of the PI block obtained from an aliquot removed from the reaction vessel after PI synthesis (determined with GPC using PI standards) combined with the NMR-derived molar ratios of the different blocks.

ISO for alternating gyroidal mesoporous oxides and nitrides. The poly(isoprene)-b-styrene)-b-ethylene oxide) (PI-b-PS-b-PEO, or simply ISO) triblock terpolymer used to make the BCP SA derived mesoporous materials with alternating gyroid morphology was synthesized using a sequential living anionic polymerization method reported elsewhere. The polymer had a molar mass of 83 kg mol-1 with volume fractions of 29% PI, 64% PS, 6.5% PEO, and a dispersity of 1.09, determined via the GPC-NMR procedure described above.

Polymer Dope Solution Preparation. Asymmetric oxides and nitrides. The ISV solutions used to prepare the asymmetric TiN were prepared by dissolving ISV at a mass fraction of 15% in a solvent mixture of DOX:THF (mass ratio of 7:3) and stirred to obtain homogeneous solutions. The TiO₂ sol was prepared separately via a hydrolytic sol-gel route, similar to that reported previously. 1.0 mL titanium isopropoxide was added to 0.3 mL HCl in a septum vial, stirred vigorously for 5 min, at which time 2 mL of THE was added. The mixture was then again stirred for 2 min (min=minute(s)) before being added to the casting solution. Typically, 0.1 g of ISV was used to prepare the initial solution. The TiO₂ sol was prepared separately via a hydrolytic sol-gel route, similar to that reported previously. The overall volume fraction of TiO₂+ISV in solvent was 7.9%.

Asymmetric carbons. The ISV solutions used to prepare asymmetric carbons were made by dissolving ISV in a mass ratio of 7:3 DOX:THF, allowing for the solution to fully homogenize before adding the resols in a 2:1 mass ratio ISV:resols. This “consecutive” method was used for the preparation of materials with cross-sections as shown in FIG. 2i. Alternatively, in the “simultaneous” method, the solid ISV was mixed with resols (predissolved in a 7:3 DOX:THF mass ratio) in a 2:1 ISV:resols mass ratio, immediately followed by adding solvent (7:3 DOX:THF). For both methods stock solutions of a mass fraction of 25% resols in DOX:THF (7:3 mass ratio) were made. The final casting solution had a mass fraction of 10% ISV+resols (with a 2:1 ISV:resols mass ratio) in 7:3 DOX:THF.

Alternating gyroidal mesoporous oxides and nitrides. The solutions used to make the alternating gyroidal mesoporous materials were prepared using a similar method to that known in the art. ISO (150 mg) were dissolved in THE (6.00 mL). Thereafter, the sol solution (497 μL), prepared as described above, was added to the ISO/THF solution such that the volume fraction of PEO and TiO₂ together was 17.0% (corresponding to a volume fraction of 11.2% TiO₂ relative to ISO, also referred to as vol %).

Dope Solution Casting. Asymmetric oxides and nitrides. Self-assembly/co-assembly and non-solvent induced phase separation (S/CNIPS) was used to prepare the asymmetric materials. The casting solution was pipetted onto a glass substrate, a thick film was cast with a doctor blade using a fixed gate height (height between the substrate and casting blade) adjusted using feeler blades of 305 and 381 μm. After 75 s evaporation time, to allow for the formation of a concentration gradient along the film-normal, the films were plunged into a non-solvent DI water bath to allow for precipitation, thereby producing the porous membranes with structural gradient.

Alternating gyroidal mesoporous oxides and nitrides. In order to make the gyroidal mesoporous materials, the solutions were cast in 1 cm diameter Teflon dishes, which were set on a glass dish and covered by a glass dome at room temperature. The slow evaporation of the solvent led to solvent evaporation induced self-assembly, which was continued until the films were fully dry (typically 24 to 48 h).

Asymmetric carbons. Co-assembly and nonsolvent induced phase separation (CNIPS) was used to prepare the ISV+resols hybrid membranes. Films were cast onto substrates heated to 30° C. in an environment with relative humidity below 28%. A pipette was used to dispense the casting solutions onto the glass substrates. Thereafter a doctor blade whose gate height was adjusted to between 203 and 229 μm was used to control the film thickness. After 40 s evaporation time, the films were plunged into a non-solvent DI water bath to precipitate the polymer.

Thermal Processing. All oxides and nitrides. The membranes/films were dried and then heated in a convection oven to 50° C. for 2 h, followed by 5 h at 130° C. In the case of the gyroidal mesoporous materials, the polymer/oxide hybrid films were etched to remove dense interface overlayers. The etching procedure consisted of a CF₄ plasma in an Oxford Plasmalab 80+ Reactive Ion Etcher system at 300 W for 45 min on each side of the film. The asymmetric materials did not require etching. These steps were followed by a heat-treatment step in a flow furnace under ambient air to produce the freestanding oxides. The temperature profile for this step was 1° C. min⁻¹ to 400° C. The temperature was held at 400° C. for 3 h before being allowed to cool back to room temperature. To produce titanium nitrides, the oxides were heated in a flow furnace under flowing ammonia gas (10 L h⁻¹) with a ramp rate of 5° C. min⁻¹. The temperature was held at 600° C. for 6 h before being allowed to cool to room temperature. Before removing the samples from the furnace, the tube was purged with argon or nitrogen in order to remove any remaining ammonia gas.

To obtain superconducting titanium nitrides, a second heat-treatment in ammonia at 5° C. min⁻¹ to 865° C. with a dwell time of 3 h at 865° C. and an ammonia flow rate of 10 L h⁻¹ was used. After the dwell time, the tube was cooled to room temperature under flowing ammonia and purged with argon or nitrogen before the samples were removed.

Asymmetric carbons. After casting, the membranes were dried and heated for 24 h in a convection oven at 130° C. to crosslink the resols. Thereafter, the membranes were subjected to an additional heat-treatment step under flowing nitrogen with the following temperature profile: 1° C. min⁻¹ to 600° C. with a dwell time of 3 h, followed by further heating at a ramp rate of 5° C. min⁻¹ to 900° C. with a dwell time of 3 h. Thereafter, the materials were allowed to cool to room temperature at ambient rate.

Materials characterization. SEM Analysis. Scanning electron microscopy (SEM) micrographs were obtained using a ZEISS Gemini 500 scanning electron microscope (SEM) operated at an accelerating voltage of 2 kV. Samples were either uncoated or coated with gold-palladium prior to imaging. SEM images were brightness/contrast adjusted.

X-ray Diffraction Characterization. XRD data for the hybrids, oxides, and nitrides were collected on a Bruker D8 Advance ECO powder diffractometer equipped with a high-speed silicon strip detector, using Cu Kα radiation (λ=1.54 Å) and a step size of 0.019° (2θ) at 5.7° min⁻¹. MDI Jade was used to fit the peak profiles.

Lattice parameters for titanium nitride were calculated using the position of the (200) peak, while lattice parameters for titanium dioxide were calculated as the average of parameters calculated using the positions of the (200) and (105) peaks. Coherent scattering domain sizes were calculated using the Debye-Scherrer equation with shape factor k=1 and were the result of an average of the values for the first five peaks for titanium nitride and the average of the (101), (200), (105), and (211) peaks for titanium dioxide. Instrumental and other sources of peak broadening were not accounted for in this analysis, which represents the lower limit of the domain size.

Nitrogen Sorption. Nitrogen adsorption-desorption isotherms of the oxides, nitrides, and carbons were recorded using a Micromeritics ASAP 2020 surface area and porosity analyzer at −196° C. The specific surface areas were determined using the Brunauer-Emmett-Teller (BET) method. Barrett-Joyner-Halenda (BJH) analysis was used to determine the pore size distributions. The reported errors result from the standard deviation from weighing each material several times. The standard deviation of the full-width at half-max (FWHM) is a result of fitting the pore size distribution with a least-squares fit to a gaussian function in Igor Pro.

Small-Angle X-Ray Scattering. SAXS data in FIG. 9d was collected at the Soft Matter Interfaces beamline at NSLS-II in in-vacuum mode using a Dectris Pilatus 1M detector operated at a sample-to-detector distance of 8.287 m and an incident photon energy of 11.50 keV. The resulting images were radially integrated and plotted using the Nika and Irena packages for Igor Pro.

Electrochemical Measurements. Electrodes were fabricated by adhering titanium wire to the nitride and carbon monoliths using a two-step procedure. First, the wires were affixed to the more dense (shiny) side of the monoliths with conductive gold paint and allowed to cure for 2 h. After curing, an inert two-part epoxy was mixed and used to cover the back and sides of the monolith as well as the gold paint and approximately 2.5 cm of the wire to ensure that only the monolith generated an electrochemical response. The inert epoxy was allowed to cure for 12 h.

All electrochemical measurements were conducted using a three-electrode electrochemical cell with 0.1 mol L⁻¹ perchloric acid as the supporting electrolyte and a platinum wire as the counter electrode. The applied potential was controlled using a Bio-Logic SP-300 potentiostat while an Ag/AgCl electrode was used as the reference electrode. The reference electrode was placed in a capillary filled with 0.1 mol L⁻¹ perchloric acid to further isolate it from the electrolyte and prevent chlorine evolution at high applied potentials. The reference electrode was calibrated against the reversible hydrogen electrode (RHE) scale by measuring the hydrogen evolution/oxidation currents on a polycrystalline Pt disk (Pine) in 0.1 mol L⁻¹ HClO₄ electrolyte. All potentials in this study were referenced to the RHE potential scale.

Capacitance measurements of all monoliths were obtained using cyclic voltammetry in an electrolyte saturated with argon (Airgas, ultra-high purity) prior to measurement. All cyclic voltammograms were measured both with iR-corrected potentials and without iR correction. The total resistance, R, was measured as the AC impedance at high frequency in the three-electrode system and corresponded to the sum of all electrolyte and contact resistances. This resistance value was subsequently used to manually compensate the applied potential using the Bio-Logic SP-300 hardware compensation mode during the measurements. The iR-corrected cyclic voltammograms were used to compare the intrinsic capacitance retention of each asymmetric and mesoporous morphology. Since literature results typically report performance without iR compensation, however, the uncompensated results were used to calculate all power and energy densities.

To introduce oxygen functional groups to the asymmetric graphitic carbon surface, each monolith was activated by cycling between 0.01 V vs RHE and 1.4 V vs RHE at 5 V s⁻¹ until the cyclic voltammogram reached an equilibrium where it did not change with subsequent cycling. All TiN monoliths were measured between 0.01 V and 1.4 V vs RHE without a prior activation step. For all samples, data for the fastest scan rate were collected first, followed by incrementally slower rates.

Chronoamperometry measurements were conducted in the same Ar-saturated electrolyte. The effective time constants were calculated by fitting the chronoamperometry data over the exponential decay regime using:

$$\frac{I}{{I}_{0}} = {e}^{- t / RC} \qquad ( 1 )$$

The cutoff point for the data was defined as the point at which R²=0.99 for the exponential fit.

Power and Energy Density Calculations. he power and energy densities reported herein were calculated from cyclic voltammograms without iR compensation. The total electrode gravimetric capacitance, C_{electrode}, was first calculated using:

$${C}_{electrode} = \frac{{\int }_{{V}_{1}}^{{V}_{2}} I ( V ) dV}{2 ( {V}_{2} - {V}_{1} ) \frac{dV}{dt}} \qquad ( 2 )$$

Subsequently, the energy density of one electrode was calculated using the total electrode gravimetric capacitance and half-cell voltage:

$$Energy Density = \frac{1}{2} {C}_{electrode} {V}_{half - cell}^{2} \qquad ( 3 )$$

The average power density was calculated from dividing the energy density by the discharge time. The calculated power and energy densities were benchmarked against several state-of-the-art literature results. The selected literature results used either a two-electrode testing configuration to report the performance of a full cell, or a three electrode testing configuration to report the performance of a single electrode. To report the full cell energy density from a two-electrode measurement, the full cell gravimetric capacitance and voltage were typically used:

$$Energy Density = \frac{1}{2} {C}_{cell} {V}_{cell}^{2} \qquad ( 4 )$$

Since the gravimetric capacitance of a single electrode is 4× the full cell gravimetric capacitance measured in a two-electrode configuration, the full cell energy density for a two-electrode measurement could also be calculated from the capacitance of a single electrode using:

$$Energy Density = \frac{1}{8} {C}_{electrode} {V}_{cell}^{2} \qquad ( 5 )$$

For literature results, which used a three-electrode configuration to report the energy density of a single electrode, Equation (3) was used. The results for both testing configurations are plotted together under the assumptions that ion transport is similar in both configurations, the gravimetric capacitance of a single electrode is 4× the full cell gravimetric capacitance, and the cell voltage is 2× the half-cell voltage. Equations (3)-(5) also assume a voltage independent capacitance. Due to the high power density of our materials, however, the conclusion that asymmetric carbon possesses the highest energy density (14.5 W-h kg⁻¹) at the reported power density (287.9 kW kg⁻¹) should not be affected by these assumptions. To normalize the performance by the electrode mass, two methods were used. For gyroidal mesoporous TiN, the total mass of each electrode was derived from the pore volume measured with nitrogen sorption and the electrode thickness measured using SEM. Specifically:

$$Electrode mass = \frac{( thickness ) ( electrode area )}{pore volume} \qquad ( 6 )$$

The pore volume only accounts for meso- and microporosity, however, so for the asymmetric morphologies, monoliths were weighed using a TA Instruments Q500 thermogravimetric analyzer (TGA) and normalized by the electrode area to obtain an areal density for each asymmetric morphology. This areal density was subsequently multiplied by the area of each electrode to obtain the electrode mass. The measured areal densities were 0.32 mg cm⁻² (asymmetric carbon), 0.95 mg cm⁻² (asymmetric TiN), 1.95 mg cm⁻² (superconducting asymmetric TiN), and 5.05 mg cm⁻² (mesoporous TiN). Volumetric surface areas were calculated by multiplying the specific surface area by the thickness and areal density.

Conductivity Measurements. Conductivity measurements were performed using samples prepared in a multistep procedure. Monoliths were mounted onto a carrier chip and electrically contacted using Epo-TEK H20E silver-filled epoxy. The carrier chip was fabricated by sputter depositing multiple gold contact pads onto a 100 nm thermal oxide layer on a (110) silicon substrate. These gold pads were in turn contacted using silver wire and Epo-TEK H20E, and a Keithley 2400 source meter used for a four-point Van der Pauw conductivity measurement. The horizontal resistance was measured via the average voltage drop along the two horizontal edges using both polarities of the current source and voltage meter. An analogous method was used to calculate the vertical resistance. All measurements were performed with an excitation current of 100 pA. The sheet resistance was calculated numerically from the horizontal and vertical resistance using the relation:

e^{-πR}^{_{vertical}}^{/R}^{ₛₕₑₑₜ}+e^{-πR}^{_{horizontal}}^{/R}^{ₛₕₑₑₜ}=1 (7)

Resistivity was determined by multiplying the sheet resistance by the thickness and the porosity fraction, while conductivity was calculated from the inverse of resistivity.

Magnetization Characterization. Temperature-dependent magnetization measurements were conducted on a Quantum Design Physical Property Measurement System (PPMS) Vibrating Sample Magnetometer (VSM). A sample of the superconducting nitride after all heat treatments was placed in a polypropylene powder capsule and mounted in a brass half-tube on the VSM. The sample was zero-field cooled to 2.2 K, after which a field of 796 Å m⁻¹ was applied and the sample position determined by scanning for a negative magnetic moment. The moment was then measured while scanning temperature from 2.2 K to 5 K at 1 K min⁻¹, after which the sample was warmed to room temperature.

### Example 2

This example provides a description of asymmetrically porous films of the present disclosure. Also provided are methods of making and uses of the asymmetrically porous films.

Asymmetrically structured, porous materials allow for high surface area accessibility and fast diffusion making them attractive for applications in energy conversion and storage, separations, and catalysis. Block copolymer (BCP) self-assembly provides a route to obtaining such porous, asymmetric materials in which a mesoporous top surface merges into a porous support structure with increasing macroporosity along the film normal. BCPs can further be used to structure-direct organic or inorganic materials. Described is the co-assembly and non-solvent induced phase separation (CNIPS) of poly(isoprene)-b-poly(styrene)-b-poly(4-vinylpyridine) (ISV) triblock terpolymer and titanium dioxide (TiO₂) sol-gel nanoparticles to obtain hybrids with structural asymmetry. Upon heat-treatment in air, free-standing TiO₂ can be obtained. Further heat-treatment in ammonia results in free-standing titanium nitride (TiN). The resulting oxides and nitrides are structurally asymmetric and have mesoscopic porosity. The walls of the macroporous pockets are mesoporous. Changes in the processing temperature of the oxide allowed for tuning of the crystallinity and porosity of the oxide. This in turn influences the properties of the resulting nitride. It was also shown that these properties influence the nitride performance in electrochemical applications.

The focus of this Example is the synthesis of asymmetric TiO₂ and TiN resulting from the CNIPS procedure and subsequent heat-treatment. By controlling the processing parameters (e.g., evaporation time, maximum temperature), the material properties can be tuned. Though their macroscopic structures look similar, the crystallinity is different either mixed phase or single phase. Further, by tuning the material properties, the specific capacitance could be improved.

Experimental Section. Materials Synthesis/Preparation/Materials. Unless otherwise state, materials were used as received. 1,4-Dioxane (DOX, Sigma-Aldrich, anhydrous, 99.8%) and Tetrahydrofuran (THF, Sigma-Aldrich, anhydrous, ≥99.9%, inhibitor-free) were used to make the casting solutions. The TiO₂ sol NPs were made using hydrochloric acid (HCl, VWR, BDH, ACS Grade, 36.5-38%), titanium tetraisopropoxide (TTIP, Sigma Aldrich, 99.999% trace metals basis or Alfa Aesar, 99.995% metals basis), and tetrahydrofuran (THF, Sigma-Aldrich, anhydrous, ≥99.9%, inhibitor-free). In the SNIPS synthesis, the non-solvent/precipitation bath was deionized (DI) water with a resistivity of 18.2 MΩcm.

Heat-treatment was performed using these gases: Either ammonia (NH₃, Airgas, anhydrous, 99.9%, purified over an SAES MicroTorr MC400-702F purified to remove residual moisture/oxygen) or ammonia (NH₃, Praxair, electronic grade, 99.9999%) for the nitride synthesis. Argon (Ar, Airgas, high purity) or nitrogen (N₂, Airgas, high purity) to purge the furnace tube of residual ammonia.

Polymer Synthesis and Characterization. A previously described sequential living anionic polymerization process was used to synthesize the poly(isoprene)-b-poly(styrene)-b-poly(4-vinylpyridine) (ISV) triblock terpolymer. The ISV triblock terpolymer used had a total molar mass of 113 kg mol-1. The volume fractions for poly(isoprene) (PI), poly(styrene) (PS), poly(4-vinylpyridine) were 29 vol % (also referred to as a volume fraction), 59 vol %, and 12 vol %, respectively. The dispersity (Ð) of the ISV was 1.3 determined via gel permeation chromatography. Using a combination of gel permeation chromatography and nuclear magnetic resonance spectroscopy, the molar mass of the individual fractions and thus the entire block copolymer could be determined. In order to determine the block fractions of each block, the polymer was dissolved in chloroform-d₆ (D, 99.8%, Cambridge Isotope Laboratories) prior to analysis using a Varian INOVA 400 MHz ¹H solution nuclear magnetic resonance (¹H NMR) spectrometer. In order to determine the dispersity (Ð) using PS standards, the polymer was dissolved in THE and analyzed using a Waters ambient-temperature gel permeation chromatograph (GPC) equipped with a Waters 410 differential refractive index (RI) detector (flow-rate 1 mL min⁻¹). The overall ISV molar mass was determined using a combination of GPC and NMR, i.e., by using the molar mass of the PI (obtained from GPC using PI standards) and combining this with the NMR results of the molar ratios of the blocks.

Solution Preparation. The casting solutions used herein were prepared by first dissolving ISV at 15 wt % concentration in a 7:3 (by weight) solvent mixture of DOX:THF. Typically, 0.1 g of ISV was used to prepare the initial solution of ISV in 7:3 DOX:THF. The solution was stirred until homogeneous. The TiO₂ sol was prepared in a separate vial via a hydrolytic sol-gel route, adapted from a previously reported process. 7.9 vol % ISV+TiO₂ was the volume percent of the casting solution.

Casting. The asymmetric materials were prepared via a process called self-assembly/co-assembly and non-solvent induced phase separation (S/CNIPS). In this process, the casting solution was pipetted onto a glass substrate. Thereafter, a doctor blade was used to cast a thick film of predetermined height. Prior to casting, the gate height (height between the casting blade and substrate) was adjusted to 0.305 and 0.381 μm thickness using feeler blades. After casting, the solvents in the film were allowed to evaporate for a specified amount of time (typically 75 s unless otherwise stated) to allow for a concentration gradient to form along the film normal. After this evaporation time period, the films were plunged into a non-solvent DI water bath. This step precipitated the ISV+TiO₂, thereby turning the concentration gradient into a structural gradient.

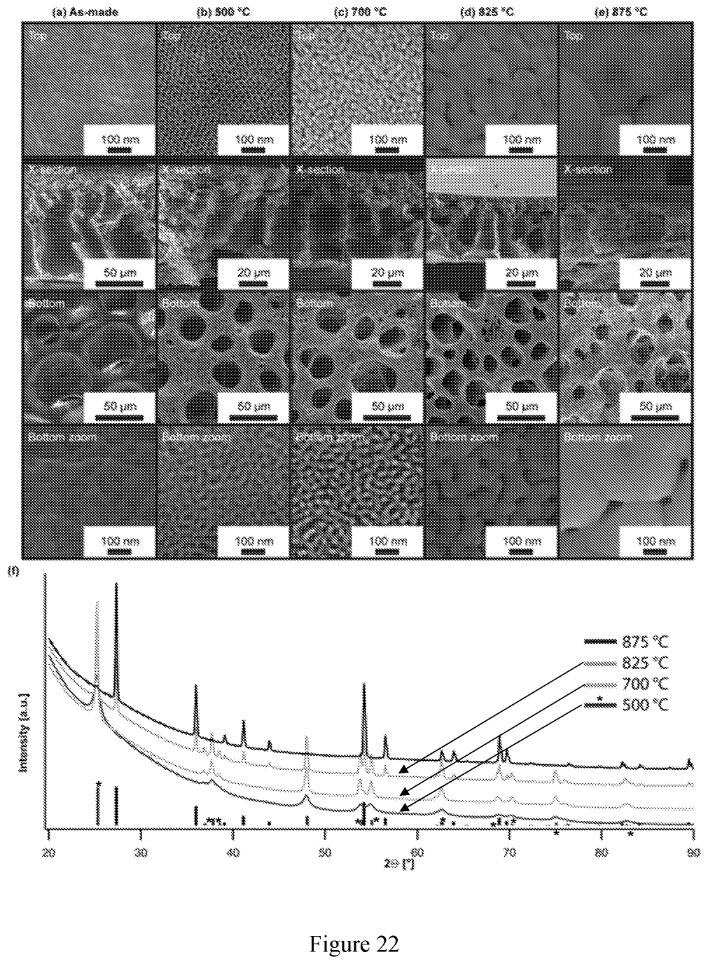

Temperature Processing. Once the membranes were made, they were dried in a vacuum oven and then heated first to 50° C. for 2 h, followed by an additional heating step for 5 h at 130° C. Thereafter, a flow furnace was used for further heat-treatment steps. In order to produce the oxide material, the furnace was open to air. The temperature profile for this step was 1° C. min⁻¹ to 300° C., 400° C., or 500° C. The temperature was held at 300° C., 400° C., or 500° C. for 3 h before being allowed to cool back to room temperature at ambient rate. In order to produce the free-standing nitride, either the oxide material was heated or the original 130° C. hybrid material was heated in a flow furnace under flowing ammonia gas (10 L h⁻¹). Regardless of the oxide being used for making the nitride, the temperature profile was 5° C. min⁻¹ to 600° C. The temperature was held at 600° C. for 6 h before being allowed to cool to room temperature at ambient rate. Before removing the sample from the furnace, the tube was purged with either argon or nitrogen in order to remove any remaining ammonia gas. In the case of the anatase to rutile series (FIG. 22), the ramp rate was 1° C. min⁻¹ to 500, 700, 825 and 875° C. with a dwell time of 0.1 h instead of 3 h. The samples were treated in a flow furnace that was open to air.

Materials Characterization. SEM Analysis. Scanning electron microscopy (SEM) micrographs were obtained using either a TESCAN MIRA3 FE-SEM (in-lens detector, accelerating voltage of 5-15 kV) or a ZEISS Gemini 500 Scanning Electron Microscope (SEM) (accelerating voltage of 2 kV). The samples were either left uncoated or coated with gold-palladium prior to imaging using a Denton Vacuum Desk II. Some SEM images were brightness/contrast adjusted.

X-ray Diffraction. XRD data for the hybrid, oxide, and nitrides were collected on a Rigaku Ultima IV diffractometer equipped with a D/teX Ultra detector using CuKα radiation (40 V, 44 mA, λ=1.54 Å) and a step size of 0.02° (2θ) at 1° min⁻¹. MDI Jade was used for the analysis by fitting the peak profiles.

Lattice parameters for TiN were calculated using the raw XRD data using the (200) reflection. The coherent scattering domain sizes were calculated using the Debye-Scherrer analysis with shape factor k=1, and were the result of an average of the values for the first five peaks, unless otherwise noted. Peak markings correspond to the expected peak positions and relative intensities of cubic Fm3̅m (space group #225) TiN (osbornite) (ICSD entry #00-038-1420) with a reported lattice parameter of 4.2417 Å.

Lattice parameters for the TiO₂ (anatase) were calculated using the raw XRD data of the (200) and (105) reflections. The coherent scattering domain sizes were calculated using the Debye-Scherrer analysis with a shape factor k=1, and were the result of the values obtained using the (101), (200), (105), and (211) reflections, unless otherwise noted. Peak markings correspond to the expected peak positions and relative intensities of a tetragonal crystal system of I4₁/amd (space group #141) for TiO₂ (anatase) (ICSD entry #01-070-7348) with a reported lattice parameter of a=b=3.7840 Å and c=9.5000 Å.

Lattice parameters for the TiO₂ (rutile) were calculated using the raw XRD data of the (101) and (111) reflections. The coherent scattering domain sizes were calculated using the Debye-Scherrer analysis with a shape factor of k=1, and were the result of the values obtained using the (110), (101), (200), (111), (210), (211), and (220) reflections. Peak markings correspond to the expected peak positions and relative intensities of a tetragonal crystal system of P4₂/mnm (space group #136) for TiO₂ (rutile) (ICSD entry #00-021-1276) with a lattice parameter of a=b=4.5933 Å and c=2.9592 Å.

These analyses represent the lower limit of the domain sizes as instrumental and other sources of peak broadening were not accounted for.

Nitrogen Sorption. Nitrogen adsorption-desorption isotherms were recorded using a Micromeritics® ASAP 2020 surface area and porosity analyzer at −196° C. The Brunauer-Emmett-Teller (BET) method was used to obtain the specific surface areas of the various oxides and nitrides. The pore size distributions were obtained using the Barrett-Joyner-Halenda (BJH) analysis. The reported errors in surface area are a result of the standard deviations of repeated sample weighing. The standard deviation of the full-width at half-max (FWHM) is a result of fitting the pore size distribution with a least-squares fit using a gaussian function in Igor Pro.

Thermogravimetry Analysis. A TA Instruments Q500 thermogravimetric analyzer (TGA) was used. The temperature was ramped from room temperature at 1° C. min⁻¹ to 300° C., 400° C., or 500° C. for each of the three samples. There the temperature was held isothermally for 3 h before being allowed to cool back to room temperature at ambient rate. The sample was processed in air.

Electrochemical Measurements. Electrodes were fabricated by adhering titanium wire to the nitride monoliths using a two-step procedure. First, the wires were affixed to the monoliths with conductive gold paint and allowed to cure for 2 h. After curing, an inert two-part epoxy was mixed and used to cover the back and sides of the monolith as well as the gold paint and approximately 1 inch of the wire to ensure that only the monolith generated an electrochemical response. The inert epoxy was allowed to cure for 12 h.

All electrochemical measurements were conducted using a three-electrode electrochemical cell with 0.1 M perchloric acid as the supporting electrolyte and a platinum wire as the counter electrode. The applied potential was controlled using a Bio-Logic SP-300 potentiostat while an Ag/AgCl electrode was used as the reference electrode. The reference electrode was placed in a capillary filled with 0.1 M perchloric acid to further isolate it from the electrolyte and prevent chlorine evolution at high applied potentials. The reference electrode was calibrated against the reversible hydrogen electrode (RHE) scale by measuring the hydrogen evolution/oxidation currents on a polycrystalline Pt disk (Pine) in 0.1 mol L⁻¹ HClO₄ electrolyte and all potentials in this study were referenced to the RHE potential scale.

Capacitance measurements of all monoliths were obtained using cyclic voltammetry in an electrolyte saturated with argon (Airgas, ultra-high purity) prior to measurement by scanning between 0.01 V vs RHE and 1.4 V vs RHE at a series of scan rates between 1 V s⁻¹ and 50 mV s⁻¹. The fastest scan rates were measure first, followed by incrementally slower rates. All cyclic voltammograms were measured with iR-compensated potentials. The total resistance, R, was measured using the Biologic automatic software compensation as the AC impedance at high frequency in the three-electrode system and corresponded to the sum of all electrolyte and contact resistances.

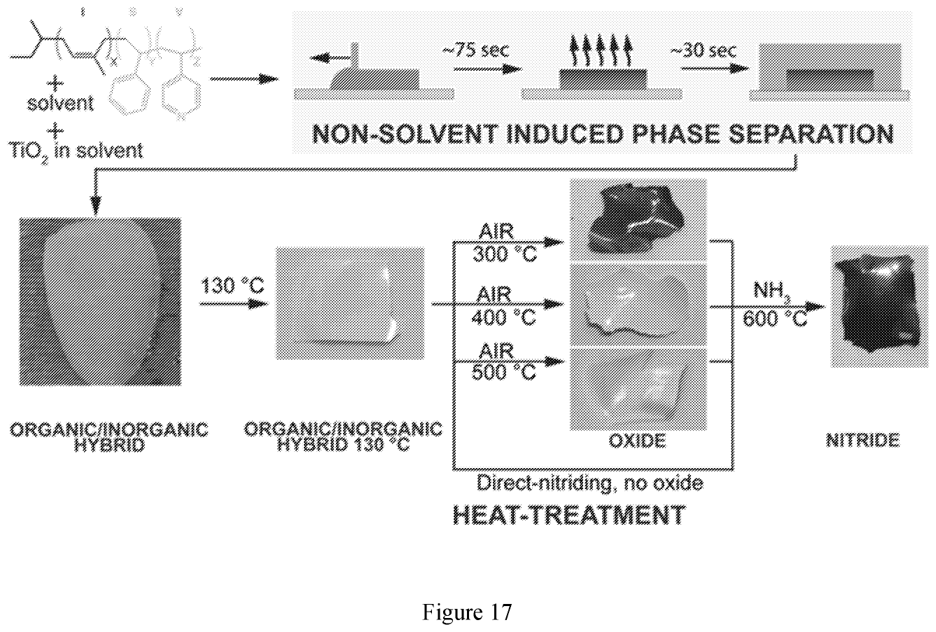

Results and Discussion. Upon immersion into a DI water bath, the polymer was precipitated, converting the ISV+TiO₂ concentration gradient of the films occurring after solvent evaporation into a structural gradient. The resulting membranes were dried at RT and up to 130° C. in a vacuum oven. They were then subjected to heat-treatment in a flow furnace that was open to air (300, 400, and 500° C.). This led to the decomposition of the polymer and formation of a freestanding oxide. The oxide was then subjected to heat-treatment in ammonia (600° C.) to form titanium nitride. In one route, the 130° C. hybrid was directly heat-treated to the nitride without first treating to the oxide in air. Photographs of the materials at each synthetic step are shown in FIG. 17.

Asymmetric, porous titanium oxides and nitrides (Cornell Graded Materials—CGMs) with graded porosity along the film normal were obtained using a process called co-assembly and nonsolvent-induced phase separation (CNIPS) and a series of heat-treatments (FIG. 17). In this process, an amphiphilic block copolymer (BCP) is used as the structure-directing agent for either organic or inorganic additives. In this case, a poly(isoprene)-block-poly(styrene)-block-poly(4-vinylpyridine) (ISV) triblock terpolymer was used to structure direct inorganic (TiO₂) sol-gel nanoparticles (NPs).

The ISV triblock terpolymer employed in this study had a molar mass of 113 kg mol-1 with poly(isoprene) (PI), poly(styrene) (PS), and poly(4-vinylpyridine) volume fractions of 29, 59, and 12 vol %, respectively, and a dispersity (Ð) of 1.3. It was synthesized via a previously reported sequential anionic polymer process. In preparation for the CNIPS process, the ISV was dissolved at 15 wt % in a solvent system of 7:3 (by weight) 1,4-dioxane:tetrahydrofuran (DOX:THF). TiO₂ sol-gel NPs, which are expected to selectively swell the hydrophilic P4VP phase, were prepared via a previously reported sol-gel synthesis route. The TiO₂ sol-gel NPs were added to the homogeneous ISV in DOX:TIF solution. The solutions were cast onto glass slides using a doctor blade whose height had been adjusted to 0.305-0.381 μm using feeler blades. The solvents in the casted films were allowed to partially evaporate for typically 75 s, inducing an ISV+TiO₂ concentration gradient along the film normal. Immediately following the set evaporation time, the films were gently plunged into a non-solvent (deionized water) bath. In this step, the polymer precipitates, which freezes—in the structure by converting the concentration gradient into a structural gradient. This concluded the CNIPS part of the process that resulted in organic/inorganic hybrid membranes.

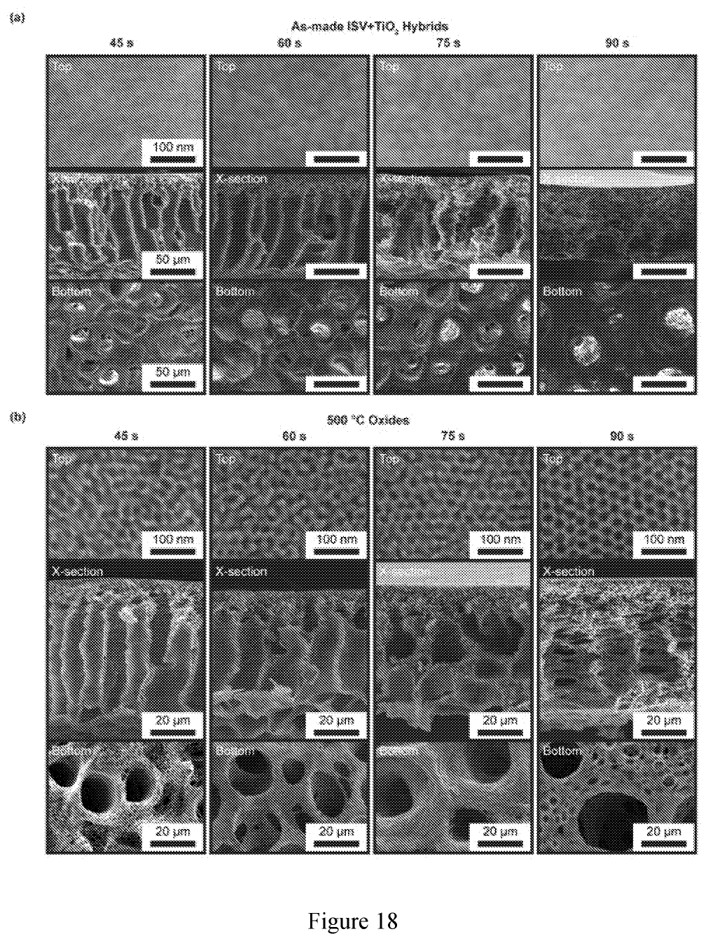

The CNIPS procedure was combined with a series of heat-treatments. The films were dried and then heated to 130° C. to drive off residual solvent or non-solvent. Thereafter, they were either treated to 300° C., 400° C., or 500° C. to obtain freestanding oxide (TiO₂) with either more (300° C.), trace (400° C.), or no (500° C.) leftover carbon as indicated by the color in the photographs in FIG. 18. These oxides were then treated to 600° C. in flowing ammonia to obtain freestanding titanium nitride (TiN). In one route, the oxide step was omitted by taking the 130° C. hybrid and directly heating it in ammonia to obtain freestanding TiN.

Evaporation time as a means to tuning substructure. The S/CNIPS process is highly tunable. Parameters such as evaporation time, casting solution concentration, membrane thickness, and additives can be varied to tune the final structures, both the top surface and substructure. FIG. 18 depicts scanning electron micrographs (SEM) of a series of evaporation times of both the as-made ISV+TiO₂ hybrid materials (FIG. 18a) immediately following precipitation and drying as well as the corresponding free-standing oxides which were treated to 500° C. (FIG. 18b). The evaporation times were varied from 45 s to 60 s to 75 s to 90 s (from left to right).

As can be seen from FIG. 18a, the top surface (top row) remains closed irrespective of the evaporation time. Yet, it appears that the top surface resembles hexagonal ordering. With increasing evaporation time, the cross-section evolves from a more finger-like to a more sponge-like profile (middle row, left to right). This transformation has been previously explained as resulting from the increased film concentration and thus more viscous solutions at higher evaporation times. The higher viscosity delays the solvent and non-solvent exchange, thereby resulting in denser (i.e., more sponge-like) substructures. The bottom surfaces (bottom row) of the materials also change as a result of the increased evaporation time. It appears that with increased evaporation time there are fewer yet larger macropores.

Each of the hybrids in FIG. 18a was turned into an oxide by treating in air at a temperature profile of 1° C. min⁻¹ to 500° C. for 3 h (FIG. 18b). Both the asymmetric cross-section (middle row) and open bottom (bottom row) are retained for each respective evaporation time. However, due to the substantial amount of material that is decomposed, the top surfaces (top row) are now porous. Further, due to the porous top surfaces in the oxides, the hexagonal packing becomes particularly evident at 75 s and 90 s evaporation times.

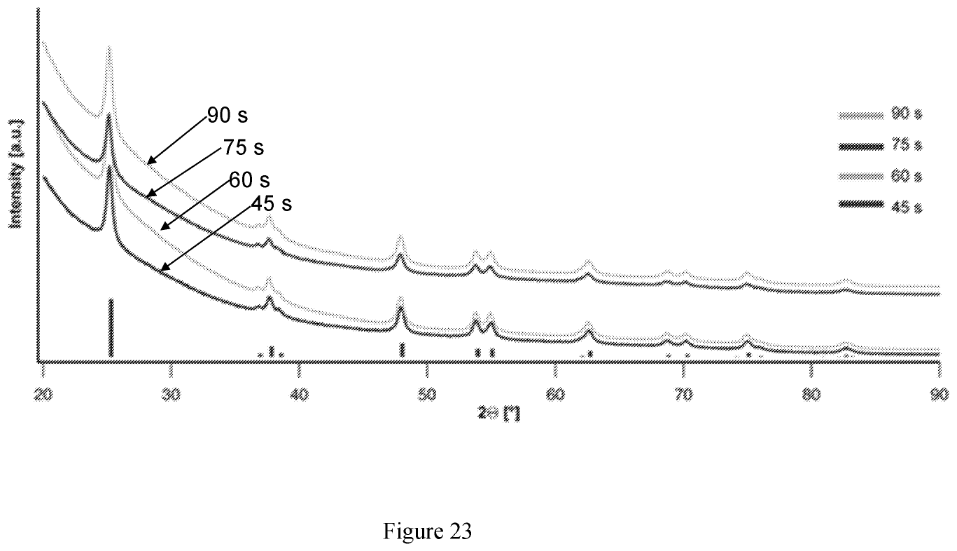

The oxides were characterized using x-ray diffraction (XRD) (FIG. 23). The resulting patterns are consistent with an anatase phase TiO₂ (ICSD #01-070-7348) which crystallizes in space group I4₁/amd (#141) with lattice parameters around a=b=3.80 Å, c=9.53 Å and a coherent scattering domain size of around 15 nm. Individual values can be found in Table 8.

TABLE 8
Lattice constants and crystallite sizes corresponding to the power
XRD of oxides from FIG. 23.

| Evaporation Time | LC a [Å] | LC c [Å] | XS [nm] |
|---|---|---|---|
| 90 s | 3.80 | 9.53 | 14 |
| 75 s | 3.80 | 9.54 | 15 |
| 60 s | 3.80 | 9.54 | 16 |
| 45 s | 3.79 | 9.53 | 15 |

While the CNIPS procedure provides various tunable components that affect the final macroscopic membrane structure and thus surface area accessibility, the subsequent heat-treatments to fabricate both the oxides and nitrides are also controllable and tunable. The heat-treatments affect the material composition and crystallinity, and thus the material performance and application. Generally, single-phase TiN is desirable in electrochemical applications. However, mixed phase materials consisting of crystalline anatase and crystalline TiN can find uses in simultaneous DSSCs and water splitting applications.

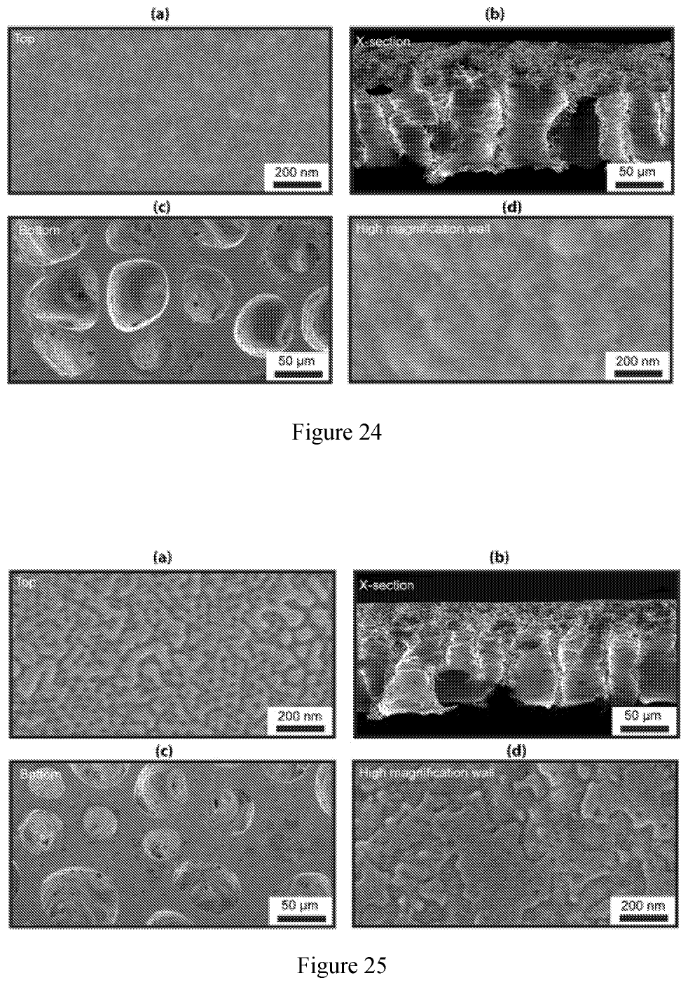

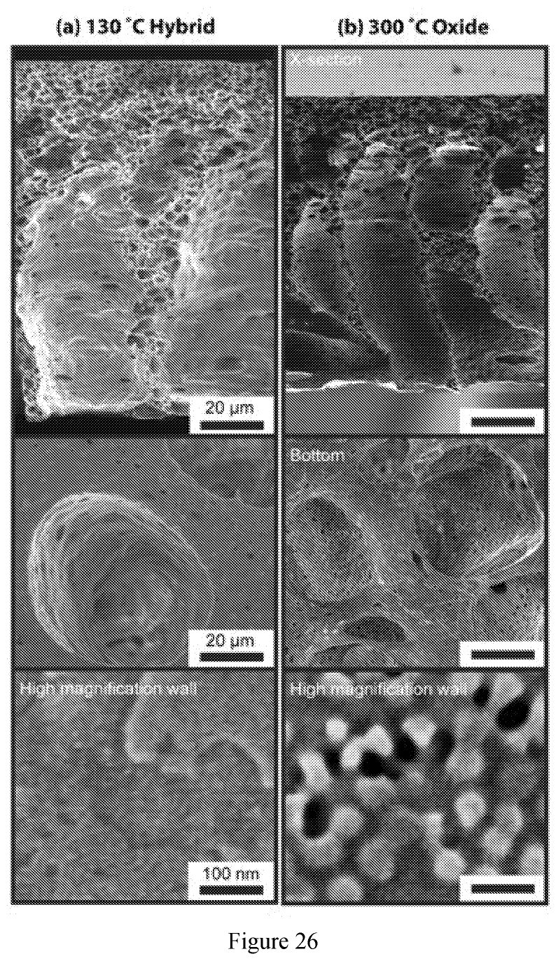

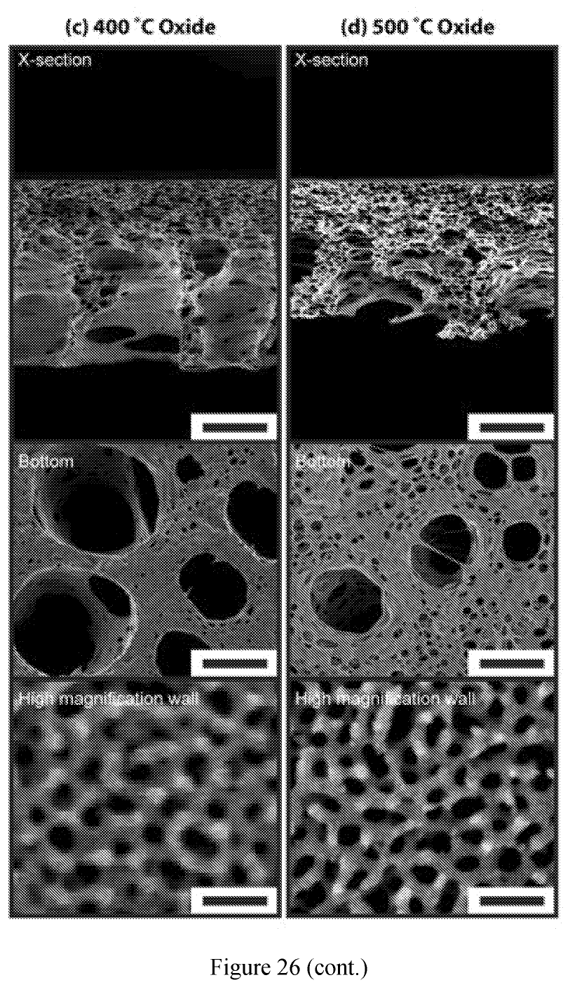

Four pathways were developed that resulted in either single phase nitrides or mixed phase anatase and TiN. In particular, the role of the oxide crystallinity in the final nitride crystallinity was probed. The hybrid precursor membranes in all cases were the same. The as-made ISV+TiO₂ organic/inorganic hybrids (FIG. 24), were dried and then heated to 130° C. (FIG. 25) in a vacuum oven to drive off any residual solvent (DOX, THF) and non-solvent (DI water). The as-made top surface area was closed (FIG. 24a), yet a hexagonal packing becomes evident in the hybrid treated to 130° C. (FIG. 25a). The asymmetric cross-section (FIGS. 25b and 26b) and open macroporous bottom are evident in both hybrids (FIGS. 24c and 25c). The walls of the macropores at these stages are also closed (FIGS. 24d and 25d), a result that is consistent with the closed top surfaces of these hybrids.

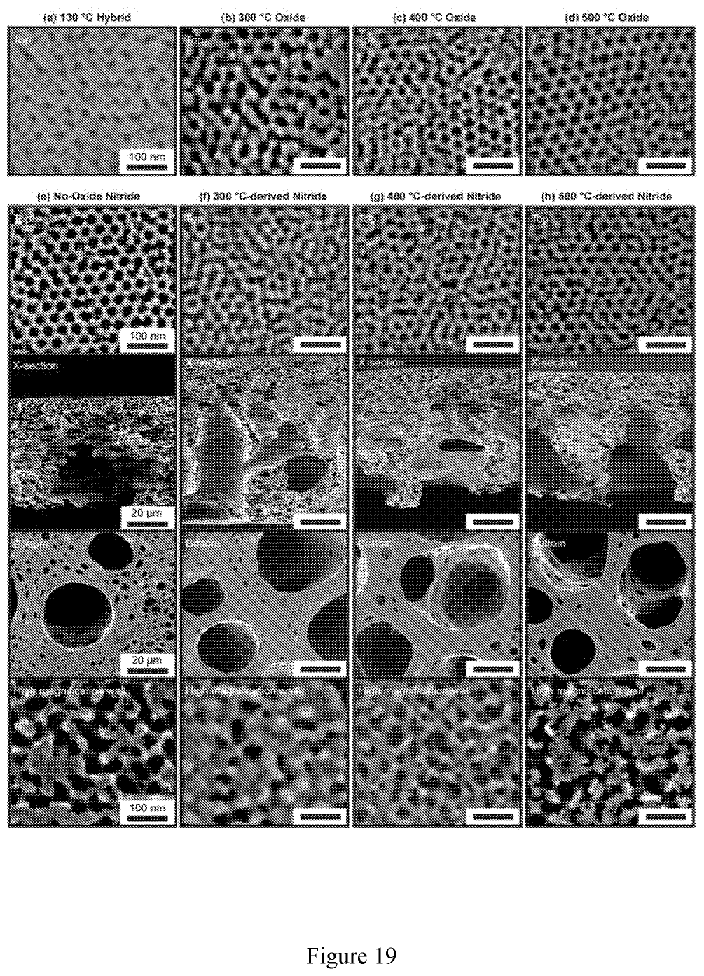

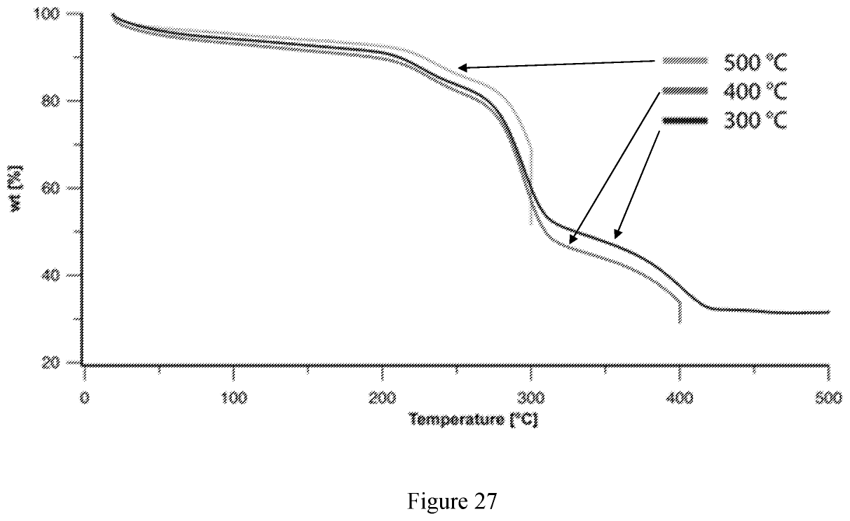

Following heat-treatment to 130° C., the processing pathways were varied. In the first, the ISV+TiO₂ hybrid that was processed to 130° C. was directly heated to the nitride, bypassing the oxide step. In the other three methods, prior to nitriding, the hybrid was treated to either 300° C., 400° C., or 500° C. in air with a dwell time of 3 h before being allowed to cool to room temperature at ambient rate. This resulted in free-standing asymmetric oxides. SEM of the 130° C. hybrid as well as the various oxides is provided in FIG. 19 and FIG. 26. The hybrid treated to 130° C. possesses a mostly closed top surface (FIG. 19a), an asymmetric cross-section, open macroporous bottom, and closed mesoporous walls in the macroporous section (FIG. 26a). When treating the hybrid to 300° C. (FIG. 19b), 400° C. (FIG. 19c), and 500° C. (FIG. 19d), while retaining their asymmetric cross-sections and open bottom surfaces (FIG. 26b-d top and middle row), the material now exhibits an open hexagonally packed top surface (FIG. 19 first and second row). Consistent with the top surface, the walls of the macropores are now mesoporous due to the decomposition of the polymeric material (FIG. 26b-d bottom row). However, it appears that with increasing processing temperature, the mesopore size decreases, possibly due to the increased processing temperature. Additionally, the oxide treated to 300° C. appears to be more closed than the oxides treated to 400° C. and 500° C. One possible hypothesis for this is that there is residual carbon (see FIG. 18 photo of brown, not white material, as well as TGA FIG. 27) that fills the pores of the 300° C. oxide.

The nitriding step for all the materials was the same at 5° C. min⁻¹ to 600° C. with a dwell time of 6 h under flowing ammonia. SEM is provided in FIG. 19e-h. The nitrides retain the porous top surface morphology that was already evident in the oxides. The cross-sections are asymmetric and the bottom surfaces are open with large macropores. While all the walls of the macropores are mesoporous (FIG. 19e-h, bottom row), the nitride derived from the 300° C. oxide has somewhat more closed features. This is possibly a result of the features of the 300° C. oxide and carbon material contained herein.

Even though the SEM images of the various nitrides appear similar, XRD indicates differences resulting from variations in the temperature processing conditions (FIG. 20, Table 5). All materials are derived from 130° C. ISV+TiO₂ hybrids, which are amorphous (FIG. 20, black). When subjecting the 130° C. hybrid directly to ammonia, the material undergoes an amorphous to crystalline transition. The resulting crystalline nitride has peaks consistent with a cubic rocksalt TiN (ICSD entry #00-038-1420) which crystallizes in space group Fm3̅m (#225) with a lattice parameter of 4.21 Å and a coherent scattering domain size, determined from a Debye-Scherrer analysis of x-ray peak widths, of 5.7 nm.

The 300° C. oxide, which possesses some degree of crystallinity, has peaks that are consistent with an anatase phase TiO₂ (ICSD #01-070-7348) which crystallizes in space group I4₁/amd (#141) with lattice parameters around a=b=3.80 Å, c=9.55 Å and a coherent scattering domain size of around 11 nm. When subjected to heat-treatment in ammonia, the material undergoes a crystal-to-crystal transition. The oxide peaks disappear and TiN peaks emerge that are consistent with the cubic rocksalt TiN with a lattice parameter of 4.22 Å and a coherent scattering domain size, determined from a Debye-Scherrer analysis of x-ray peak widths, of 6.1 nm. However, this material, while being a single-phase crystalline material in the end, likely possess some carbon in the final material (vide infra).

The oxide treated to 500° C. in air demonstrates crystallinity and has peaks consistent with anatase TiO₂ with lattice parameters around a=b=3.80 Å, c=9.54 Å and a coherent scattering domain size of around 12 nm. When treated in ammonia, the crystal-to-crystal transition remains incomplete as both peaks consistent with anatase TiO₂ and TiN co-exist. Anatase TiO₂ with lattice parameters around a=b=3.80 Å and c=9.55 Å, and a much larger coherent scattering domain size of around 23 nm is now observed. The remaining peaks are consistent with the cubic rocksalt TiN with a lattice parameter of 4.21 Å and a coherent scattering domain size, determined from a Debye-Scherrer analysis of x-ray peak widths, of 7.4 nm. While this nitride possesses no carbon, as can be inferred from TGA (FIG. 27) of the 130° C. hybrid in air to 500° C., the mixed crystallinity can pose potential issues in applications, e.g., due to the reduced conductivity of the TiN resulting from semiconducting TiO₂.

Therefore, another pathway was developed with the goal of subjecting the materials to sufficiently high temperatures to remove all carbon prior to nitriding, yet to also perform a complete crystal to crystal transition with no crystalline oxide peaks remaining in the final material. At temperatures of 400° C., two results were obtained—sample 1 and 2. In sample 1, a complete crystal-to-crystal transition was observed. The oxide exhibits crystalline peaks consistent with anatase TiO₂ with lattice parameters around a=b=3.80 Å, c=9.54 Å and a coherent scattering domain size of around 14 nm. After heat treatment in ammonia, the derived nitride peaks are consistent with the cubic rocksalt TiN with a lattice parameter of 4.21 Å and a coherent scattering domain size of 7.2 nm. No remaining anatase peaks were observed in this sample. Another sample (sample 2) that was also treated to 400° C. has an oxide with similar crystallinity consistent with an anatase phase and a coherent scattering 10 domain size of around 13.0 nm. Yet after heat treatment in ammonia, the resulting material shows mixed crystal phases of both oxide and nitride. The oxide peaks are consistent with an anatase phase TiO₂ and a much larger coherent scattering domain size of around 19 nm. The remaining peaks are consistent with cubic rocksalt TiN with a lattice parameter of 4.21 Å and a coherent scattering domain size of 6.7 nm. Thus, at a oxide processing temperature of 400° C., one sample was completely transformed to a nitride, while the other retained crystalline oxide. It is hypothesized that this difference might be due to slight variations in the location of the sample in the furnace tube leading to slight variations in processing temperature.

TABLE 5
Summary of XRD results on lattice constants (LC) and x-ray derived
domain sizes (XS) of oxides and nitrides (heat treated to 600° C.).

| | Anatase | Anatase | Anatase XS | Nitride | Nitride XS |
|---|---|---|---|---|---|
| Sample | LC a [Å] | LC c [Å] | [nm] | LC a [Å] | [nm] |
| 500° C.-derived nitride | 3.80 | 9.55 | 23 | 4.21 | 7.4 |
| 500° C. oxide | 3.80 | 9.54 | 12 | — | — |
| 400° C.-derived nitride | 3.80 | 9.56 | 19 | 4.21 | 6.7 |
| sample 2 | | | | | |
| 400° C. oxide sample 2 | 3.80 | 9.54 | 13 | — | — |
| 400° C.-derived nitride | — | — | — | 4.21 | 7.2 |
| sample 1 | | | | | |
| 400° C. oxide sample 1 | 3.80 | 9.54 | 14 | — | — |
| 300° C.-derived nitride | — | — | — | 4.22 | 6.1 |
| 300° C. oxide | 3.80 | 9.55 | 11 | — | — |
| Nitride no oxide | — | — | — | 4.21 | 5.7 |
| 130° C. hybrid | — | — | — | — | — |

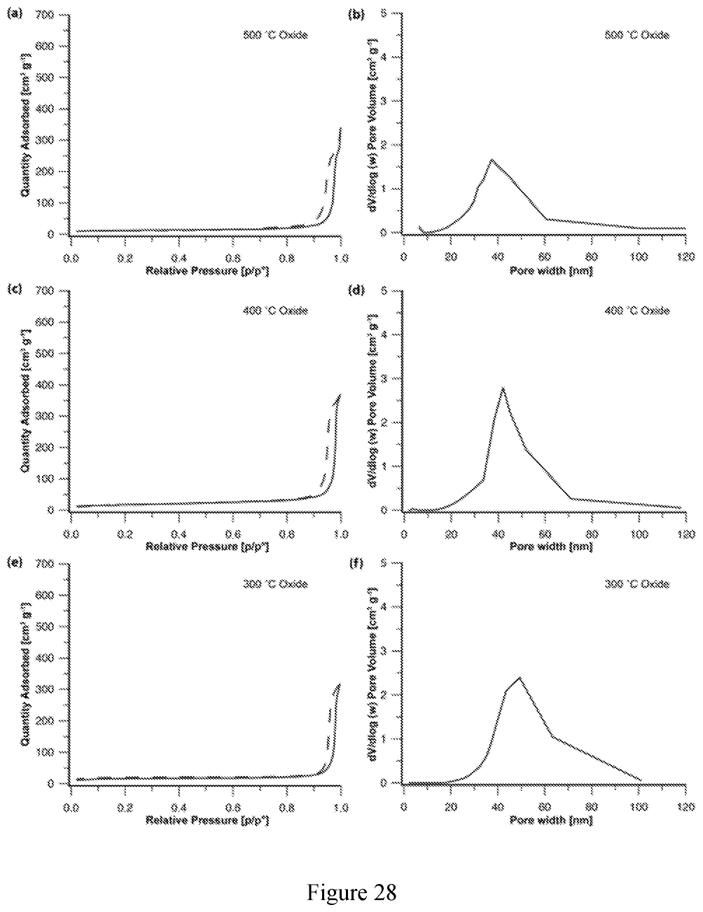

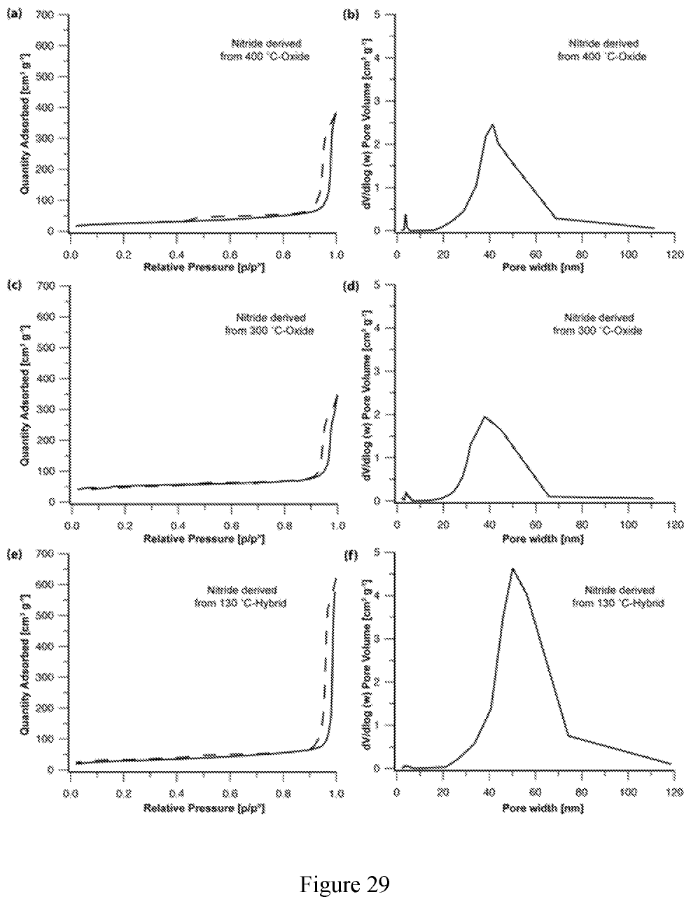

In addition to the XRD results, the porosity and surface area of the materials were characterized via nitrogen sorption. Table 6 summarizes the results, while the corresponding nitrogen sorption isotherms and pore size distribution graphs for the oxides and nitrides are provided in FIGS. 28 and 29, respectively. The 300° C. oxide has a BET surface area of 57±1.7 m² g⁻¹, a micropore area of 26 m² g⁻¹, a peak pore size of 49 nm, a FWHM of 22±9.5 nm, and a single point adsorption pore volume of 0.49 cm³ g⁻¹. The 400° C. oxide has a BET surface area of 60±1.1 m² g⁻¹, a micropore area of 11 m² g⁻¹, a peak pore size of 42 nm, a FWHM of 16±6.8 nm, and a single point adsorption pore volume of 0.57 cm³ g⁻¹. The 500° C. oxide has a BET surface area of 43±4.3 m² g⁻¹, a micropore area of 18 m² g⁻¹, a peak pore size of 37 nm, a FWHM of 19±8.3 nm, and a single point adsorption pore volume of 0.43 cm³ g⁻¹. These values are consistent with literature values reported for mesoporous TiO₂.

When comparing the oxide materials, the pore size decreases with increased processing temperature from 49 nm to 42 nm to 37 nm for the 300° C. 400° C., and 500° C. oxide, respectively. This corresponds to the features seen in SEM (FIG. 26). This decrease in pore size is likely a result of the increased maximum processing temperature.

When comparing the nitrides derived from the 300° C. and 400° C. oxides, as well as the nitride derived from the 130° C. hybrid, there is no apparent surface area correlation to temperature. The nitride derived from the 130° C. hybrid has a BET surface area of 105±6.0 m² g⁻¹, a micropore area of 28 m² g⁻¹, a peak pore size of 50 nm, a FWHM of 18±7.8 nm, and a single point adsorption pore volume of 0.80 cm³ g⁻¹. The 300° C.-derived nitride has a BET surface area of 178±19 m² g⁻¹, a micropore area of 56 m² g⁻¹, a peak pore size of 38 nm, a FWHM of 17±7.1 nm, and a single point adsorption pore volume of 0.54 cm³ g⁻¹. The 400° C.-derived nitride has a BET surface area of 90±3.0 m² g⁻¹, a micropore area of 15 m² g⁻¹, a peak pore size of 41 nm, a FWHM of 17±7.1 nm, and a single point adsorption pore volume of 0.59 cm³ g⁻¹. The difficulty in assigning a trend to the surface area of the nitrides could possibly be due to residual carbon in some of the materials, which contributes to the microporosity and thus surface area. It could be expected that the nitride derived directly from the hybrid would have the largest carbon content and thus microporosity and surface area. Yet its surface area of 105±6.0 m² g⁻¹ is still significantly lower than the surface area of the nitride derived from an oxide that was treated to 300° C., which has a surface area of 178±19 m² g⁻¹. It is hypothesized that this is due to crosslinked networks formed during treatment to 300° C., which are likely less vulnerable to decomposition by ammonia than the 130° C. hybrid-derived nitride that has a lower cross-linking density.

TABLE 6
Summary of nitrogen sorption results of oxides and nitrides.

| | | | | | Single |
|---|---|---|---|---|---|
| | | | | | point |
| | | | | | adsorption |
| | | Micropore | | | pore |
| | BET surface | surface area | Peak pore | FWHM | volume |
| Sample | area [m² g⁻¹] | [m² g⁻¹] | size [nm] | [nm] | [cm³ g⁻¹] |
| 500° C. oxide | 43 ± 4.3 | 18 | 37 | 19 ± 8.3 | 0.43 |
| 400° C.-derived | 90 ± 3.0 | 15 | 41 | 17 ± 7.1 | 0.59 |
| nitride | | | | | |
| 400° C. oxide | 60 ± 1.1 | 11 | 42 | 16 ± 6.8 | 0.57 |
| 300° C.-derived | 178 ± 19 | 56 | 38 | 17 ± 7.1 | 0.54 |
| nitride | | | | | |
| 300° C. oxide | 57 ± 1.7 | 26 | 49 | 22 ± 9.5 | 0.49 |
| Nitride no oxide | 105 ± 6.0 | 28 | 50 | 18 ± 7.8 | 0.80 |

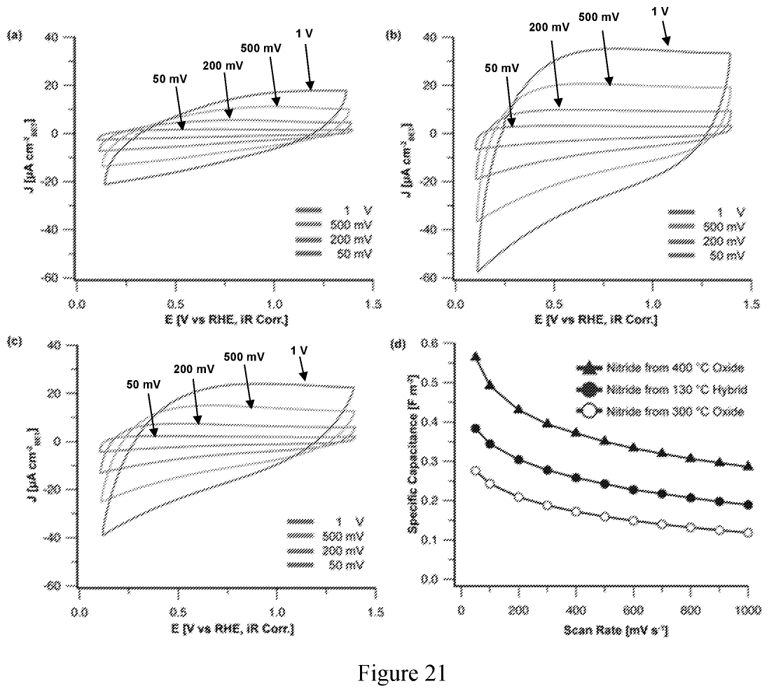

Electrochemistry. It was demonstrated in Example 1 that asymmetric TiN with polymer removal conducted at 400° C. under air led to state-of-the-art power density at moderate energy density when used as a double-layer capacitor electrode. To characterize the effect of the thermal processing parameters on this capacitive performance, cyclic voltammetry (CV) in 0.1 mol L⁻¹ HClO₄ was used with each nitride derived in Example 2 at a series of scan rates between 50 mV s⁻¹ and 1 V s⁻¹ (FIG. 21a-c, 30a-b). The specific and gravimetric integral capacitance were calculated for each material at all scan rates as well as the slow-scan rate capacitance retention when the cycling rate was increased (FIG. 21d, 30c-d). After calculating the specific integral capacitance, we observe that the TiN electrode with polymer removed at 400° C. had the highest specific integral capacitance, while the specific integral capacitance decreased monotonically with increasing surface area at all measured scan rates, i.e., from 400° C.-derived nitride with a BET surface area of 90±3.0 m² g⁻¹ to 130° C.-hybrid-derived nitride with a surface area of 105±6.0 m² g⁻¹ to the nitride derived from the 300° C. oxide with a surface area of 178±19 m² g⁻¹.

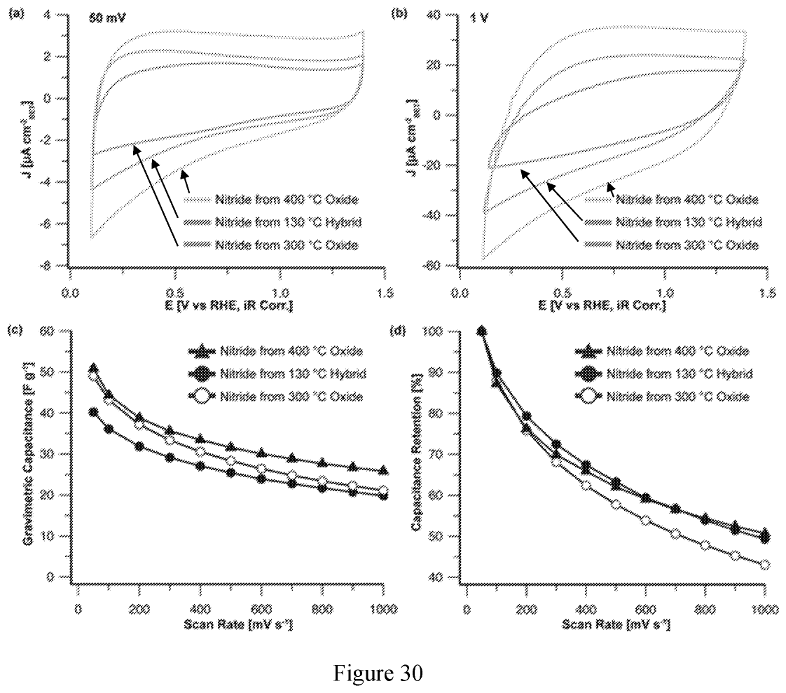

From these results, it is hypothesized that this trend is based on the amount of residual carbon remaining in the samples as described above. While the carbon is accessible to the N₂ molecules used to measure the BET surface area, it is proposed that it does not contribute to the double-layer charging capacitance, either due to poor connectivity to the porous nitride backbone or because the carbon is insufficiently conductive, limiting its ability to charge and discharge during the CV measurements. When the integral capacitance is normalized by the electrode mass, only small differences were observed between the different processing conditions (FIG. 30c), suggesting that the residual carbon is likely the main contributor to the higher surface area observed for the 300° C. and nitride derived from the 130° C. hybrid samples. Additionally, the similar gravimetric integral capacitances for each material suggest that the residual carbon does not substantially improve the capacitive performance. Further, it is noted that the material treated at 300° C., which likely has the highest fraction of residual carbon, has somewhat lower capacitance retention (˜40% vs 50-55% for other samples, FIG. 30b), suggesting that the higher fraction of residual carbon could partially inhibit ion diffusion through the porous nitride network.

TABLE 7
Summary of X-ray diffraction results on lattice constants (LC) and
x-ray derived domain sizes (XS) of oxides.

| Temper- | | | | | | Rutile |
|---|---|---|---|---|---|---|
| ature | Anatase | Anatase | Anatase | Rutile | Rutile | XS |
| [° C.] | LC a [Å] | LC c [Å] | XS [nm] | LC a [Å] | LC c [Å] | [nm] |
| 875 | — | — | — | 4.60 | 2.97 | 43 |
| 825 | 3.79 | 9.53 | 37 | 4.60 | 2.97 | 52 |
| 700 | 3.79 | 9.53 | 26 | — | — | — |
| 500 | 3.79 | 9.52 | 12 | — | — | — |

While generally single-phase materials are desirable, mixed oxide phase materials consisting of both anatase and rutile TiO₂ could find potential applications as photocatalytic materials. By further changing the processing temperature of the 130° C. derived hybrid materials, the oxide structure and crystal phase could be tuned as demonstrated by SEM and XRD (FIG. 22, Table 7). From top to bottom the SEM images in FIG. 23 show the top surface, a cross section, the bottom surface, as well as higher magnification SEM micrographs of the mesoporous walls of the macropores. The as-made hybrid (FIG. 22a) used to make the materials is asymmetric with a mesoporous top surface atop a macroporous support structure. At 500° C., the XRD peaks are consistent with anatase TiO₂ with lattice parameters of a=b=3.79 Å, c=9.52 Å and a coherent scattering domain size of around 12 nm. While the lattice parameters remain similar, in the sample heated to 700° C., the coherent scattering domain size increases to 26 nm. The increased crystal size is also evident from the SEM, in particular when looking at the top surface (FIG. 22c), which is now disordered and depicts pores surrounded by thicker strut sizes.

When processed to even higher temperatures of 825 or 875° C. the asymmetry, macroporosity, and some degree of mesoporosity are retained, although second phase, rutile, develops. This is expected as typically in synthetic titania, the anatase to rutile transition temperature lies between 600 and 700° C. At 825° C. (FIG. 22d) substantial crystal overgrowth is evident. In addition, the crystallinity of the material is now mixed phase with peaks consistent with anatase TiO₂ with lattice parameters of a=b=3.79 Å, c=9.53 Å and a coherent scattering domain size of around 37 nm as well as rutile TiO₂ (ICSD #00-021-1276) phase, which crystallizes in space group P4₂/mnm (#136) with lattice parameters of a=b=4.60 Å, c=2.97 Å and a coherent scattering domain size of around 52 nm. Further crystal overgrowth results at even higher temperature of 875° C. (FIG. 22e). At this temperature, however, only the rutile phase is observed with lattice parameters of a=b=4.60 Å, c=2.97 Å and a coherent scattering domain size of around 43 nm.

Example 2 demonstrated the synthesis of asymmetric and hierarchically porous materials with graded porosity along the film normal by utilizing block copolymer self-assembly to structure-direct inorganic nanoparticles such as sol-gel derived TiO₂ nanoparticles. The co-assembly and non-solvent induced phase separation (CNIPS) and subsequent heat-treatment lead to asymmetric oxides and nitrides with tunable properties. By changing the evaporation time in the CNIPS procedure, various macroscopic cross-sections, from finger-like to sponge-like, could be obtained. In the membrane field, the substructure has an effect on the flux. From this comparison, it is expected that properties like the ion diffusion rate in energy devices is affected by structural variations in these asymmetric materials.

Further, by investigating various heating protocols, the crystallinity, material composition and porosity of the materials could be tuned, both in the oxides as well as the resulting nitrides. By changing the highest processing temperature of the hybrids and oxides in air, the final oxide crystallinity could be controlled from anatase to rutile and mixed phases in between. By changing the highest processing temperature of the hybrid or oxide materials in ammonia atmosphere, the crystallinity of the nitride could be tuned with controllable retention of the oxide crystal phase. The effect of the processing conditions on the use of asymmetric TiN as a double-layer capacitor electrode was probed and it was found that crystallinity and material composition play an important role on performance. Tuning synthetic parameters can make these materials viable for a range of applications, particularly in electrochemical energy and storage. Further, by understanding the formation mechanisms, the co-assembly process is expected to be expanded to include other materials such as catalytically active materials.

Abbreviations. BCP (block copolymer), CGM (Cornell Graded Materials), CNIPS (co-assembly and non-solvent induced phase separation), SNIPS (self-assembly and non-solvent induced phase separation)

### Example 3

This example provides a description of asymmetrical porous films of the present disclosure. Also provided are methods of making and uses of the asymmetrical porous films.

Asymmetric porous inorganic materials provide increased accessibility and flux, making them attractive for applications in energy conversion and storage, separations, and catalysis. Non-equilibrium based block copolymer directed self-assembly approaches provide a route to obtaining such materials. Described is a one-pot synthesis using the co-assembly and non-solvent induced phase separation (CNIPS) of poly(isoprene)-b-poly(styrene)-b-poly(4-vinylpyridine) (ISV) triblock terpolymer and phenol formaldehyde resols. After heat-treatment, asymmetric porous carbon materials result with a mesoporous top surface atop a porous support with graded porosity along the film normal and mesopores throughout the material. For example, the walls of the macroporous support are also mesoporous providing a structural hierarchy in addition to the asymmetric structure. Using a combination of ex-situ transmission small angle x-ray scattering (SAXS) of the membrane dope solutions, in-situ grazing incidence SAXS (GISAXS) after dope solution blading and during solvent evaporation, and scanning electron microscopy (SEM) of the final membrane structures, we demonstrate how successfully navigating the pathway complexity associated with the non-equilibrium approach of CNIPS enables switching from disordered to ordered top surfaces in the as-made organic-organic hybrids and resulting carbon materials after thermal treatments. It is expected that the final asymmetric porous carbon materials with hierarchical porosity in the substructure are of interest for a number of applications, including batteries, fuel cells, capacitors, and as catalyst supports.

This example describes in-depth investigations into the early formation stages of CNIPS derived porous carbon materials from the ISV+resols system in order to generate a deeper understanding of the processes and parameters controlling periodic pore order in the top surfaces of these asymmetric membranes. It is demonstrated, that such fundamental understanding of the early formation stages enables generation of as-made hybrid materials, as well as resulting asymmetric carbon membranes with highly ordered top surface pores. These results are expected to benefit the transfer of scalable SNIPS/CNIPS type membrane formation processes to a host of other inorganic materials thereby opening up pathways for new applications not accessible for purely polymer-organic hybrid membrane materials.

Experimental section. Materials Synthesis/Preparation. Materials. Materials were used as received except as otherwise indicated. Anhydrous (99.9%) grades of tetrahydrofuran (THF) and 1,4-dioxane (DOX) were purchased from Sigma-Aldrich. Deionized (DI) water with a resistivity of 18.2 MΩcm was used as the nonsolvent precipitation bath. The following chemicals were used for the synthesis of phenol formaldehyde resols: Phenol (Sigma-Aldrich, purified by redistillation, ≥99%), formalin solution (Sigma-Aldrich, ACS reagent, 37 wt % in water, containing 10-15% methanol as stabilizer to prevent polymerization), sodium hydroxide (Sigma-Aldrich, reagent grade, ≥98% pellets anhydrous), para-toluene sulfonic acid monohydrate (Sigma-Aldrich, ACS reagent, ≥98.5%), deionized (DI) water with a resistivity of 18.2 MΩcm.

Polymer Synthesis and Characterization. The poly(isoprene)-b-poly(styrene)-b-poly(4-vinylpyridine) (ISV) triblock terpolymer used in this example was synthesized via sequential living anionic polymerization as previously reported. The polymer had a molar mass of 95 kg mol⁻¹ with 29 vol % poly(isoprene) (PI), 57 vol % poly(styrene) (PS), 14 vol % poly(4-vinylpyridine) (P4VP) and a dispersity (Ð) of 1.2. A Varian INOVA 400 MHz ¹H solution nuclear magnetic resonance (¹H NMR) spectrometer was used to determine the block fractions of each block using chloroform-d₆ as solvent (D, 99.8%, Cambridge Isotope Laboratories). A Waters ambient-temperature gel permeation chromatograph (GPC) equipped with a Waters 410 differential refractive index (RI) detector (flow-rate 1 mL min⁻¹) was used to analyze the ISV dispersity (Ð) using polystyrene standards for dispersity (Ð) determination. Tetrahydrofuran (THF) was used as the solvent. Overall ISV molar mass was obtained using the molar mass of the PI block (determined with GPC using PI standards) combined with the NMR results of the molar ratios of the different blocks.

Solution Preparation. ISV solutions were prepared by dissolving ISV at various concentrations in a solvent mixture of DOX:THF (7:3 by weight) and stirred to obtain homogeneous solutions. Oligomeric phenol formaldehyde resols with a molar mass of less than 500 g mol⁻¹ were synthesized using a procedure described elsewhere. A stock solution of 25 wt % resols in DOX, as well as a stock solution of 25 wt % resols in THE were prepared and combined in a 7:3 weight ratio to obtain a 25 wt % resols solution in DOX:THF (7:3 by weight). In the so-called “simultaneous method”, appropriate amounts of ISV powder and resols stock solution were combined to achieve the desired ISV/resols ratios (typically 2:1 by weight) and DOX:THF (7:3 by weight) was immediately added before dissolution of the ISV to reach the desired polymer concentrations. In the so-called “consecutive method”, ISV was first dissolved in DOX:THF (7:3 by weight) to obtain a homogeneous solution, to which the resols stock solution was added thereafter to obtain the targeted ISV/resols weight ratio (typically 2:1). All solution concentrations used for ISV+resols refer to the ISV plus resols overall weight ratio in 7:3 DOX:THF.

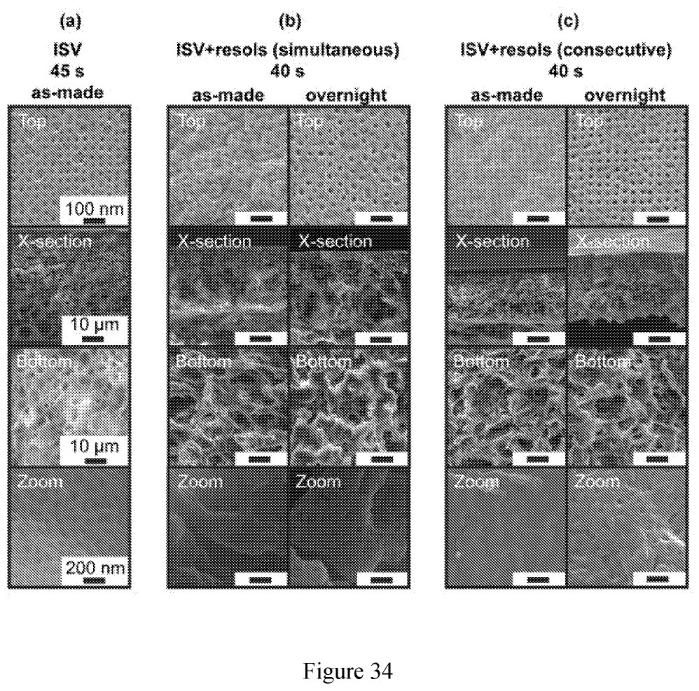

Membrane Casting. Self-assembly/Co-assembly and non-solvent induced phase separation (S/CNIPS) was used to prepare the membranes. As described in the results and discussion section, two substrate temperatures (room temperature, RT, or 30° C.) and humidity environments (<28% or ˜70%) were used. However, the general process remained the same. The casting solution was pipetted onto a glass substrate, a thin film was cast with a doctor blade using a gate height (height between the substrate and casting blade) between 203 and 229 μm. After various evaporation times, the films were plunged into a non-solvent DI water bath to allow for precipitation (usually for 30 s). In the case of overnight stirring (e.g., see FIG. 34), membranes were stirred in DI water overnight allowing for the dissolution of resols out of the membranes, effectively resulting in ISV membranes (with negligible amounts of resols).

Temperature Processing. The membranes were dried and heated in a convection oven to crosslink the resols at a temperature of 130° C. for about 24 h. This step was followed by a heat-treatment step in a flow furnace using nitrogen as the flow gas. The temperature profile for this carbonizing step was 1° C. min⁻¹ to 600° C. The temperature was held at 600° C. for 3 h before being further ramped at 5° C. min⁻¹ to 900° C. The furnace was then kept at 900° C. for 3 h before being allowed to cool back to room temperature at ambient rate.

Materials Characterization. Small-Angle X-ray Scattering (SAXS) of solutions. Transmission SAXS measurements were performed at the G1 station of the Cornell High Energy Synchrotron Source (CHESS) with a typical beam energy of 9.8 keV and a sample-to-detector distance of about 2 m. The precise sample-detector distance was determined for each configuration using silver behenate. Samples were loaded in 0.9 mm glass capillaries (Charles Supper Co.), flame-sealed, and sealed with epoxy as a secondary seal. Two-dimensional scattering patterns were collected on either a Dectris Pilatus3 300 k or a Dectris Eiger 1M pixel array detector. Patterns were azimuthally integrated and plotted using the Nika and Irena software packages for Igor Pro. The scattering vector q is defined as q=(4π/k)sin θ, where θ is half of the scattering angle. Reported lattice parameters were determined by fitting the primary peak with a gaussian function and converting the position to a lattice parameter assuming the indicated lattice. For the body centered cubic (BCC) lattice, the lattice parameter, a, was determined by: a=2√2π/q*.

In-Situ Grazing-Incidence Small-Angle X-ray Scattering (GISAXS). In-situ GISAXS experiments were performed at the D1 station of the Cornell High Energy Synchrotron Source (CHESS) using a previously described custom-built doctor blade setup using a known experimental setup. Solutions were cast by an automated doctor blade spreading the polymer solution across a glass substrate at 7500 μm s⁻¹. Gate heights (coating gap between the substrate and the blade) of 203 or 229 μm were used. In-situ GISAXS data was collected almost immediately after casting using a Pilatus 200 k detector and exposure times of one second at three or 5 s intervals, between which the shutter was closed to limit radiation exposure of the sample. Representative selected intervals are shown in the figures. Incident angles of 0.12° to 0.15° were used, slightly below the critical angle of the glass substrate. GISAXS patterns are plotted against the scattering vector magnitude, q, with q=4π sin θ/κ, where θ is half of the total scattering angle and k is the x-ray wavelength (1.16 Å or 1.17 Å). The software that was used to both plot the data and index the patterns to determine the lattice parameter is called indexGIXS. In order to obtain lattice parameters, a, of cubic lattices from the positions of the primary peak, q*, the following equations were employed: simple cubic (SC) lattice: a=2π/q*; for a BCC lattice: a=2√2π/q*.

SEM Analysis. Scanning electron microscopy (SEM) micrographs were obtained using either a TESCAN MIRA3 FE-SEM using an in-lens detector and an accelerating voltage of 5-15 kV, or a ZEISS Gemini 500 Scanning Electron Microscope (SEM) and voltage of 2 kV. The as-made and post-130° C. treated samples were coated with gold-palladium prior to imaging. SEM images were brightness/contrast adjusted. Pore-to-pore distances were calculated by fast Fourier transform (FFT) analysis of the SEM micrographs (using the raw data, i.e., without post-SEM brightness/contrast adjustment) followed by radial integration using ImageJ with the Radial Profile plugin (Philippe Carl).

Thermogravimetric Analysis. Analysis was conducted on a TA Instruments Q500 thermogravimetric analyzer (TGA) under nitrogen flow. The temperature was ramped from room temperature at 1° C. min⁻¹ to 600° C., holding isothermally at 600° C. for 3 h and then further ramping up at 5° C. min⁻¹ to 900° C. The furnace was then held at 900° C. for 3 h before being allowed to cool back to room temperature at ambient rate.

Nitrogen Sorption. Nitrogen adsorption-desorption isotherms of the porous carbon materials were recorded using a Micromeritics® ASAP 2020 surface area and porosity analyzer at −196° C. The specific surface areas were determined following the Brunauer-Emmett-Teller (BET) method. Barrett-Joyner-Halenda (BJH) analysis was used to determine the pore size distributions.

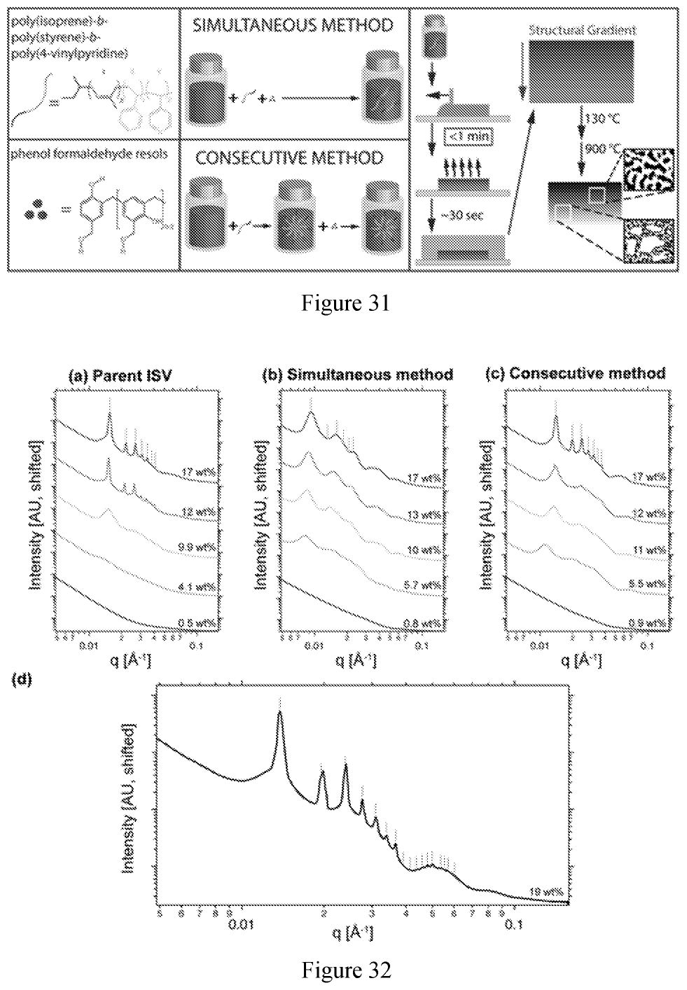

Results and discussion. Graded meso- and macro-porous carbon materials, referred to in the following as CGM-Cs, were obtained from a non-equilibrium type process using the combination of co-assembly and nonsolvent-induced phase separation (CNIPS) of triblock terpolymer poly(isoprene)-block-poly(styrene)-block-poly(4-vinylpyridine) (ISV) with phenol formaldehyde resols and a subsequent series of heat-treatments (FIG. 31). Triblock terpolymer ISV employed here was synthesized via previously know sequential anionic polymerization. The polymer had a molar mass of 95 kg mol⁻¹ with 29 vol % poly(isoprene) (PI), 57 vol % poly(styrene) (PS), 14 vol % poly(4-vinylpyridine) (P4VP) and a dispersity (Ð) of 1.2. Phenol formaldehyde resols (resols) with a molar mass of less than 500 g mol-1 were synthesized as described previously and used as thermally cross-linkable carbon precursor materials.

The CNIPS process and heat-treatment (FIG. 31, right side) for preparing CGM-C materials followed previously reported protocols. Typically a 2:1 ratio by weight of ISV and resols in a 7:3 ratio by weight of DOX:THF were prepared into co-assembled solutions. After stirring, the homogeneous solutions were cast onto glass slides using a doctor blade and allowed to evaporate for a specific amount of time. This introduced a concentration gradient along the film-normal direction. Hereafter, the films were plunged into a nonsolvent, i.e., deionized (DI) water bath. The membranes were only immersed in the water for short periods of time (˜30 s) to avoid dissolution of the hydrophilic resols in water. This concluded the CNIPS part of the process. The ISV+resols hybrid membranes were then subjected to a series of heat-treatments. They were first dried and subsequently cured at 130° C. to induce cross-linking of the resols. Cross-linking is essential to provide a stable structure for the subsequent carbonization step at 900° C.

Two different methods were employed for making the casting solutions (FIG. 31, middle). In the “simultaneous method”, stock solutions of 25 wt % resols in 7:3 DOX:THF were made and combined with ISV powder (2:1 ISV:resols by weight) without prior dissolution of the ISV. DOX and THE were added thereafter (7:3 DOX:THF) to dissolve the ISV and mix with the resols. In the “consecutive method”, ISV was first dissolved in 7:3 DOX:THF. After complete dissolution, the 25 wt % resols solution was added. In both the consecutive and simultaneous method, ISV terpolymer and carbon precursor were dissolved at a 2:1 ratio (by weight) in a 7:3 (by weight) DOX:THF solution, while solution concentrations were kept comparable (vide supra). It is important to note that the overall sample processing following solution preparation for both the consecutive method and simultaneous method was kept the same—in order to ensure a direct comparison between both methods. Any differences in structural characteristics of the resulting membranes therefore could be traced back to the differences in the preparation of the casting solutions.

Small-Angle X-Ray Scattering (SAXS) of Solutions. FIG. 32 compares selected small-angle x-ray scattering (SAXS) results of the different quiescent casting solutions employing the simultaneous (FIG. 32b) and consecutive (FIG. 32c) solution preparation methods with those of parent ISV (no additives, FIG. 32a) in order to investigate the effects of resols additives as well as sample preparation method on order and structure as a function of solution concentration (marked for each trace). For pure ISV (FIG. 32a), results for solutions ranging from 0.5 wt % to 17 wt % ISV in 7:3 DOX:THF are exhibited. While at the lowest concentration no particular structure is evident, a correlation peak first emerging at 4.1 wt % suggests onset of micelle formation without ordered packing. Beyond 10 wt % a clear lattice is evidenced by well-defined higher order peaks consistent with a body-centered cubic (BCC) lattice with a lattice parameter of 57 nm at 17 wt %, consistent with previously reported results.

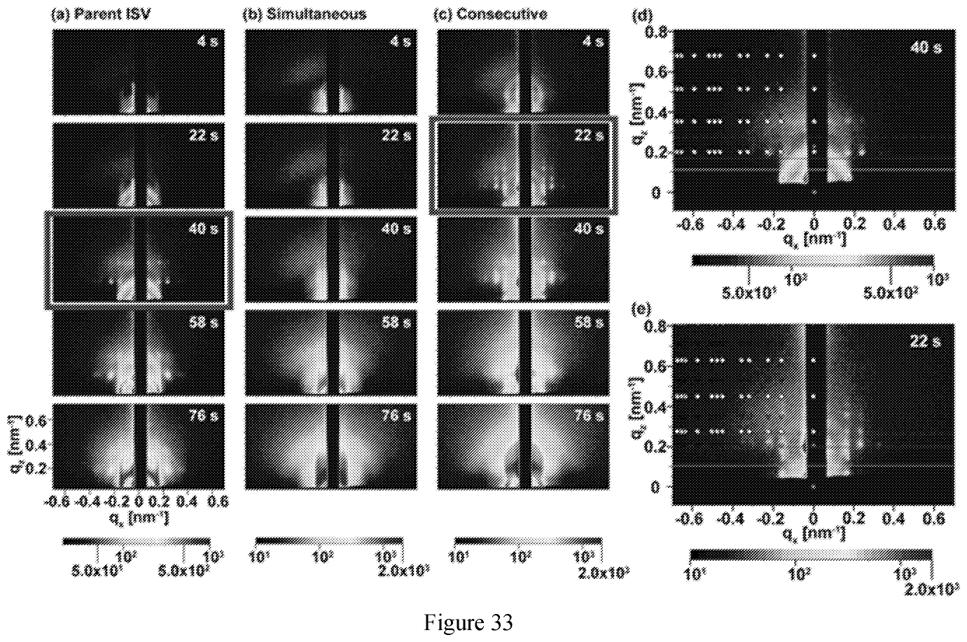

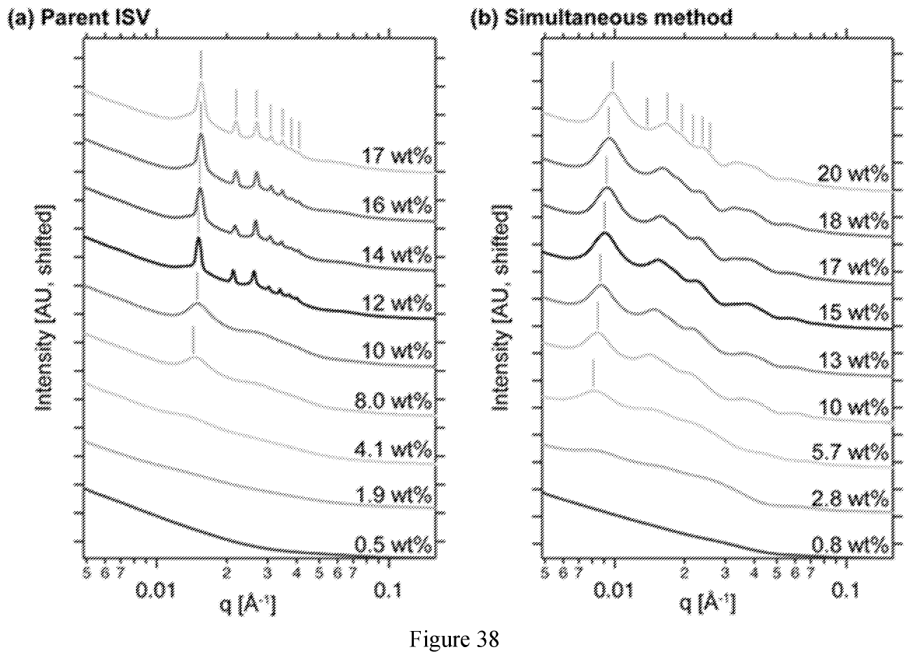

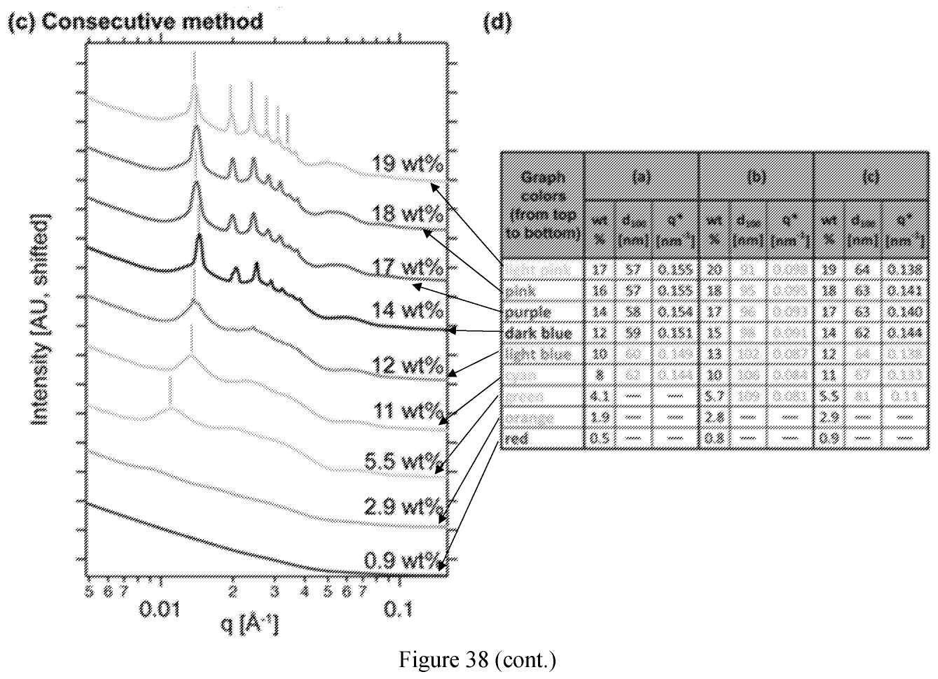

SAXS patterns of ISV+resols solutions prepared via the simultaneous method (FIG. 32b) and ranging in concentration from 0.8 wt % to 17 wt % (ISV+resols at 2:1 ISV:resols weight ratio) show a similar evolution but with two major differences: First, peaks are shifted to smaller q values, suggesting larger characteristic structures consistent with resols swelling the system. Second, no specific lattice could be associated with the relatively broad first and higher order reflexes, even at the highest concentrations studied (see also FIG. 38). Interestingly, both of these effects are reverted when the consecutive method is used for sample preparation (FIG. 33c). At 17 wt % SAXS data again suggest a BCC lattice with a lattice parameter of 63 nm, i.e., only slightly larger as compared to the pure ISV system at the same overall concentration. FIG. 33d provides the scattering pattern of a 19 wt % ISV+resols solution prepared by this method exhibiting 13 higher order peaks and consistent with a BCC lattice with a spacing of 64 nm. To the best of our knowledge this is the largest number of higher order reflexes observed for a ISV based micellar lattice in 7:3 DOX:THF. The individual BCC lattice reflexes sit on top of oscillations that presumably are due to the form factor of the micelles.

It is hypothesized that in the simultaneous case, the addition of resols prior to dissolution of the ISV hinders the ISV polymer from forming homogeneous micelles and therefore from forming well-ordered micellar BCC lattices in solution. In the meantime, it was determined from independent studies (data not shown) that the P4VP block rather than the PI block of ISV in 7:3 DOX:THF forms the micelle core. The reason why the presence of resols hinders highly ordered micelle lattice formation might be that they hydrogen bond to the P4VP blocks upon dissolution early on, thereby locking the system into large structures that cannot equilibrate into well-defined micellar lattices. In contrast, in the consecutive case, ISV polymer micelles are allowed to form first, before addition of the resols, therefore allowing for cubic micelle lattice formation with only slightly larger lattice spacings as for the parent ISV terpolymer presumably due to swelling of the P4VP micelle cores by the resols.

FIG. 38 shows SAXS patterns of the full concentration series studied (including points between those in FIG. 32) as well as a table of concentration versus lattice spacings based on the first order peak position and assuming a BCC lattice in all cases. The onset of cubic ordering in the parent ISV case (FIG. 38a) occurs at comparable overall concentration (˜12 wt %) as in the ISV+resols consecutive case (FIG. 38c). This means that in the ISV+resols case ordering occurs at a lower ISV concentration-so less polymer is needed to obtain cubic order in solution with a similar lattice parameter. This is again consistent with swelling of the micelle cores with resols, which after mixing into the existing BCP micelle solutions may simply diffuse into the existing P4VP cores and expand their size.

In-Situ Grazing-Incidence Small-Angle X-Ray Scattering (GISAXS). To elucidate the behavior of this pathway-dependent system during evaporation, in-situ grazing-incidence small-angle x-ray scattering (GISAXS) during blade-coating and evaporation was performed. Details are provided herein. In short, films were cast with a doctor blade and the subsequent evaporation process monitored in-situ at various times using GISAXS. During successful S/CNIPS based membrane formation, this evaporation process leads to long range BCP micelle ordering as evidenced by Bragg reflection spots in the GISAXS patterns in a layer formed atop a disordered substructure.

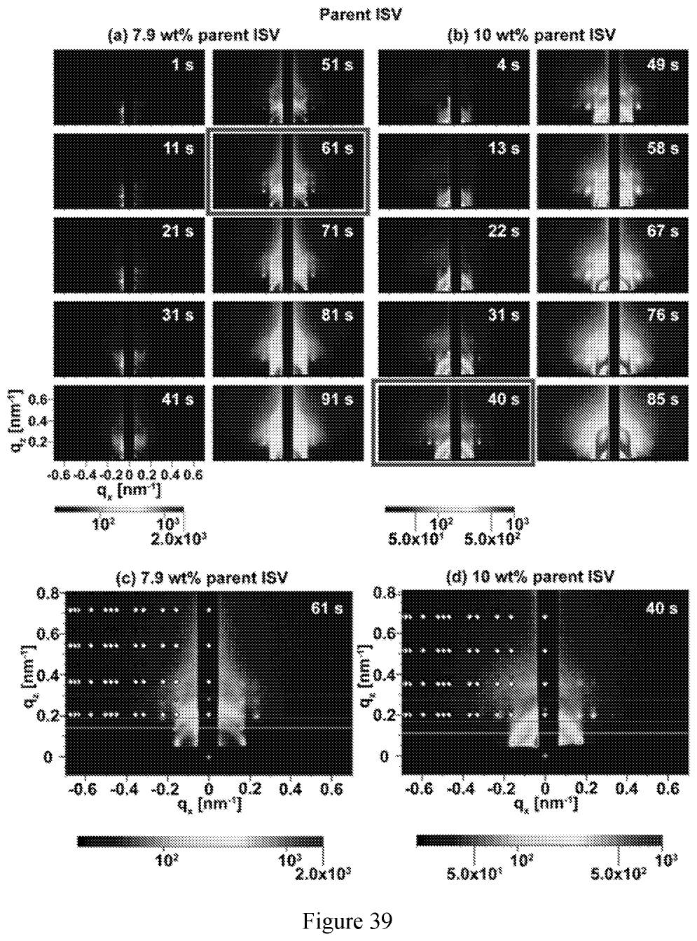

FIG. 33a-c shows representative time dependent in situ GISAXS pattern sequences for all three scenarios tested, i.e., for parent ISV terpolymer (a), as well as for ISV+resols (2:1 ISV:resols weight ratio) systems prepared either with the simultaneous (b) or consecutive (c) methods. FIGS. 39 to 42 summarize all data sets collected together with specific indexed patterns. FIG. 33a shows in situ GISAXS patterns of a film cast from a 10 wt % solution of parent ISV terpolymer and collected at different solvent evaporation times ranging from 4 s to 76 s. The film started out disordered, with very faint scattering rings evident at the earliest time point (4 s evaporation time). These scattering rings become more prominent at 22 s. The half-ring (lower ring) at smaller q is caused by transmission scattering, while the upper full ring is associated with reflection scattering. Discrete Bragg reflection spots first emerge at an evaporation time of 40 s. This marks the transition from a disordered to a highly ordered state with long-range order. As time progresses, the Bragg spots become more intense, but on the time scale shown up to about 80 s never disappear.

TABLE 9
Summary of in situ GISAXS pattern analysis for different solution
concentrations indicating suggested BCP film surface lattices and
corresponding lattice spacings.

| Polymer | System | Obs. ordered | Lattice spacing | Exp. |
|---|---|---|---|---|
| system | wt % | structure | [nm] | q* [nm⁻¹] |
| ISV | 7.9 | SC | 39.5 | 0.159 |
| ISV | 10 | SC | 38.0 | 0.165 |
| ISV + resols | 8.0, 10, | — | — | — |
| (simultaneous) | 12, 15 | | | |
| ISV + resols | 8.0 | SC | 40.5 | 0.155 |
| (consecutive) | | | | |
| ISV + resols | 10 | SC | 39.5 | 0.159 |
| (consecutive) | | | | |
| ISV + resols | 13 | SC | 39.5 | 0.159 |
| (consecutive) | | | | |
| ISV + resols | 15 | BCC | 58.0 | 0.153 |
| (consecutive) | | | | |

In contrast, time dependent in-situ GISAXS patterns over the same time interval resulting from the evaporation of a film cast from a 10 wt % ISV+resols solution (2:1 ISV:resols weight ratio) prepared via the simultaneous route do not exhibit well defined reflection spots, suggesting disordered micelle structures at all times studied (FIG. 33b). Finally, the time dependent progression of in situ GISAXS patterns resulting from a film that was cast from a 10 wt % ISV+resols solution (2:1 ISV:resols weight ratio) prepared via the consecutive method shown in FIG. 33c is again more similar to that of the parent ISV polymer, except that well-defined reflections signaling long-range order appear earlier, here around 22 s rather than 40 s, and are getting washed out at the longest time points shown around 80 s.

In-situ GISAXS patterns at 40 s for series (a) and 22 s for series (c) were simulated using indexGIXS. The indexed patterns are shown in FIGS. 33d and 33e, respectively. The circles and triangles indicate expected peak positions for simple cubic (SC) lattices for the directly scattered and reflected beams, respectively. The sample horizon is indicated by the line, while the polymer critical angle and substrate critical angle are indicated by the solid and dashed red lines, respectively. The region between the polymer and substrate critical angles is called the Yoneda band. Patterns in FIGS. 33d and 33e for 10 wt % solutions of pure ISV at 40 s and ISV+resols prepared via the simultaneous method at 22 s were both indexed to an SC lattice with the (001) plane in the in-plane direction relative to the film surface, and lattice parameters of 38 nm and 39.5 nm, respectively.

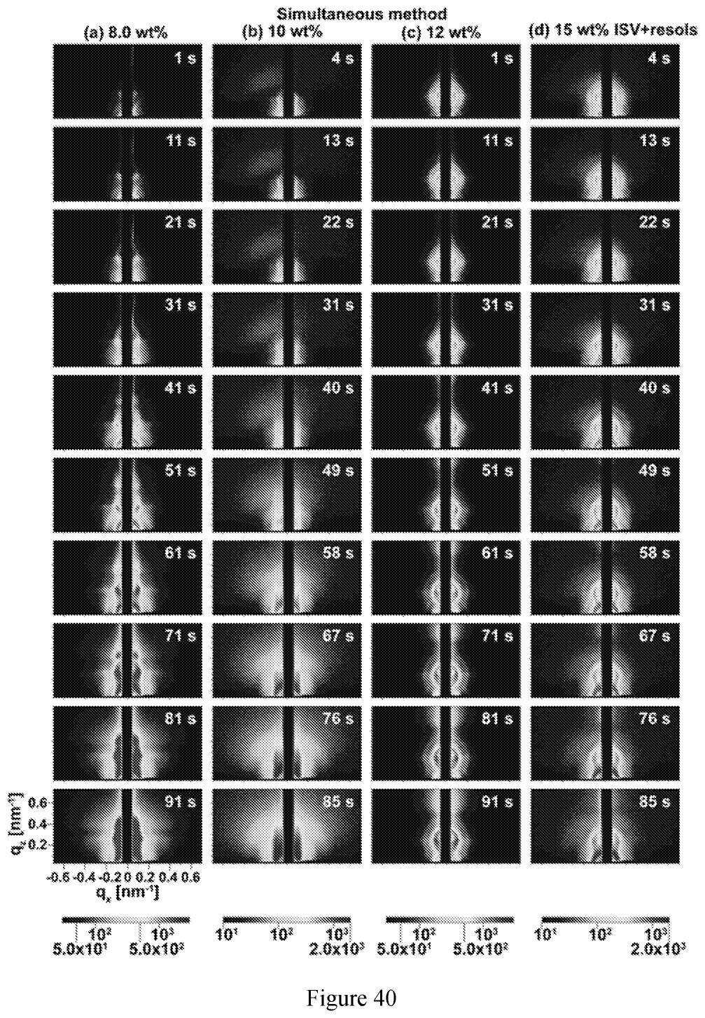

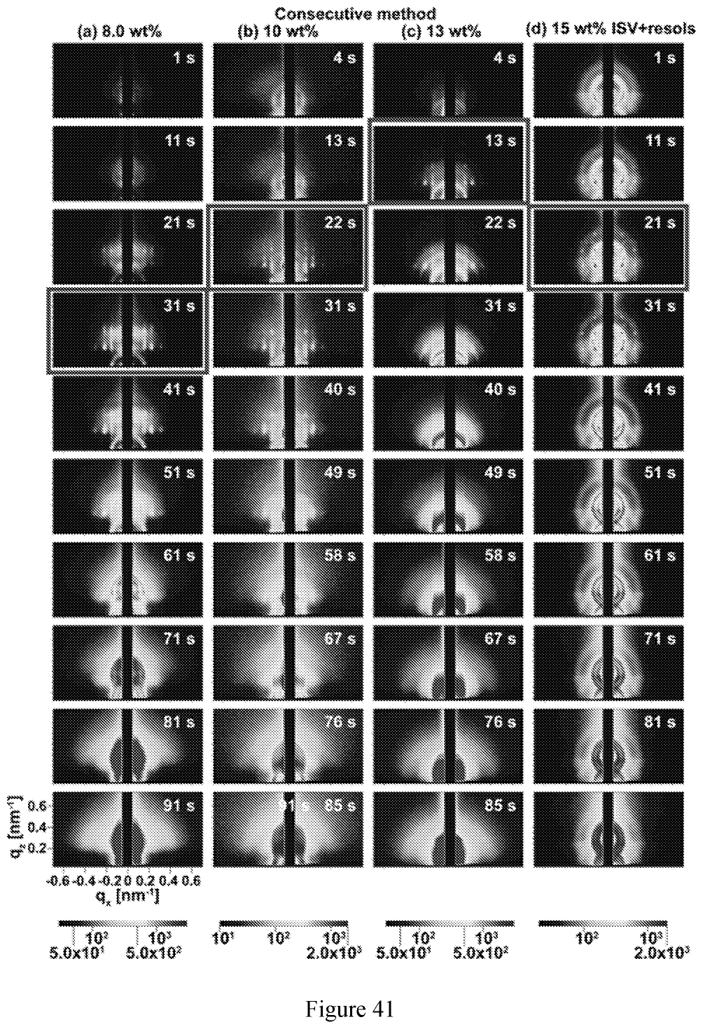

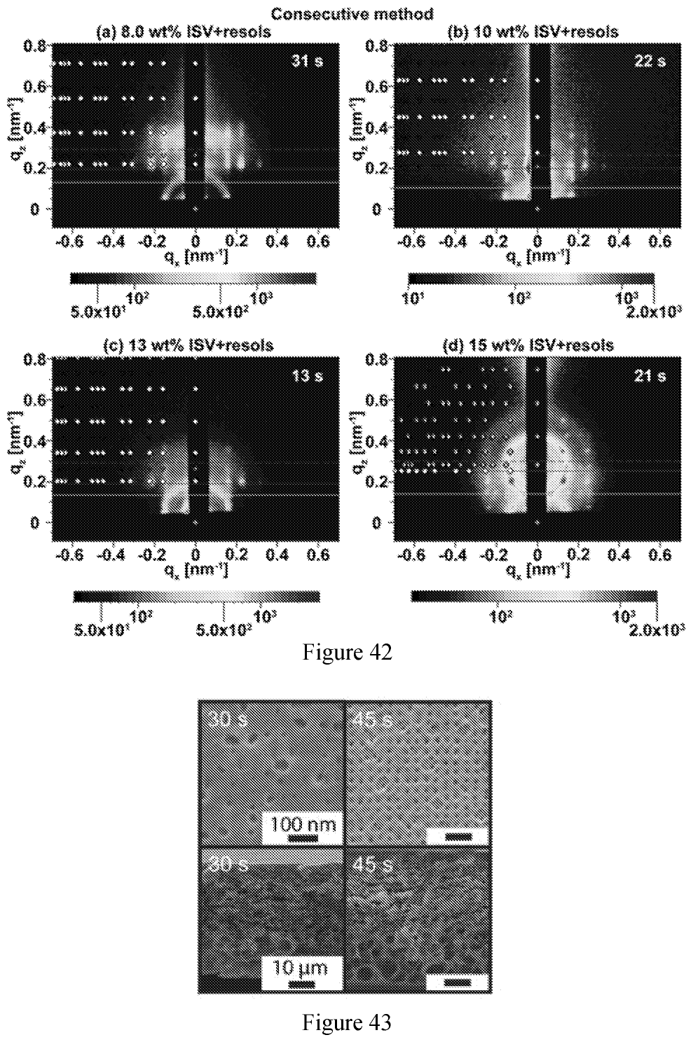

Table 9 summarizes all the quantitative in-situ GISAXS analysis results with additional data sets and indexing results at varying concentrations provided in FIGS. 39 to 42. In the pure ISV case, SC lattices with lattice parameters of 39.5 nm and 38 nm emerged for the 7.9 wt % (FIG. 39a) and 10 wt % ISV solutions (FIGS. 33a and 39b) in 7:3 DOX:THF, respectively. For ISV+resols solutions prepared via the simultaneous method, no pattern could be ascribed to any particular lattice with long-range order (FIGS. 33b and 40). Instead, disordered structures dominated the behavior as evidenced by the formation of scattering rings (FIGS. 40c and 41d). For the consecutive case, however, all tested concentrations resulted in patterns that could be indexed to a particular lattice with long-range order (FIG. 41). At lower concentrations of 8.0 wt %, 10 wt %, and 13 wt % (FIGS. 41a-c), GISAXS patterns at 31 s, 22 s, and 13 s evaporation time were consistent with SC lattices with the (001) plane parallel to the surface and lattice parameters of 40.5 nm, 39.5 nm, 39.5 nm, respectively, while at the highest concentration tested of 15 wt % (FIG. 41d), the GISAXS pattern at the 21 s time-point was consistent with a BCC lattice with the (110) plane parallel to the film surface and a lattice parameter of 58 nm (FIG. 42). This latter high concentration case was the sole example of BCC ordering in the membrane top surface layer consistent with ordering that was found for quiescent solutions at higher concentrations (FIG. 32c).

These in-situ GISAXS results obtained for our 95 kg mol⁻¹ ISV terpolymer based studies are consistent with those known in the art for pure ISV cast films with varying molar mass and similar terpolymer composition and corroborate the overall picture that order in the top surface layer of these membranes evolves from disorder to BCC and then to SC lattices, the former consistent with solution structures at higher concentrations as observed with SAXS studies (see FIG. 32) and the latter being consistent with the pore structure of the final ISV membranes (vide infra). For a 91 kg mol⁻¹ ISV terpolymer earlier studies observed an SC lattice at a lower ISV concentration of 10 wt %, while solution SAXS at higher concentration of 16 wt % confirmed a BCC lattice. Furthermore, for a smaller, 43 kg mol-1 ISV terpolymer at 16 wt % a transition from a BCC to a SC lattice was observed, with both lattices having the same lattice orientation relative to the substrate as found in the current study. Consistent with the interpretation of results in this earlier investigation, we infer that the highest ISV+resols concentration of 15 wt % studied here for the consecutive method generates samples of sufficiently high viscosity to prevent the final BCC to SC transition-thereby trapping the system in the BCC order state.

From these results on the early membrane formation stages upon solvent evaporation after (doctor) blading, the addition of resols to ISV does not seem to substantially perturb the structure formation process if, and only if, the resols are added to the terpolymer using the consecutive method. In contrast, as is revealed by these in-situ GISAXS studies as well as the quiescent solution SAXS studies (FIG. 23), adding ISV and resols simultaneously to the 7:3 DOX:THF solvent mixture does prevent well-defined lattice formation.

Qualitatively, comparing in-situ GISAXS with transmission solution SAXS results (i.e., compare FIG. 32a-c with FIG. 33a-c), it is apparent that while parent ISV as well as consecutive method derived ISV+resols solutions and films exhibit highly ordered (cubic) lattices, simultaneous method derived samples do not. For a more quantitative comparison of solution SAXS with in situ GISAXS results, in particular for the consecutive method of interest here, the GISAXS pattern obtained from the 15 wt % ISV+resols solution after 21 s of evaporation (FIG. 42d) and indexed to a BCC lattice with a lattice parameter of 58 nm can be directly compared to the corresponding solution SAXS results for concentrations above 15 wt %, as all these solution results could also be indexed to BCC lattices (see FIG. 38c) and the 15 wt % in the GISAXS experiments only indicates the starting solution concentration. For example, comparison to the BCC lattice parameter of 63 nm of an 18 wt % ISV+resols solution (see Table in FIG. 38d) shows that the lattice parameter results deviate by less than 10%. This corroborates earlier studies of ISV solutions and resulting SNIPS derived ISV based UF membranes demonstrating that solution SAXS is a good predictor of UF membrane surface structure. From the current studies, this result also seems to hold for consecutive method derived ISV+resols mixed membranes.

Characterization of As-Made Membranes via Scanning Electron Microscopy (SEM). Following x-ray solution and in-situ evaporation studies, membranes cast via the CNIPS process were characterized in the as-made state using scanning electron microscopy (SEM). As-made is defined as being the state immediately following precipitation in the non-solvent bath. Alternatively, after casting membranes were left in the DI water bath overnight under stirring in order to provide enough time for the resols to be washed out, which was expected to improve visualization of porosity via SEM.

In order to screen for optimal membrane structure formation, various parameters including evaporation time, substrate temperature, and water bath conditions were tested. A summary of the results from varied substrate temperatures as well as non-solvent bath temperatures is provided in Table 10, while the full set of scanning electron micrographs is provided in FIGS. 43 to 48.

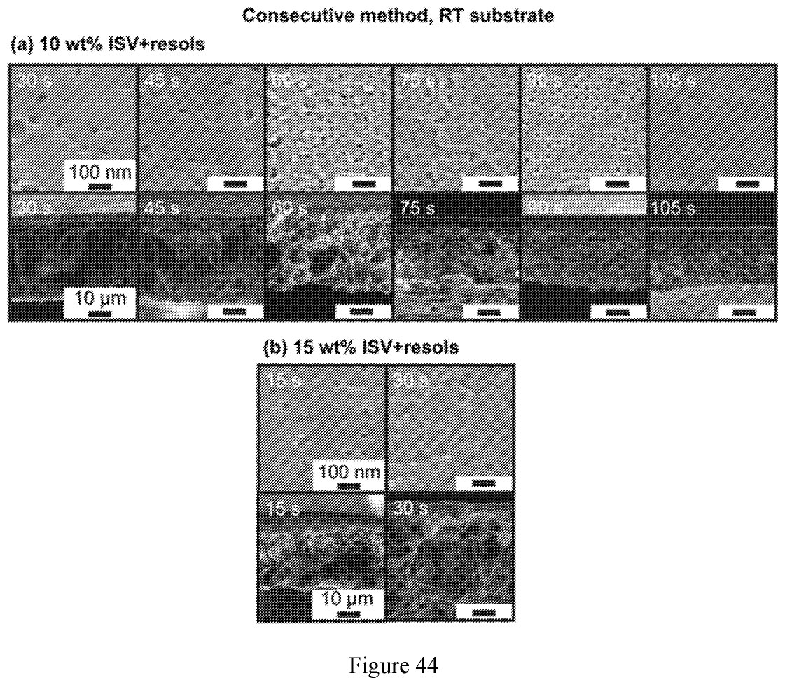

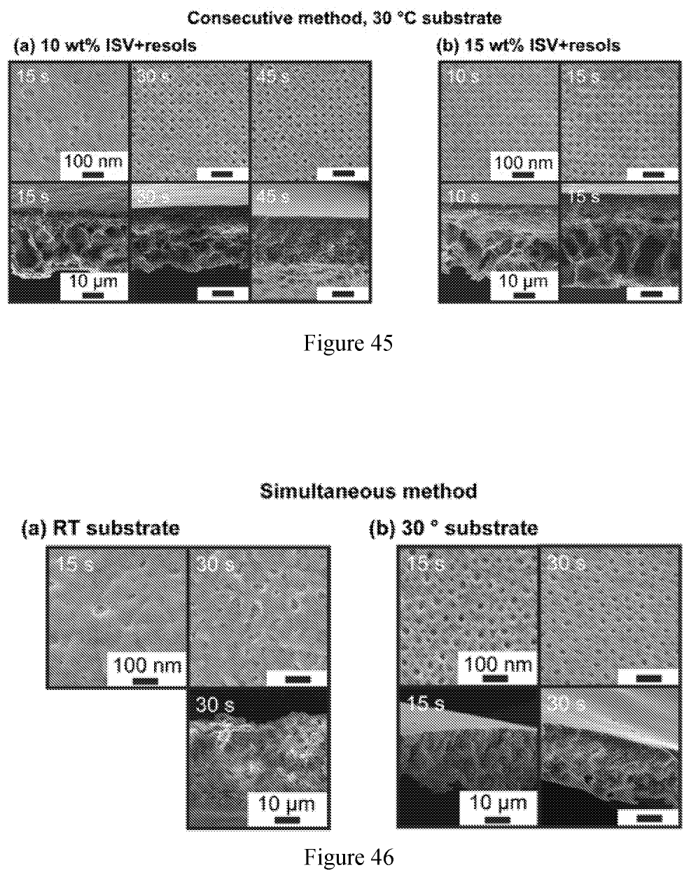

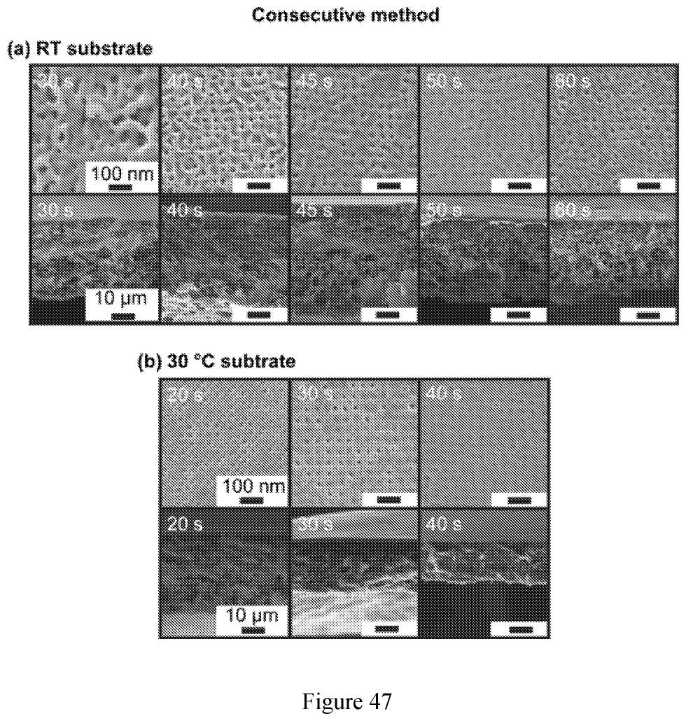

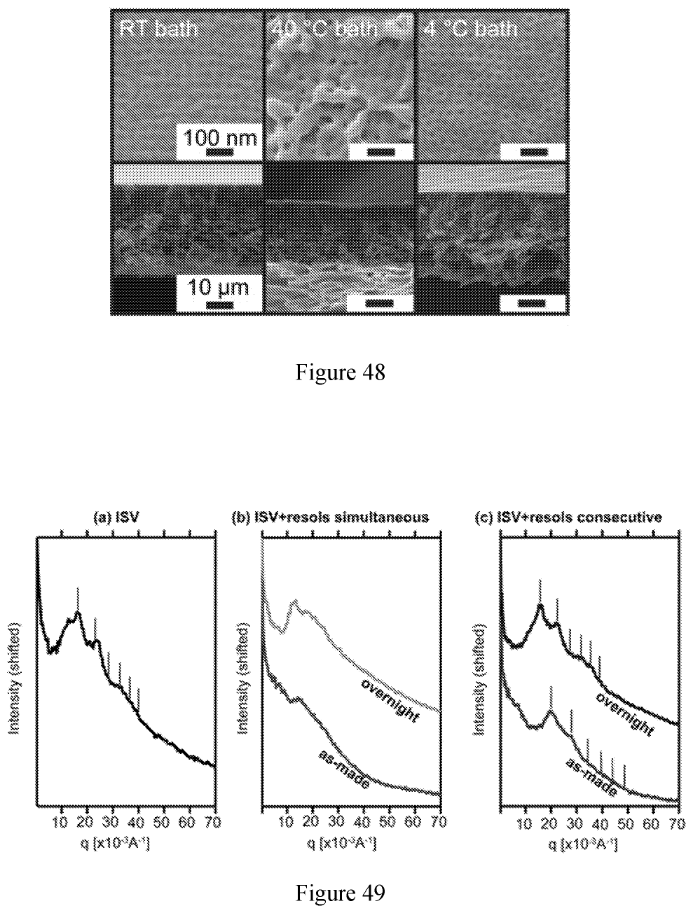

While casting at room temperature resulted in ordered top surfaces in the pure ISV dopes (FIG. 43), such conditions did not result in optimal surface ordering for ISV+resols dopes (see results for consecutive method in FIG. 44 where the closest to cubic order was observed at the 90 s evaporation time point). To search for experimental conditions for improved top surface ordering, the casting substrate temperature was varied. Instead of a room temperature substrate, membranes were cast on a 30° C. substrate. This resulted in substantially improved top surface order for both 10 wt % and 15 wt % ISV+resols casting solutions using the consecutive method (compare results in FIG. 45 with those in FIG. 44). When the heated substrate approach was applied to the simultaneous preparation method, it failed (FIG. 46). When it was applied together with increased humidity casting conditions (˜70% relative humidity) for the pure parent ISV system, which resulted in poor ordering on room temperature substrates under these conditions, it indeed helped improve the order of the top surface of the material (FIG. 47). Finally, for the consecutive method, three water bath temperatures were tested to probe their effects on membrane top surface order (FIG. 48). When dipping into DI water baths at room temperature (˜20° C., left images) and 4° C. (right images), the cubic order which developed during the evaporation was preserved, whereas when dipping into a warmed 40° C. (middle images) bath, the order was not preserved.

TABLE 10
Summary of experiments conducted to elucidate optimized
experimental conditions for obtaining ordered top surfaces in
membranes cast via the S/CNIPS process.

| | Rel. | | | |
|---|---|---|---|---|
| Polymer | humidity | | Non-solvent | Obs. surface |
| System | [%] | Substrate T | bath T | order |
| ISV | <30 | RT | RT | cubic |
| ISV | ~70 | RT | RT | — |
| ISV | ~70 | 30° C. | RT | cubic |
| ISV + resols | <30 | RT | RT | —* |
| (consecutive) | | | | |
| ISV + resols | <30 | 30° C. | RT | cubic |
| (consecutive) | | | | |
| ISV + resols | <30 | 30° C. | 4° C. | cubic |
| (consecutive) | | | | |
| ISV + resols | <30 | 30° C. | 40° C. | cubic |
| (consecutive) | | | | |
| ISV + resols | <30 | RT | RT | — |
| (simultaneous) | | | | |
| ISV + resols | <30 | 30° C. | RT | — |
| (simultaneous) | | | | |

FIG. 34 shows SEM characterization results for optimized membrane formation conditions, i.e., cast at low relative humidity (<30%), evaporated for 45 s on RT (˜20° C., 35a) or 40 s on 30° C. (34b and 34c) substrates, before being plunged into a RT (˜20° C.) nonsolvent DI water bath, obtained from the following polymer dope solutions in 7:3 DOX:TIF: 9.9 wt % parent ISV (FIG. 34a), 10 wt % ISV+resols (2:1 ISV:resols weight ratio) simultaneous method (FIG. 34b), and 10 wt % ISV+resols (2:1 ISV:resols weight ratio) consecutive method (FIG. 34c). For both simultaneous and consecutive cases, membrane samples were taken following 30 s of exposure to (left column), as well as overnight stirring in (right column), the non-solvent DI water bath (vide supra). As is evident from these images, good quality surface ordering was achieved for both the parent ISV membrane, as well as for the membrane obtained from the consecutive method. In contrast, well ordered top surface layers of membranes formed using the simultaneous method were not observed, consistent with x-ray scattering results reported in the previous sections. Fast Fourier transform (FFT) analysis of the top surface order (FIG. 49), while not applicable to membranes obtained from the simultaneous method (FIG. 49b), yielded pore-to-pore distances (based off of the q* position and assuming SC lattices) of 39 nm for the parent ISV case (FIG. 49a) as well as 32 nm (lower trace, as-made) and 40 nm (upper trace, overnight stirring) for consecutive method derived membranes (FIG. 49c). These results were consistent with those obtained by manually measuring >50 pore-to-pore (channel-to-channel) distances using the measuring tool in ImageJ (data not shown). These results were consistent with the corresponding in-situ GISAXS derived values of 38 nm and 39.5 nm for 10 wt % ISV and ISV+resols derived membranes (see Table 9).

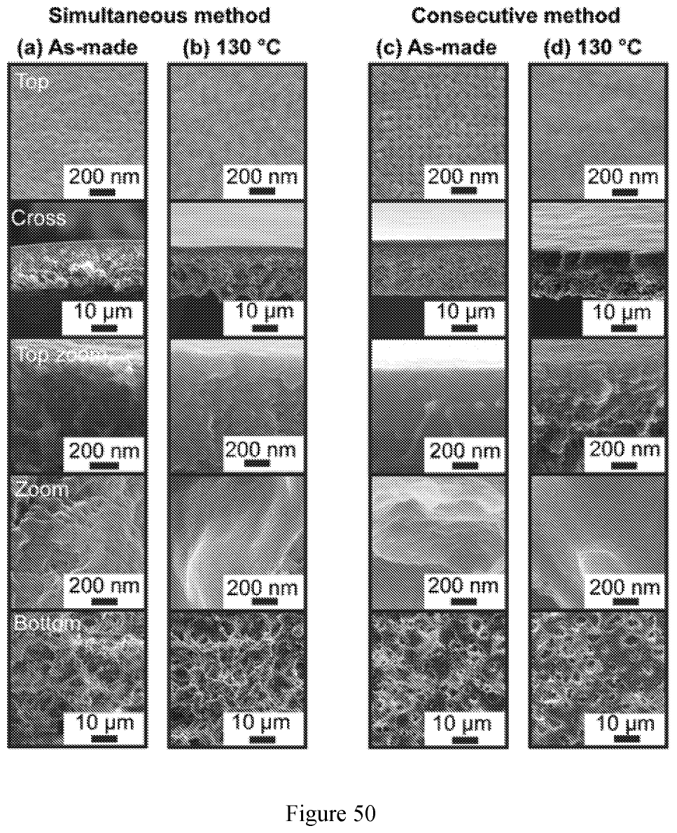

Heat-Treatment of As-Made Membranes and Comparison to Carbonized Materials. Once optimized parameters (low, <30% relative humidity, 30° C. heated substrate, RT, ˜20° C. non-solvent DI water bath) leading to ordered top surfaces in the organic-organic (ISV-resols) hybrid membranes were identified, these membranes were subjected to a series of heat-treatments to produce carbon materials. Immediately following casting and precipitation, as-made membranes were dried at room temperature and then underwent heat-treatment at 130° C., both in a vacuum oven, in order to cross-link the resols. After heat-treatment (FIG. 50) to this moderate temperature (i.e., below polymer decomposition temperatures), surface features became less prominent and pores appeared to close (FIG. 50).

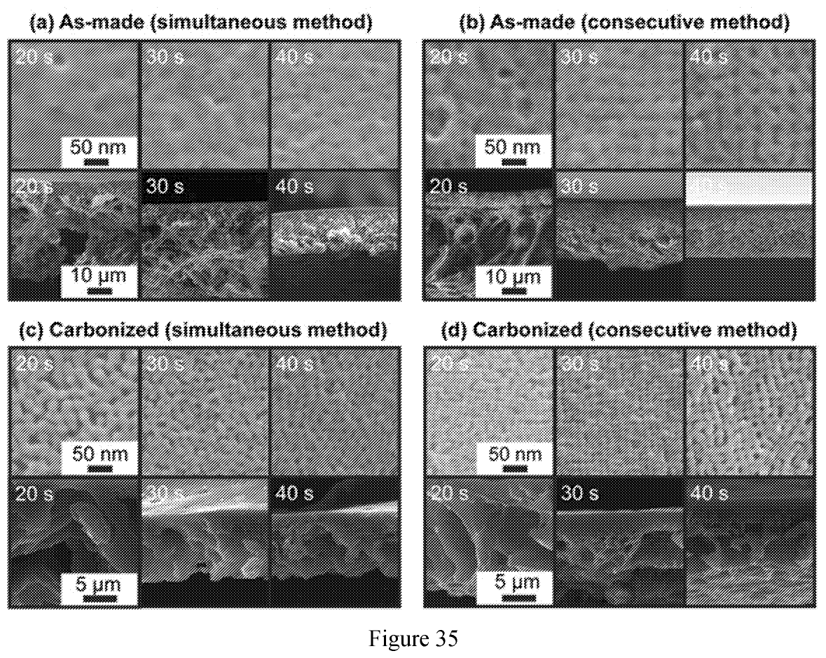

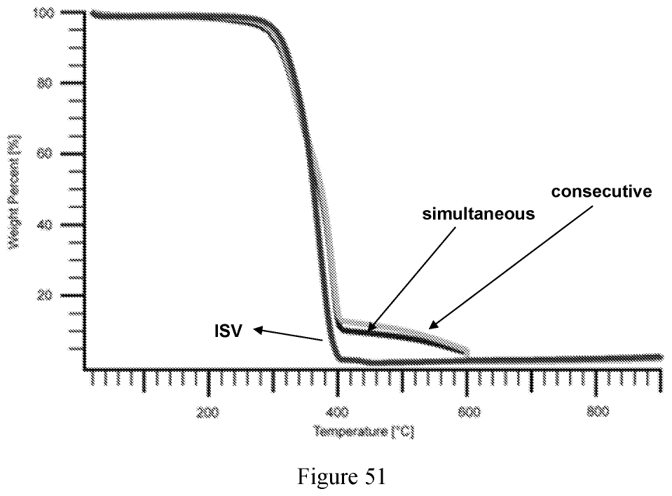

After cross-linking, the membranes were heat-treated in a flow furnace under inert atmosphere (nitrogen) at 1° C. min⁻¹ to 600° C. for 3 h, immediately followed by ramping to 900° C. at 5° C. min⁻¹ for 3 h. In this process, the polymer decomposed (FIG. 51). However, the structure was preserved due to the cross-linked resols, which were converted to a carbon material as described and analyzed in depth in previous publications. FIG. 35 provides a comparison by means of SEM characterization of membrane top surfaces (top rows) and cross sections (bottom rows) between as-made membranes prepared from 11 wt % and 10 wt % ISV+resols (2:1 ISV:resols weight ratio) solutions in 7:3 DOX:THF via simultaneous and consecutive method, respectively, and their carbonized counterparts.

In the simultaneous method as-made case (FIG. 35a), a disordered mesoporous top surface transitioned into a support structure of about 20 μm thickness with asymmetric porosity. FIG. 35a also shows that while overall features remained similar, increasing evaporation time resulted in a denser and thinner cross-section, likely due to the evaporation of more solvent out of the membrane. When this organic-organic hybrid material was carbonized (FIG. 35c), the overall asymmetric structure was retained. However, due to material loss and associated material shrinkage, membrane thickness was reduced to about 10 μm (compare cross section scale bars in FIG. 35a/c). Finally, this SEM analysis demonstrates that an increased evaporation time resulted in smaller feature sizes on the mesoporous top surface.

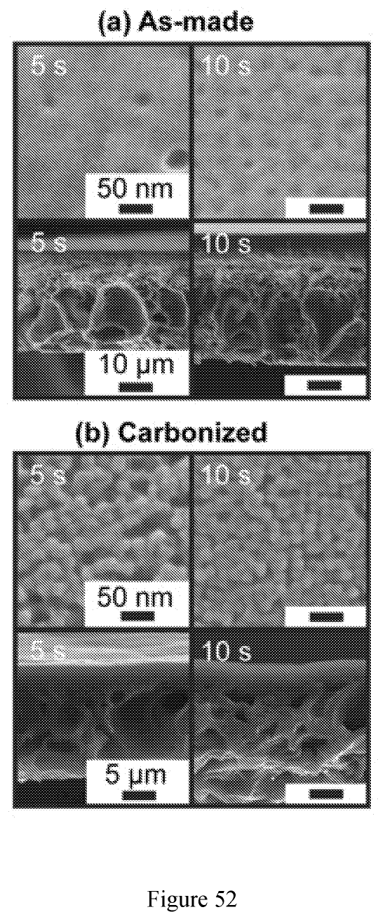

For the consecutive method as-made and carbonized cases (FIG. 35b/d) general trends were the same as described for the simultaneous method. The main difference, however, was the highly regular, cubic top surface order of the as-made materials, in particular at longer evaporation times, which was retained in the final carbonized membranes. Similar results were obtained for membranes, which were cast from a 15 wt % ISV+resols solution (FIG. 52).

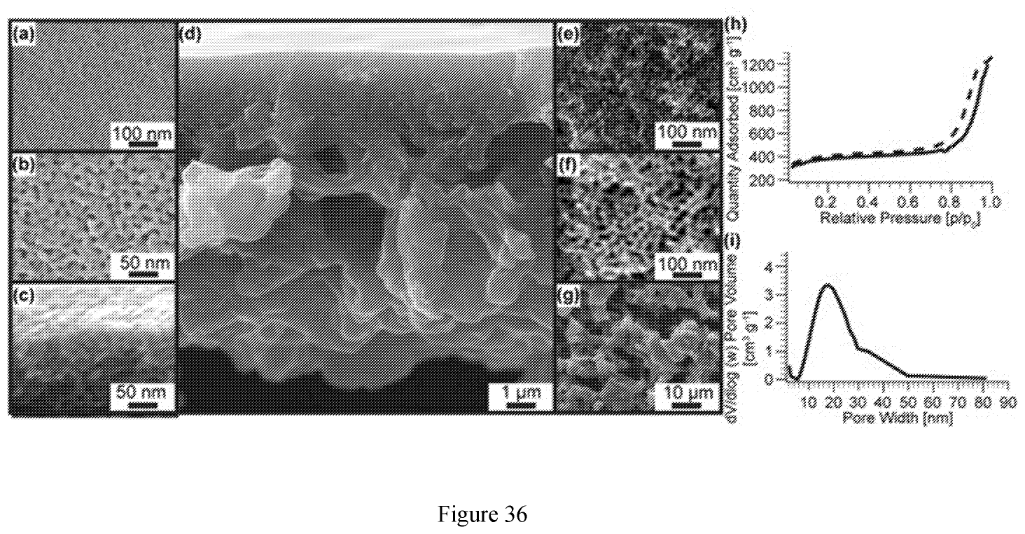

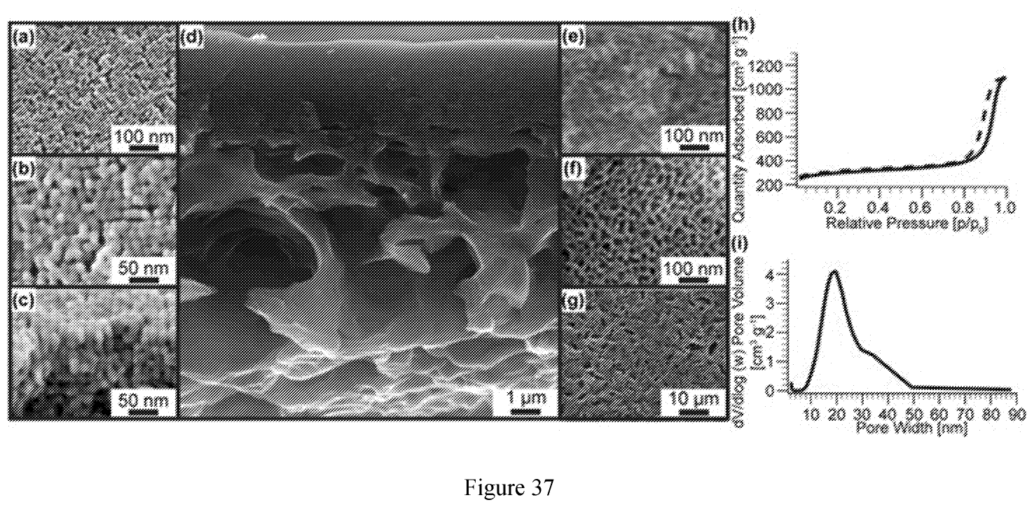

Characterization of Carbon Materials. A more in-depth characterization of carbon materials prepared via both the simultaneous and consecutive method using SEM and nitrogen sorption analysis are shown in FIGS. 36 and 37, respectively.

The carbon materials resulting from the simultaneous method possessed a homogeneous top surface, but with only disordered arrays of mesopores (FIG. 36a, b). In contrast, for carbon materials obtained from the consecutive method employing optimized membrane formation parameters, a top surface with periodic local cubic order was achieved (FIG. 37a, b). It is evident from comparing these SEM images with those of the parent ISV membrane or the ISV+resols consecutive method derived as-made/overnight samples (e.g., see FIG. 34a/c), that the original array of square ordered mesopores in the top surface layer of these materials is replaced by square ordered arrays of dimples in the carbonized materials. It was concluded that in the top surface layer the resulting carbon material stems from resols that originally filled the P4VP coated (pore) space of the ISV membrane in the co-assembly process. This square ordering extends a few micelle layers down along the film normal (FIG. 37c) before the order is lost in the meso- to macro-porous substructure.

Simultaneous and consecutive methods resulted in asymmetric carbon structures (FIG. 36d, 37d) with mesoporosity throughout the material. This porosity was characterized via nitrogen sorption isotherms analyzed using the Brunauer-Emmett-Teller (BET) method (FIGS. 36h and 37h).

Type-IV curves with H1-type hysteresis and sharp capillary condensations above relative pressures of 0.9 were observed in both cases. For the simultaneous method, a BET surface area of 1322 m² g⁻¹ with a weighing error of 357 m² g⁻¹, micropore area of 837 m² g⁻¹, and specific pore volume of 1.96 cm³ g⁻¹ at p/p₀=0.99 were obtained. For the consecutive method, a slightly lower BET surface area of 1024 m² g⁻¹ with a weighing error of 143 m² g⁻¹, micropore area of 655 m² g⁻¹, and specific pore volume of 1.69 cm² g⁻¹ at p/p₀=0.99 were obtained. BJH pore size distributions of materials prepared from both methods had also similar profiles (FIGS. 36i and 37i). For the material from the simultaneous method, the pore size distribution peaked at 18 nm with a FWHM of 15 nm, while for the material from the consecutive method the values were 20 nm and 12 nm for peak pore size and FWHM, respectively.

This examples shows the successful non-equilibrium type one-pot synthesis method to obtaining asymmetric porous carbon materials with ordered top-surface layers and hierarchical substructure with meso- and macropores. To that end, approaches were pursued in which carbon precursors (resols) were either simultaneously or consecutively mixed with the structure directing triblock terpolymer, ISV. Both methods generally resulted in approximately 10 micron thick carbon materials with a mesoporous top surface layer which transitioned into a support structure with increasing pore size along the film normal, ending in a macroporous structure at the membrane bottom, with mesopores throughout the material. The difference between the two methods is that only after carefully screening various processing conditions the optimized consecutive method resulted in an ordered top surface layer in the resulting porous carbon materials. In the consecutive method, ISV was first dissolved in a 7:3 DOX:THF solvent mixture, before the addition of resols, which likely allows for the formation of uniform micelles in solution prior to the addition of hydrogen bonding additive, and therefore allows for the evolution of ordered solution structure with increasing concentration as evidenced by SAXS of quiescent ISV+resols solutions. This order also occurs in the top surface layer of as-made membranes upon solvent evaporation as evidenced by in-situ GISAXS experiments and SEM images of the resulting top surfaces of the final carbon materials. In contrast to the consecutive method, even after carefully screening a variety of processing conditions the simultaneous method (in which resols are already present when the polymer dissolves and forms micelles) only resulted in relatively disordered structures both in quiescent solutions as well as in the resulting membranes as evidenced by SAXS, in-situ GISAXS, and SEM of the final carbons.

The insights gained by these fundamental solution and evaporation studies are expected to result in expanding the types of additives, which can be combined with polymers in the CNIPS process, while successfully maintaining the characteristic well-ordered top surfaces of SNIPS membranes. This periodic order of the pores in the top separation layer, together with the asymmetric and simultaneously hierarchical porosity of the substructure is expected to combine high surface area with high flux. Due to the advantages of high porosity and pore accessibility as well as the scalability of the NIPS based membrane formation process, it is expected for these asymmetric carbon materials to find use in areas as diverse as catalysis, energy conversion and storage, and separations.

Abbreviations. BCP (block copolymer), CGM (Cornell Graded Materials), CNIPS (co-assembly and non-solvent induced phase separation), resols (phenol formaldehyde resols), SNIPS (self-assembly and non-solvent induced phase separation)

Although the present disclosure has been described with respect to one or more particular examples, it will be understood that other examples of the present disclosure may be made without departing from the scope of the present disclosure.

1. A method for forming an asymmetric porous film, the film comprising one or more carbon material(s), one or more metalloid oxide(s), one or more metal(s), one or more metal oxide(s), one or more metal nitride(s), one or more metal oxynitride(s), one or more metal carbide(s), one or more metal carbonitrides, or a combination thereof, comprising:
forming a film comprising a multiblock copolymer comprising one or more hydrogen-bonding block(s) that can self-assemble using a mixture comprising the multiblock copolymer and a solvent system and one or more carbon precursor(s), or one or more metal oxide precursor(s), or one or more metalloid oxide precursor(s), or a combination thereof;
removing at least a portion of the solvent system from the film comprising a multiblock copolymer comprising one or more hydrogen-bonding block(s) and one or more carbon precursor(s), or one or more metal oxide precursor(s), or one or more metalloid oxide precursor(s), or a combination thereof,
contacting the film having at least a portion of the solvent system removed with a non-solvent system, such that an asymmetric porous film comprising the multiblock copolymer and the precursor(s) is formed;
optionally, heating the asymmetric porous film comprising the multiblock copolymer and the one or more precursor(s) to form an asymmetric porous film comprising one or more carbon material(s), one or more metalloid oxide(s), one or more metal(s), one or more metal oxide(s), one or more metal nitride(s), one or more metal oxynitride(s), one or more metal carbide(s), one or more metal carbonitrides, or a combination thereof; and
optionally, treating the asymmetric porous film comprising metal oxide under reducing conditions to form the asymmetric porous film comprising metal, or
optionally, nitriding the asymmetric porous film comprising the multiblock copolymer and the one or more metal oxide precursor(s) or the asymmetric porous film comprising metal oxide to form the asymmetric porous film comprising metal nitride, or
optionally, treating the asymmetric porous film comprising multiblock copolymer and the one or more carbon precursor in inert atmosphere to form the asymmetric porous film comprising carbon, or
optionally, heat treating the carbon asymmetric porous film under carbon dioxide.

2. The method of claim 1, wherein the one or more hydrogen-bonding block(s) are to be chosen from poly(4-vinylpyridine), poly(2-vinylpyridine), poly(ethylene oxide), poly(acrylic acid), poly(methacrylic acid), poly(dimethyl amino ethyl methacrylate), poly(acrylic acid), poly(hydroxystyrene), and combinations thereof.

3. The method of claim 1, wherein the multiblock copolymer further comprises of one or more hydrophobic block(s).

4. The method of claim 1, wherein the one or more carbon precursor(s) are chosen from resins, oligomeric resins, aromatic alcohols, unsaturated alcohols, phenol-based resols, phenol-formaldehyde resols, resorcinol-formaldehyde resols, furfuryl alcohol, and combinations thereof.

5. The method of claim 1, wherein the concentration of the multiblock copolymer and precursor(s) is 3 to 50 wt. % (based on the total weight of the mixture used to form the film comprising a multiblock copolymer comprising one or more hydrogen-bonding block(s) and one or more carbon precursor(s), or one or more metal oxide precursor(s), or one or more metalloid oxide precursor(s), or a combination thereof).

6. The method of claim 1, wherein the ratio of the multiblock copolymer to precursor(s) in the mixture used to form the film is 0.1:1 to 10:1 (based on wt. %, which is based on the total weight of the mixture used to form the comprising a multiblock copolymer comprising one or more hydrogen-bonding block(s) and one or more carbon precursor(s), or one or more metal oxide precursor(s), or one or more metalloid oxide precursor(s), or a combination thereof), or the ratio of the multiblock copolymer to precursor(s) in the mixture used to form the film is greater than or equal to 200:1 and/or less than or equal to 3000:1 (based on molecular weight of the multiblock copolymer and precursor(s)).

7. The method of claim 1, wherein the one or more metal oxide precursor(s) is/are chosen from inorganic compounds and sol-gel precursors, and combinations thereof, and/or the metalloid oxide precursor(s) is/are chosen from metalloid compounds, and combinations thereof.

8. The method of claim 1, wherein the metal oxide precursor(s) is/are chosen from transition metal alkoxides, and combinations thereof.

9. The method of claim 1, wherein the mixture further comprises a homopolymer and/or a small molecule and the as-made asymmetric porous film further comprises the homopolymer or the small molecule.

10. The method of claim 1, wherein the solvent system comprises a solvent chosen from 1,4-dioxane, tetrahydrofuran, morpholine, formylpiperidine, toluene, chloroform, dimethylformamide, acetone, dimethylsulfoxide, dimethylacetamide, N-methylpyrrolidone, sulfolane, acetonitrile, 2-methyltetrahydrofuran, and combinations thereof.

11. The method of claim 1, wherein the heating comprises drying the asymmetric porous film and/or
in the case where the asymmetric porous film was formed using one or more carbon precursor(s), carbonization of the film,
in the case where the asymmetric porous film was formed using one or more carbon precursor(s), formation of an N-doped carbon film,
in the case where the asymmetric porous film was formed using metal oxide precursor(s), formation of the metal oxide,
in the case where the asymmetric porous film was formed using either multiblock copolymer and metal oxide precursor(s) or a metal oxide asymmetric porous film, formation of the metal nitride,
in the case where the asymmetric porous film was formed using metal oxide precursor(s), formation of the metal.

12. The method of claim 1, wherein the nitriding comprises heating the asymmetric porous film of the multiblock copolymer and the one or more metal oxide precursor(s), or the asymmetric porous film comprising metal oxide in an atmosphere of a nitrogen source.

13. An asymmetric porous film, comprising:
a porous three-dimensional carbon, metal, metal oxide, metal nitride, metal oxynitride, metal carbide, metal carbonitride, or a combination thereof structure,
wherein at least a portion or all of the carbon, or metal, or metal oxide, or metal nitride, or metal carbonitride or a combination thereof is mesoporous,
wherein the asymmetric porous film has a surface layer, and/or a plurality of mesopores, and the asymmetric porous film substructure has a plurality of mesopores and/or micropores.

14. The asymmetric porous film of claim 13, wherein the size of the pores in the surface layer have a pore size distribution of less than 3, wherein the pore size distribution is the ratio of the maximum pore diameter (dₘₐₓ) to the minimum pore diameter (dₘᵢₙ).

15. The asymmetric porous film of claim 13, wherein the asymmetric porous film has a thickness of 5 microns to 500 microns.

16. A device comprising one or more asymmetric porous film(s) of claim 13.

17. The device of claim 16, wherein the device is an energy device.

18. The device of claim 17, wherein the energy device is chosen from batteries, capacitors, fuel cells, electrolyzers, and combinations thereof.

19. The device of claim 18, wherein the device is a filtration device.

20. The device of claim 19, wherein the filtration device is an ultrafiltration device, a nanofiltration device, or a microfiltration device.
